(19) United States
(12) Patent Application Publication
(10) Pub. No.: US 2023/0325556 A1
(43) Pub. Date: Oct. 12, 2023

(54) Solution to the Sign Problem Using a Sum of Controlled Few-Fermions

(71) Applicant: Haiqing Wei, San Jose, CA (US)

(72) Inventor: Haiqing Wei, San Jose, CA (US)

(21) Appl. No.: 18/196,430

(22) Filed: May 11, 2023

Related U.S. Application Data
(63) Continuation-in-part of application No. 17/563,023, filed on Dec. 27, 2021.
(60) Provisional application No. 63/341,328, filed on May 12, 2022.

(51) Int. Cl. G06F 30/20

(52) U.S. Cl. CPC G06F 30/20; G06F 2111/10

(57) ABSTRACT

Methods and systems of Monte Carlo quantum computing are disclosed for simulating quantum systems and implementing quantum computing efficiently on a classical computer, including methods and systems for simulating many-variable signed densities, methods and systems for decomposing a many-variable density into a combination of few-variable signed densities, and methods and systems for solving a computational problem via Monte Carlo quantum computing.

### CROSS-REFERENCE TO RELATED APPLICATIONS

This patent application is a continuation-in-part of U.S. Ser. No. 17/563,023, filed Dec. 27, 2021. This patent application also claims the benefit of U.S. Provisional Ser. No. 63/130,847, filed Dec. 27, 2020 and U.S. Provisional Ser. No. 63/341,328, filed May 12, 2022. Each of the above-referenced patent applications is incorporated in its entirety by reference herein.

### FIELD

This invention relates to classical and quantum computations, specifically to implementations of quantum computing and simulations via Monte Carlo on classical computers.

### BACKGROUND

### General Background

Quantum mechanics and quantum field theories provide the most accurate description of almost everything in the known physical world, with the only exception of extremely strong gravitation. Vastly many questions in physics, chemistry, materials science, and even molecular biology could be answered definitively by solving a set of well established quantum equations governing a quantum system, which refers to a generic physical system consisting of particles and fields that mediate electromagnetic, weak and strong interactions, even non-extreme gravitational forces, so long as said particles and fields conform to the laws of quantum mechanics. Such a quantum system usually involves a large number of particles and modes of fields, and the noun quantum system is often premodified by an adjective many-particle or many-body to stress that the sum of the number of particles and the number of modes of fields is large, although such adjective many-particle or many-body is sometimes omitted but implied and understood from the context.

The ability to simulate quantum systems efficiently on a classical computer [1, 2] or a quantum machine [1, 3, 4] is crucially important for fundamental sciences and practical applications. Of particular importance is to simulate the ground state of a quantum many-body system efficiently on a classical computer. Among many numerical methods, quantum Monte Carlo [2] is uniquely advantageous as being based on first principles without uncontrolled systematic errors and using polynomially efficient importance sampling from an exponentially large Hilbert space, until its polynomial efficiency is spoiled by the notorious numerical sign problem [5, 6]. On the other hand, many computational problems that are not directly related to simulations of quantum systems can be solved by running a quantum computing process on a quantum computer, which reduces to simulating a quantum system, especially the ground state of a quantum many-body system. A fundamental question in computational complexity theory is whether the class of bounded-error probabilistic polynomial time (BPP) is the same as that of bounded-error quantum polynomial time (BQP) [7], which will be answered affirmatively in this specification.

### Prior Art

Ostensibly due to the exponentially exploding dimension of the Hilbert space that is needed to describe the state of a quantum system, it can be exceedingly hard to solve the quantum equations or simulate an eigenstate or dynamics of even a moderately sized quantum system on a classical computer [1]. Various quantum Monte Carlo (QMC) methods [2] have the potential to break the curse of dimensionality, by mapping a non-negative ground state wavefunction or Gibbs kernel of a quantum system into a classical probability density, and simulating a random walk that embodies importance sampling of such a probability distribution. Given positivity of a concerned wavefunction or Gibbs kernel, QMC is arguably the only general and exact numerical method that is free of uncontrollable systematic errors due to modeling approximations, providing reliable and rigorous simulation results upon numerical convergence. Unfortunately, previous QMC procedures for many quantum systems, especially those involving multiple indistinguishable fermions which represent the vast majority of atomic, molecular, condensed matter, and nuclear systems, suffer from the notorious sign problem [1, 2, 5] that leads to an exponential slowdown of numerical convergence, due to the presence and cancellation of positive and negative amplitudes, when no computational basis is known to represent the concerned ground or thermal state by a non-negative wavefunction or Gibbs kernel. At the fundamental and theoretical level, as Feynman keenly noted, a defining characteristic, possibly the single most important aspect, setting quantum mechanics and computing apart from classical mechanics and computing, seemed to be the presence and necessity of a sort of “negative probability” in the quantum universe, endowing the power to represent and manipulate “negative probabilities”. Indeed, their perceived inability to deal with “negative probabilities” efficiently was believed to fundamentally limit the power of classical mechanics and computers in terms of simulating their quantum counterparts and solving computational problems that quantum computers are predicted and believed to excel. The persistently unsolved status of the sign problem in the past, compounded by the piling of “evidence problems” that had an efficient quantum solution but no good classical solution being known or even thought possible, had fueled a pervasive belief that quantum computers were inherently more powerful than classical machines, and there existed certain hard computational problems which were amenable to polynomial quantum computing processes but could not be solved efficiently on classical computers, or in the terminology of quantum complexity theory [7], that the computational complexity classes of BQP and quantum Merlin Arthur are strictly proper (i.e., larger) supersets of the classical classes of BPP and 1-message Arthur-Merlin interactive proof.

### Objects and Advantages

Bucking the common and popular belief, this specification discloses general and systematic solutions to the dreaded sign problem, thus establish BPP=BQP, by identifying and characterizing a number of classes of quantum Hamiltonians/systems called strongly frustration-free (StrFF), ground sate frustration-free (GFF), directly frustration-free (DFF), separately frustration-free (SepFF), whose Gibbs wavefunctions have a nodal structure that can be efficiently computed by solving a small subsystem involving a small number of dynamical variables associated with a constituent few-body interaction, as well as quantum Hamiltonians/systems called sum of controlled few-fermions (sum-of-CFFs), whose Gibbs kernels and ground states can be simulated rigorously via path integral Monte Carlo (PIMC) on a classical computer, where the rigorous PIMC uses restricted path integrals (RPIs) to overcome the dreaded sign problem. As a first major utility, it is demonstrated that any StrFF, GFF, DFF, SepFF, or sum-of-CFFs Hamiltonian can be efficiently simulated on a classical computer, in the sense that ground state wavefunctions, Gibbs wavefunctions, Gibbs kernels, Gibbs transition amplitudes, and Wiener densities associated with such Hamiltonians can be efficiently sampled via a Monte Carlo procedure on a classical computer, subject to a polynomially small error in a properly defined sense. A particular class of Hamiltonians/systems consist of distinguishable and interacting bi-fermions, each of which comprises two non-interacting identical spinless fermions moving in a three-well potential on a circle. Then as a second major utility, it is demonstrated that each of the classes of StrFF, GFF, DFF, SepFF, or sum-of-CFFs Hamiltonians/systems consisting of only bi-fermions is universal for quantum circuits and computations by homophysically implementing a Feynman-Kitaev construct.

Combining the first and second major utilities leads to a third major utility which asserts and demonstrates that the two computational complexity classes BPP and BQP are actually one and the same. That quantum computing and mechanics are just classical computing and probability up to polynomial reduction is of great significance. Any quantum computing process or quantum circuit in BQP can be efficiently simulated by a Monte Carlo procedure running on a classical computer. Such simulation, indeed implementation of quantum computing, is called Monte Carlo quantum computing, which is not to be confused with the still sign-problem-prone, conventional quantum Monte Carlo simulation of quantum systems and computing processes. The methods, computing processes, and systems disclosed in this specification not only solve the sign problem that has plagued Monte Carlo simulations in many areas of science and technology, but also open up new avenues for developing and identifying efficient classical computing processes from the vantage point of quantum computing. All known and to be discovered BQP computing processes reduce to BPP solutions. It should be noted that the BPP or BQP class of computational problems as referenced here is not to be understood as limited strictly to the family of decision or promise problems on a classical or quantum computer. Rather, the BPP or BQP class should be broadly interpreted as to represent general types of computational problems that are efficiently solvable on a classical or quantum machine. Indeed, it has been well established and widely known that a great number of computational problems for function evaluation, objective optimization, and matching or solution search, etc., are reducible or polynomially equivalent to BPP or BQP problems, in that, the answer to a function/optimization/search problem can be obtained efficiently by solving one or a polynomial-bounded number of BPP or BQP problem(s). Moreover, it is usually straightforward in practice to modify and adapt only slightly a BPP or BQP computing process to an efficient procedure for solving a function/optimization/search problem.

### SUMMARY

Methods, software systems and related computer program products, involved computer-readable source and machine codes as well as numerical data, signals, hardware systems and related physical devices storing, processing, and executing involved computer-readable source and machine codes as well as numerical data and signals, are disclosed in relation to methods and processes of simulating a many-variable system or a many-variable signed density associated with a many-variable system, constructing a many-variable system comprising a plurality of few-variable systems or processing data and signals describing and representing a many-variable signed density into a combination of a plurality of few-variable signed densities, and solving a computational problem by simulating a many-variable system or a many-variable signed density.

One method of simulating a many-variable signed density comprises providing a first means for decomposing said many-variable signed density into a combination of a plurality of few-variable signed densities, providing a second means for determining few-variable nodal surfaces corresponding to each of said few-variable signed densities, providing a third means for producing a plurality of samples of few-variable restricted densities, and providing a fourth means for producing a plurality of samples of an many-variable restricted density, whereby said many-variable restricted density is substantially equivalent to said many-variable signed density.

Another method of simulating a many-variable signed density being generated by a many-variable transition operator comprises providing a first means for decomposing said many-variable transition operator into a combination of a plurality of few-variable transition operators, providing a second means for determining few-variable nodal surfaces corresponding to each of said few-variable signed densities, providing a third means for producing a plurality of samples of few-variable restricted densities, providing a fourth means for producing a plurality of samples of a many-variable restricted density, whereby said many-variable restricted density is substantially equivalent to said many-variable signed density.

One method of solving a computational problem being described by problem data comprises providing a first means for processing said problem data to produce Gibbs data and providing a second means for simulating a many-variable signed density. Said first means further comprises providing a first processing means for producing circuit data, providing a second processing means for producing homophysics data, and providing a third processing means for producing Gibbs data comprising a description of a many-variable Gibbs operator and a plurality of few-variable Gibbs operators, with said many-variable Gibbs operator generating said many-variable signed density, whereby said many-variable signed density encodes a quantum result which in turn encodes a solution to said computational problem. Said second means further comprises providing a first simulating means for determining few-variable nodal surfaces, providing a second simulating means for producing a plurality of samples of few-variable restricted densities, and providing a third simulating means for producing a plurality of samples of a many-variable restricted density, whereby said many-variable restricted density is substantially equivalent to said many-variable signed density.

### BRIEF DESCRIPTION OF THE DRAWINGS

FIG. 1 shows a Feynman spindle from a start point (qₙ_{₀}, τₙ_{₀}) to an end point (qₙ_{₂}, τₙ_{₂}) on the left, and an orbit of Feynman spindles from a start point (qₙ_{₀}, τₙ_{₀}) to an orbit of end points (G_{*}qₙ_{₂}, τₙ_{₂}) on the right.

FIG. 2 shows an orbit of Feynman spindles from an orbit of start points (G_{*}qₙ_{₀}, τₙ_{₀}) to a midpoint (q, τ), that is post-tethered by a segment of Feynman path γ1 from the midpoint to an end point (qₙ_{₁}, τₙ_{₁}).

FIG. 3 shows an orbit of Feynman spindles from a midpoint (q, τ) to an orbit of end points (G_{*}qₙ_{₁}, τₙ_{₁}), that is pre-tethered by a segment of Feynman path γ₀ from a start point (qₙ_{₀}, τₙ_{₀}) to the midpoint.

FIG. 4 shows a square-shaped Feynman-Kitaev propagator using an auxiliary rebit.

FIG. 5 shows a diamond-shaped state filter using another auxiliary rebit.

FIG. 6 shows one method of simulating a many-variable signed density.

FIG. 7 shows another method of simulating a many-variable signed density.

FIG. 8 shows one method of solving a computational problem.

### DETAILED DESCRIPTION

Let a triple ( [symbol] , [symbol] , [symbol] ) represent a general quantum system [9], where [symbol] is a configuration space consisting of configuration points, each of which is a tuple or vector of variable values (e.g., eigenvalues) assigned to an ensemble of coordinate variables that are dynamical variables associated with the quantum system, for example but not limited to spatial positions of particles, while [symbol] [symbol] [symbol] ( [symbol] )⊆L²( [symbol] ) is a Hilbert space of state vectors (i.e., wavefunctions) supported by [symbol] , and [symbol] [symbol] [symbol] ( [symbol] ) is a Banach algebra of bounded operators acting on vectors in [symbol] , which contains a strongly continuous one-parameter semigroup of Gibbs operators {exp(−τH)}_{τ∈[0,∞)}, whose infinitesimal generator H is designated as the Hamiltonian governing the quantum system, which is sometimes referred to as the total Hamiltonian particularly to contrast with additive components summing up to it. A Hamiltonian or one of its additive components is the epitome of a general lower-bounded self-adjoint operator h, called a partial Hamiltonian, whose eigenvalues are denoted by {λₙ(h)}ₙ₌₀^{∞}⊆ [symbol] in a strictly increasing order, and the associated eigenstates are denoted by {ψₙ(h)}ₙ₌₀^{∞}, each of which is either a non-degenerate wavefunction or a suitable representation of an eigen subspace. A partial Hamiltonian h and its associated Gibbs operators {exp(−τh)}_{τ∈[0,∞)} are also said to be supported by [symbol] for the sake of brevity.

It is almost always the case, here taken as an axiomatic premise, that all partial Hamiltonians in consideration are of the Schrödinger type, as a sum of an elliptic differential operator −Δ and a bounded potential V, so to substantiate the Hopf lemma and the strong Hopf extremum principle [9-11]. It is without loss of generality (WLOG) to assume that [symbol] is a compact Riemannian manifold of a finite dimension dim( [symbol] )∈ [symbol] and all wavefunctions are real-valued, so the Hilbert spaces and Banach algebras are over [symbol] [7, 9, 12, 13]. The Riemannian metric g defining [symbol] induces a length measure for curves and a volume measure V_{g} for subsets on [symbol] . Being compact, [symbol] has a finite diameter diam( [symbol] )∈ [symbol] , thus a finite size( [symbol] ) [symbol] dim( [symbol] )+diam( [symbol] ). It is assumed that all fundamental equations of physics, especially the Schrödinger and quantum field-theoretic equations, are nondimensionalized and written in a so-called natural unit system.

Consider a many-fermion system (MFS) of a variable size, comprising a number S∈ [symbol] of fermion species, each species labeled by s∈[1, S] consisting of a number nₛ∈ [symbol] of identical fermions moving on a low-dimensional Riemannian manifold χₛ, where the total number of particles N_{*} [symbol] Σₛ₌₁^{s}nₛ may go up unbounded, while both dₛ [symbol] dim(χₛ) and Dₛ [symbol] diam(χₛ), ∀s∈[1, S] are always bounded by a fixed number. Mathematically, the identical fermions of each species s∈[1, S] may be artificially labeled by an integer n∈[1, nₛ], so that a configuration coordinate (point) qₛ [symbol] (qₛ₁, qₛ₂, . . . , qsnₛ)∈χₛⁿ^{ₛ} can represent their spatial configuration, where ∀(s,d)∈[1, S]×[1, nₛ], qₛₙ [symbol] (xₛₙ₁, . . . , x_{snd}_{ₛ}) is a dₛ-dimensional coordinate of the n-th fermion of the s-th species, and ∀d∈[1, dₛ], x_{snd} is a coordinate along the d-th dimension and counted as one degree of freedom. But physically, the indistinguishability among identical fermions dictates that all of the label-exchanged coordinates be equivalent and form an orbit [symbol] ₛqₛ [symbol] {πₛqₛ:πₛ∈ [symbol] ₛ} for any qₛ∈χₛⁿ^{ₛ}, where [symbol] ₛ is the symmetry group of permuting nₛ labels, πₛ∈ [symbol] ₛ is a typical permutation. Straightforwardly, the Cartesian product [symbol] [symbol] Πₛ₌₁^{s}χₛⁿ^{ₛ} is a configuration space for the MFS, and the group direct product G_{*} [symbol] Πₛ₌₁^{s} [symbol] ₛ, called the exchange symmetry group of the MFS, acts on [symbol] and partitions it into disjoint orbits. Clearly, every pair of permutations π∈ [symbol] ₛ, s∈[1, S] and π′∈ [symbol] _{s′}, s′∈[1, S] with s≠s′ commute, hence each [symbol] ₛ, s∈[1, S] is straightforwardly a normal subgroup of G_{*}. All of the even permutations in G_{*} form a subgroup A_{*}, called the exchange alternating group. It is an axiom of physics that any legitimate quantum state ψ∈ [symbol] ( [symbol] ) must be exchange-symmetric as [πψ](q) [symbol] ψ(πq)=(−1)^{π}ψ(q), ∀q∈ [symbol] , ∀π∈G_{*}. With respect to G, and its actions on [symbol] and [symbol] ( [symbol] ), a full exchange summarization operator is defined as [symbol] [symbol] |G_{*}|⁻¹Σ_{π∈G}_{_{*}}(−1)^{π}π, with |G_{*}| denoting the cardinality of G_{*} as a set. Similarly, an even exchange symmetrization operator is defined as ε [symbol] |A_{*}|⁻¹Σ_{π∈A}_{_{*}} (−1)^{π}π.

For any partial Hamiltonian h, and any (r, q, τ)∈ [symbol] ²×(0, ∞), let [symbol] r|e^{-τh}|q [symbol] represent an artificial, non-negative definite, boltzmannonic Gibbs transition amplitude from q to r in (imaginary) time τ due to h, which ignores the fermionic exchange symmetry and regards all particles distinguishable, let

[symbol]

r|e^{-τh}| [symbol] q [symbol] [symbol] |G_{*}|⁻¹Σ_{π∈G}_{_{*}}(−1)^{π} [symbol] r|e^{-τh}|πq [symbol] , (1)

[symbol]

[symbol]

r|e^{-τh}|q [symbol] [symbol] |G_{*}|⁻¹Σ_{π∈G}_{_{*}}(−1)^{π} [symbol] r|e^{-τh}|πq [symbol] , (2)

[symbol]

[symbol]

r|e^{-τh}| [symbol] q [symbol] [symbol] |G_{*}|⁻²Σ_{π∈G}_{_{*}}Σ_{π′∈G}_{_{*}}(−1)^{π+π′} [symbol] πr|e^{-τh}|π′q [symbol] , (3)

denote a pre-, post-, and dual-symmetrized fermionic Gibbs transition amplitude. The function [symbol] ⋅|e^{-τh}|⋅ [symbol] ∈L²( [symbol] ²) is called the boltzmannonic Gibbs kernel, and [symbol] ⋅|e^{-τh}| [symbol] ⋅ [symbol] , [symbol] [symbol] ⋅|e^{-τh}| [symbol] ⋅ [symbol] , [symbol] [symbol] ⋅|e^{-τh}| [symbol] ⋅ [symbol] ∈L²( [symbol] ²) are called the pre-, post-, dual-symmetrized fermionic Gibbs kernels respectively, being associated with a formal Gibbs operator exp(−τh), τ∈(0, ∞) generated by a partial Hamiltonian h. It is obvious that [symbol] ⋅|e^{-τh}| [symbol] ⋅ [symbol] ≡ [symbol] [symbol] ⋅|e^{-τh}|⋅ [symbol] ≡ [symbol] [symbol] ⋅|e^{-τh}| [symbol] ⋅ [symbol] , either one may be referred to as the fermionic Gibbs kernel.

All Feynman path integrals, Gibbs transition amplitudes, and Gibbs kernels in this presentation should be interpreted in the boltzmannonic sense as non-negative definite quantities, unless a full exchange symmetrization operator [symbol] is placed explicitly in front of one or more configuration coordinate(s) to signify full exchange symmetrization and summation of signed contributions to yield a fermionic quantity.

Given an MFS governed by a Hamiltonian H, a computationally important number is the (descriptive) size of H, denoted by size(H), which is basically, up to a constant factor, the minimum number of classical bits needed to describe H. All computational complexities and singular values of operators will be measured against size(H). Of great interests are the so-called (computationally) local Hamiltonians [14,15] of the form H=τₖ₌₁^{K}Hₖ, K∈ [symbol] , K=O(poly(N_{*})), where each Hₖ, k∈[1, K] moves no more than a constant number of degrees of freedom around any configuration point, the size of H is defined as size(H) [symbol] size( [symbol] )+K, so size(H)=O(poly(N_{*})). In this specification, O(⋅), Ω(⋅), and Θ(⋅) are the traditional notations of asymptotics in the Knuth convention, representing an upper bound, a lower bound, and a simultaneous upper and lower bound, respectively [16]. An Hₖ, k∈[1, K] is said to move an (s,n,d)-th degree of freedom, (s,n,d)∈[1, S]×[1, nₛ]×[1, dₛ] around a configuration point q=( . . . , q_{snd}, . . . )∈ [symbol] , when there exist a τ∈(0, ∞) and an r=( . . . , r_{snd}, . . . )∈ [symbol] , such that r_{snd}≠q_{snd} while the boltzmannonic Gibbs transition amplitude [symbol] r|e^{-τH}^{ₖ}|q [symbol] ≠0 [9]. For any k∈[1, K] and any q∈ [symbol] , let [symbol] ₖ(q) [symbol] {r∈ [symbol] :∃τ>0 such that [symbol] r|e^{-τH}^{ₖ}|q [symbol] ≠0}, which is called the boltzmannonic reach of q by Hₖ.

One exemplary local Hamiltonian describes a type of MFS called a few-species fermionic system (FSFS), which comprises a small number S∈ [symbol] of different fermion species, one or more species having a large number of identical particles, where the particles are artificially labeled so that a conventional Schrödinger operator of the FSFS is rewritten deliberately into a local Hamiltonian H=Σₛ₌₁^{s}Σₗ₌₁ⁿ^{ₛ}Σₘ₌₁ⁿ^{ₛ}Hₛₗₘ, where for each (s,l,m)∈[1, S]×[1, nₛ]², Hₛₗₘ [symbol] −(Δₛₗ+Δₛₘ)/2nₛ+V/Σₛ₌₁^{s}nₛ² moves only the l-th and the m-th labeled particle of the s-th species through the Laplace-Beltrami operators Δₛₗ and Δₛₘ. A single-species fermionic system is a special case of FSFS with S=1, namely, involving a single fermion species having a large number of identical particles being artificially labeled.

Another exemplary local Hamiltonian H=Σₖ₌₁^{K} Hₖ describes an important type of MFS called a many-species fermionic system (MSFS), which comprises a large number S∈ [symbol] of fermion species, each of which has no more than a small constant of identical fermions, where each Hₖ, k∈[1, K] moves particles of no more than a small constant number of species around any given configuration point q∈ [symbol] .

Definition 1. Given an MSFS with a configuration space [symbol] coordinating a large number of fermions of a variable number S∈ [symbol] of species, a form sum H=Σₖ₌₁^{K}Hₖ, K=O(poly(S)) defining a local Hamiltonian is called a sum of CFFs, when each Hₖ, k∈[1, K], called a CFF interaction, is invariant under any exchange of identical particles, namely, π⁻¹Hₖπ=Hₖ, ∀π∈G_{*}, and satisfies [symbol] r|e^{-τH}^{ₖ}|q [symbol] =0 for any r∈ [symbol] and q∈ [symbol] that differ in more than a small constant number of degrees of freedom. Such an MSFS or Hamiltonian H is said to be sum-of-CFFs (SCFF), with SCFF serving as an adjective.

For all q∈ [symbol] and any k∈[1, K], the CFF interaction Hₖ, by its invariance under any exchange of identical particles, moves either all or none of the particles of each species around q. The species and fermions being moved by Hₖ, k∈[1, K] around q∈ [symbol] constitute a subsystem called a controlled few-fermion (CFF), which is associated with a factor subspace [symbol] ₖ(q) and a factor subgroup Gₖ(q)≤G_{*}, in the sense that, [symbol] ₖ′(q) and G′ₖ(q)≤G_{*} exist such that [symbol] ₖ(q)× [symbol] ₖ′(q)≅ [symbol] and Gₖ(q)×G′ₖ(q)≅G_{*}, with [symbol] ₖ(q) and Gₖ(q) respectively coordinating and permuting the particles in said CFF. Clearly, each Gₖ(q) is a normal subgroup of G_{*} and itself a direct product of a small number of normal subgroups from the list { [symbol] ₛ}_{s∈[1,s]}. Let Aₖ(q) denote the associated exchange alternating group, and define the corresponding full and even exchange symmetrization operators as [symbol] ₖ(q) [symbol] |Gₖ(q)|⁻¹ Σ_{π∈G}_{ₖ}_{(q)}(−1)^{π}π and εₖ(q) [symbol] |Aₖ(q)|⁻¹Σ_{π∈A}_{ₖ}_{(q)}(−1)^{π}π.

Despite an SCFF system having a large total number of particles N_{*}, it is always computationally easy to compute the boltzmannonic and fermionic Gibbs kernels [symbol] ⋅|e^{-τH}^{ₖ}|q [symbol] and [symbol] ⋅|e^{-τH}^{ₖ}| [symbol] q [symbol] , either analytically or numerically, with the complexity bounded by a constant, ∀(q, τ)∈ [symbol] ×(0, ∞), ∀k∈[1, K], since dim( [symbol] ₖ(q)) is always upper-bounded by a small constant. In particular, ∀(r,q)∈ [symbol] ², in the formula [symbol] [symbol] r|e^{-τH}^{ₖ}|q [symbol] =Σ_{π∈G}_{_{*}}(−1)^{π} [symbol] πr|e^{-τH}^{ₖ}|q [symbol] = [symbol] r|e^{-τH}^{ₖ}| [symbol] q [symbol] =Σ_{π∈G}_{_{*}}(−1)^{π} [symbol] r|e^{-τH}^{ₖ}|πq), even though the whole group G_{*} is used for the domain of exchange symmetry to simplify the mathematical notation, it is really only those permutations in the much smaller subgroup Gₖ(q) or Gₖ(r) that are active and relevant, since [symbol] πr|e^{-τH}^{ₖ}|q [symbol] =0 for all π [symbol] Gₖ(q) or [symbol] r|e^{-τH}^{ₖ}|πq [symbol] =0 for all π [symbol] Gₖ(r). Such efficient computability of [symbol] [symbol] ⋅|e^{-τH}^{ₖ}|⋅ [symbol] = [symbol] ⋅|e^{-τH}^{ₖ}| [symbol] ⋅) for all k∈[1, K] is the key for efficient simulation of an SCFF system, and by its universality, of any quantum system on a classical computer.

Definition 2. Let H=Σₖ₌₁^{K}Hₖ be a form sum defining an SCFF Hamiltonian, where λ₁(Hₖ)−λ₀(Hₖ)=Ω(1/poly(size(H))), ∀k∈[1, K]. The form sum is called a Lie-Trotter-Kato (LTK) decomposition, and H is called LTK-decomposed, when ∀ϵ>0, there exists an m∈ [symbol] , m=O(poly(size(H)+ϵ⁻¹)), such that the absolute value of [symbol] r|{Πₖ₌₁^{K}e^{-H}^{ₖ}^{/m}}^{m}| [symbol] q [symbol] − [symbol] r|e^{-H}| [symbol] q [symbol] is less than ϵ [symbol] r|e^{-H}|q [symbol] , ∀(r,q)∈ [symbol] ². The same form sum is called a ground-state projection (GSP) decomposition and H₀ [symbol] H is called GSP-decomposed, when ∀ϵ>0, there exist an m∈ [symbol] , m=O(poly(size(H)+ϵ⁻¹)) and a constant Aₘ>0 depending only on m, such that ∥Aₘ{Πₖ₌₁^{K}Πₖ}^{m}−Π₀∥<ϵ, where ∥⋅∥ denotes the operator norm, Πₖ [symbol] lim_{τ→∞}e^{-τ[H}^{ₖ}^{-λ}^{₀}^{(H}^{ₖ}^{)]} are projections to the ground state subspaces of Hₖ, ∀k∈[0, K].

The definition of an LTK- or GSP-decomposed Hamiltonian is inspired by the LTK product formula e^{-τH}=lim_{m→∞}{Πₖ₌₁^{K}e^{-τH}^{ₖ}^{/m}}^{m}, τ∈(0, ∞) in a suitable operator topology, which suggests to divide [0, τ] into time intervals delimited by time instants {τₙ [symbol] nδτ/K}_{n∈[0, N]}, or δτ [symbol] τ/m, N [symbol] mK and break the Gibbs operator e^{-τH} down into a sequence of Gibbs operators {Gₙ [symbol] [symbol] }n∈[1, N], so to compute the boltzmannonic and fermionic Gibbs kernels using the Feynman path integral, also known as the functional integration [17,18]. For all n∈ [symbol] and any K∈ [symbol] , the expression n∥K denotes the unique number such that (n∥K)∈[1, K] and (n∥K)≡n(mod K). Each Gibbs operator Gₙ and the spacetime domain [symbol] ×[τₙ₋₁, τₙ], n∈[1, N] constitute a Feynman slab, delimited by two Feynman planes ( [symbol] , τₙ₋₁) [symbol] {(qₙ₋₁, τₙ₋₁):qₙ₋₁∈ [symbol] } and ( [symbol] , τₙ) [symbol] {(qₙ, τₙ):qₙ∈ [symbol] } [9]. If necessary, each Feynman slab associated with a constant CFF interaction H_{n∥K}, n∈[1, N] can be further divided into thinner Feynman slices, each of which is defined by two Feynman planes separated by an interval of imaginary time that is as small as desired.

For Feynman slabs or slices that are sufficiently thin, there are simple rules for Feynman flights [9], which determine the associated Gibbs transition amplitude between two points q and r on two narrowly separated Feynman planes respectively. Said rules for Feynman flights induce a Wiener measure that assigns a non-negative Wiener density W(γ)=e^{-U(γ)} to each Feynman path γ, where U(⋅) is an action functional that is linear with respect to path concatenation, namely, U(γ)=U(γ₁)+U(γ₂) holds when two segments of Feynman paths γ₁ and γ₂ concatenate into a continuous Feynman path γ [symbol] γ₂*γ₁, which starts at the start point of a first segment γ₁, goes to the end point of γ₁ that coincides with the start point of a second segment γ₂, and continues till the end point of γ₂.

A number of consecutive Feynman slabs with the corresponding sequence of Gibbs operators {Gₙ}_{n∈[n}_{₁}ₙ_{₂}_{]}, 0<n₁≤n₂≤N constitute a Feynman stack with the two Feynman planes ( [symbol] , τₙ_{₀}) and ( [symbol] , τₙ_{₂}) forming its boundaries [9], where n₀ [symbol] n₁−1, ∀n₁∈ [symbol] . Pick two points (qₙ_{₀}, τₙ_{₂}) and (qₙ_{₂}, τₙ_{₂}) on the two boundary Feynman planes, the set of all Feynman paths

Γ(qₙ_{₂},τₙ_{₂};qₙ_{₀},τₙ_{₀}) [symbol] {γ(τ):τ∈[τₙ_{₀},τₙ_{₂}] [symbol] [symbol] such that γ(τₙ_{₀})=qₙ_{₀},γ(τₙ_{₂})=qₙ_{₂}} (4)

constitutes a Feynman spindle [9], which gives rise to a boltzmannonic Gibbs transition amplitude

$$\begin{matrix}ρ ( {q}_{{n}_{2}} , {τ}_{{n}_{2}} ; {q}_{{n}_{0}} , {τ}_{{n}_{0}} ) {=}^{def} {\int }_{γ ∈ Γ ( {q}_{{n}_{2}} , {τ}_{{n}_{2}} ; {q}_{{n}_{0}} , {τ}_{{n}_{0}} )} W ( γ ) d γ \\ = \int … \int \{ {\prod }_{n = {n}_{1}}^{{n}_{2}} 〈 {q}_{n} \vert {e}^{- δτ {H}_{n \vert \vert K}} \vert {q}_{n - 1} 〉 \} \\ \{ {\prod }_{n = {n}_{1}}^{{n}_{2} - 1} {dq}_{n} \} ,\end{matrix} \qquad ( 5 )$$

which can be exchange-symmetrized to produce a fermionic Gibbs transition amplitude

ρ(qₙ_{₂},τₙ_{₂}; [symbol] qₙ_{₀},τₙ_{₀}) [symbol] |G_{*}|^{-1Σ}_{π∈G}_{_{*}}(−1)^{π}ρ(qₙ_{₂},τₙ_{₂};πqₙ_{₀},τₙ_{₀}). (6)

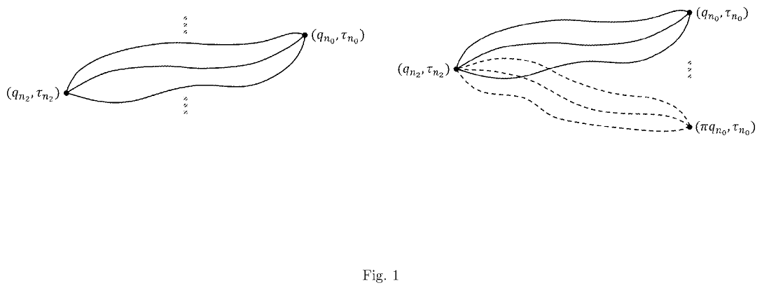

Note that the fermionic exchange symmetry is ignored in equation (5) and the integration over all particle-distinguished Feynman paths yields a non-negative definite, boltzmannonic Gibbs transition amplitude. FIG. 1 (left) shows a Feynman spindle from a start point (qₙ_{₀}, τₙ_{₂}) to an end point (qₙ_{₂}, τₙ_{₂}), with the gray ellipses indicating the presence of infinitely many other Feynman paths connecting the points (qₙ_{₀}, τₙ) and (qₙ_{₂}, τₙ_{₂}), where each Feynman path is assigned a non-negative Wiener density, and the integration of such Wiener density yields the boltzmannonic ρ(qₙ_{₂}, τₙ_{₂}; qₙ_{₀}, τₙ_{₀}). FIG. 1 (right) illustrates how exchange symmetrization induces an orbit of Feynman spindles from the G_{*}-orbit of the start point G_{*}qₙ_{₀}={πqₙ_{₀}: π∈G_{*}} to the end point qₙ_{₂}, where each Feynman spindle Γ(qₙ_{₂}, τₙ_{₂}; τₙ_{₀}, τₙ_{₂}), π∈G_{*} gives rise to a boltzmannonic ρ(qₙ_{₂}, τₙ_{₂}; πqₙ_{₀}, τₙ_{₀}) which is weighted by (−1)^{π} and makes a signed contribution to the fermionic ρ(qₙ_{₂}, τn₂; [symbol] qₙ_{₀}, τₙ_{₀}). The ellipsis in FIG. 1 right indicates the presence of many Feynman spindles starting from exchange-permuted configuration points.

The formulation of Feynman path integral is rightly suited for simulating a Gibbs kernel via Monte Carlo integration over a many- but finite-dimensional space. PIMC would realize BPP simulations of quantum systems, were it not for the sign problem [5, 6] due to the presence of negative amplitudes, particularly in fermionic systems. PIMC methods using RPIs [6, 19-22] have been proposed and applied to avoid negative amplitudes. But previous RPIs are only approximate methods as they rely on a priori approximations for the nodal surfaces of Gibbs kernels associated with the Hamiltonian of a whole system, which are unknown and hard to compute. Here I will show that for an SCFF Hamiltonian, negative amplitudes can be avoided by restricting Feynman paths locally, with respect to the efficiently computable nodal surface of a Gibbs kernel associated with an individual CFF interaction.

For a single Feynman slab associated with a CFF interaction Hₙ_{₁}_{∥K} between two Feynman planes ( [symbol] , τₙ_{₀}), ( [symbol] , τₙ_{₁}), τₙ_{₁}>τₙ_{₀}, n₁∈ [symbol] , n₀=n₁−1, the pre-symmetrized fermionic Gibbs kernel ρ(q, τ; [symbol] qₙ_{₀}, τₙ_{₀})

[symbol]

$$〈 q \vert {e}^{- ( τ - {τ}_{{n}_{0}} ) {H}_{{n}_{1} \vert \vert K}} \vert ℱ {q}_{{n}_{0}} 〉$$

is a (q, τ)-jointly continuous function of (q, τ)∈ [symbol] ×(τₙ_{₀}, ∞) for any fixed qₙ_{₀}∈ [symbol] . The preimage {(q, τ):ρ(q, τ; [symbol] qₙ_{₀}, τₙ_{₀}} is an open set, in which the unique ent that contains the trivial path {(qₙ_{₀}, τ):τ∈(τₙ_{₀}, ∞)}, denoted by [symbol] (qₙ_{₀}, τₙ_{₀}), is called the forward nodal tube or Ceperley reach of (qₙ_{₀}, τₙ_{₀}) [6, 9]. For any τ∈ (τₙ_{₀}, ∞), let [symbol] (τ; qₙ_{₀}, τₙ_{₀}) [symbol] [symbol] (;qₙ_{₀},τₙ_{₀})∩( [symbol] ×{τ}) which is clearly the nodal cell of ρ(⋅, τ; [symbol] qₙ_{₀}, τₙ_{₀}) containing the point ⋅=qₙ_{₀}. It follows from Hₙ_{₁}_{∥K} substantiating the Hopf lemma and the strong Hopf extremum principle that [symbol] (τ; qₙ_{₀}, τₙ_{₂}) as an open set-valued function of τ∈(τₙ_{₀}, ∞) is continuous; ∀(q, τ)∈ [symbol] ×(τₙ_{₀}, ∞), (q, τ)∈ [symbol] (qₙ_{₁}, τₙ_{₁}) if and only if q∈ [symbol] (τ; qₙ_{₀}, τₙ_{₀}) and a curve within [symbol] (τ; qₙ_{₀}, τₙ_{₀}) exists to connect q and qₙ_{₀}. Similarly, with respect to any fixed (qₙ_{₁}, τₙ_{₁}) and the post-symmetrized fermionic Gibbs kernel ρ( [symbol] qₙ_{₁}, τₙ_{₁}, q, τ), (q, τ)∈ [symbol] ×(−∞, τₙ_{₁}), define a backward nodal tube or Ceperley reach [symbol] (qₙ_{₁}, τₙ_{₁}), as the unique connected component of the open set {(q, τ):ρ( [symbol] qₙ_{₁}, τₙ_{₁}; q, τ)>0} that contains the trivial path {(qₙ_{₁}, τ):τ∈(−∞, τₙ_{₁})}, then define [symbol] (qₙ_{₁}, τₙ_{₁}; τ) [symbol] [symbol] (qₙ_{₁}, τₙ_{₁})∩( [symbol] ×{τ}), ∀τ∈(−∞, τₙ_{₁}), which is clearly the nodal cell of ρ( [symbol] qₙ_{₁}, τₙ_{₁}; (⋅, τ) containing the point ⋅=qₙ_{₁}. Also similarly, [symbol] (qₙ_{₁}, τₙ_{₁}; τ) as an open set-valued function of τ∈(−∞, τₙ_{₁}) is continuous; ∀(q, τ)∈ [symbol] ×(−∞, τₙ_{₁}), (q, τ)∈ [symbol] (qₙ_{₁}, τₙ_{₁}) if and only if q∈ [symbol] (qₙ_{₁}, τₙ_{₁}; τ) and a curve within [symbol] (qₙ_{₁}, τₙ_{₁}; τ) exists to connect q and qₙ_{₁}.

In a direct fermion path integral method [19], the fermionic Gibbs kernel {ρ(qₙ_{₁}, τₙ_{₁}; [symbol] qₙ_{₀},τₙ_{₀}):(qₙ_{₁}, qₙ_{₀})∈ [symbol] ² may be computed using two nested loops, where an outer loop walks the configuration points qₙ_{₁}∈ [symbol] and qₙ_{₀}∈ [symbol] , while an inner loop regards qₙ_{₁} and qₙ_{₀} as being fixed, repeatedly draws a random Feynman path γ from the orbit of Feynman spindles Γ(qₙ_{₁}, τₙ_{₁}; G_{*}qₙ_{₀}, τₙ_{₀}) [symbol] U_{π∈G}_{_{*}}Γ(qₙ_{₁}, τₙ_{₁}; πqₙ_{₀}, τₙ_{₀}) and integrates the signed Wiener density (−1)^{π}W(γ). The cancellation of positive and negative amplitudes severely degrades the efficacy of such direct Monte Carlo integration of a signed measure. It turns out that any Feynman path crossing or touching the boundary ∂ [symbol] (qₙ_{₀}, τₙ_{₀}) of the nodal tube [symbol] (qₙ_{₀}, τₙ_{₀}) belongs to an orbit of post-tethered Feynman spindles whose singed amplitude contributions cancel exactly.

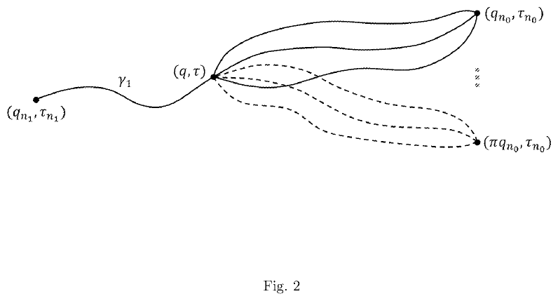

FIG. 2 illustrates an orbit of post-tethered Feynman spindle, which is a set of Feynman paths that come from an orbit of start points (G_{*}qₙ_{₀}, τₙ_{₀}) to a midpoint (q, τ) via all the different ways, then share a common segment of Feynman path γ₁ from the midpoint to an end point (qₙ_{₁}, τₙ_{₁}). For each π∈G_{*}, the set of concatenated Feynman paths γ₁*Γ(q, τ; πqₙ_{₀}, τₙ_{₀}) [symbol] {γ₁*γ₀:γ₀∈Γ(q, τ; πqₙ_{₀}, τₙ_{₀})} constitutes one post-tethered Feynman spindle, which yields a non-negative definite Wiener measure

$${\int }_{{γ}_{0} ∈ Γ ( q , τ ; π {q}_{{n}_{0}} , {τ}_{{n}_{0}} )} W ( {γ}_{1} ) W ( {γ}_{0} ) d {γ}_{0} = W ( {γ}_{1} ) ρ ( q , τ ; π {q}_{{n}_{0}} , {τ}_{{n}_{0}} ) . \qquad ( 7 )$$

With π traversing the group G_{*}, or only the subgroup Gₙ, (qₙ_{₀}) indeed, the orbit of post-tethered Feynman spindles γ₁*Γ(q, τ; G_{*}qₙ_{₁}, τₙ_{₀}) [symbol] {γ₁*Γ(q, τ; πqₙ_{₀}, τₙ_{₀})}_{π∈G}_{_{*}} is enumerated, with the corresponding Wiener measures signed accordingly and summed up to yield a fermionic transition amplitude

Σ_{π∈G}_{_{*}} (−1)^{π}W(γ₁)ρ(q,τ;πqₙ_{₀},τₙ_{₀})=W(γ₁)*ρ(q,τ; [symbol] qₙ_{₀},τₙ_{₀}), (8)

which becomes exactly zero when (q, τ)∈∂ [symbol] (qₙ_{₀}, τₙ_{₀}). Therefore, to compute the fermionic Gibbs kernel ρ(qₙ_{₁}, τₙ_{₁}; [symbol] qₙ_{₀}, τₙ_{₀}), it is sufficient to integrate over the set of [symbol] (qₙ_{₀}, τₙ_{₀})-restricted Feynman paths

Γ_{∈}(qₙ_{₁},τₙ_{₁};qₙ_{₀},τₙ_{₀}) [symbol] {γ(τ)⊆ [symbol] (qₙ_{₀},τₙ_{₀}):τ∈[τₙ_{₀},τₙ_{₁}],γ(τₙ_{₀})=qₙ_{₀},γ(τₙ_{₁})=qₙ_{₁}}, (9)

to obtain a forward restricted path integral

$$\begin{matrix}{ρ}_{∈} ( {q}_{{n}_{1}} , {τ}_{{n}_{1}} ; {q}_{{n}_{0}} , {τ}_{{n}_{0}} ) {=}^{def} {\int }_{γ ∈ {Γ}_{∈} ( {q}_{{n}_{1}} , {τ}_{{n}_{1}} ; {q}_{{n}_{0}} , {τ}_{{n}_{0}} )} W ( γ ) d γ \\ = \{ \begin{matrix}ρ ( {q}_{{n}_{1}} , {τ}_{{n}_{1}} ; & ∀ ( {q}_{{n}_{1}} , {τ}_{{n}_{1}} ) ∈ \\ ℱ {q}_{{n}_{0}} , {τ}_{{n}_{0}} ) , & 𝒯 ( ; {q}_{{n}_{0}} , {τ}_{{n}_{0}} ) , \\ 0 , & otherwise .\end{matrix}\end{matrix} \qquad ( 10 )$$

Γ_{∈}(qₙ_{₁}, τₙ_{₁}; qₙ_{₀}, τₙ_{₀}) is called a forward restricted Feynman spindle connecting (qₙ_{₀}, τₙ_{₀}) and (qₙ_{₁}, τₙ_{₁}), which comprises Feynman paths that never cross or touch the boundary ∂ [symbol] (qₙ_{₀}, τₙ_{₀}).

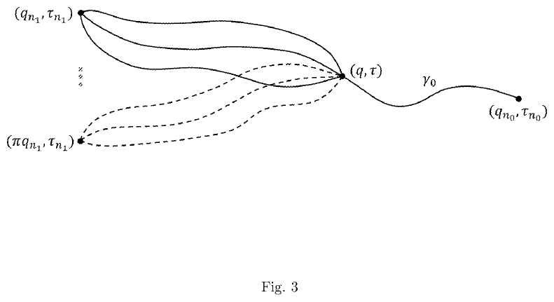

By the identity ρ( [symbol] qₙ_{₁}, τₙ_{₁}; qₙ_{₀}, τₙ_{₀})=ρ(qₙ_{₁}, τₙ_{₁}; [symbol] qₙ_{₀}, τₙ_{₀}), ∀(qₙ_{₁}, qₙ_{₀})∈ [symbol] ², a post-symmetrized fermionic Gibbs kernel ρ( [symbol] ⋅, τₙ_{₁}, τₙ_{₀}) can always be computed via the equivalent pre-symmetrized ρ(⋅, τₙ_{₁}; [symbol] ⋅, τₙ_{₀}) using the forward restricted path integral. Alternatively, one may invoke the backward nodal cell [symbol] (qₙ_{₁}, τₙ_{₁}) and consider an orbit of pre-tethered Feynman spindles Γ(G_{*}qₙ_{₁}, τₙ_{₁}; q, τ)*γ₀ [symbol] {Γ(πqₙ_{₁}, τₙ_{₁}; q, τ)*γ₀: π∈G_{*}}, (q, τ)∈ [symbol] ×(−∞, τₙ_{₁}) as depicted in FIG. 3, so to establish the sufficiency of integrating over the set of [symbol] (qₙ_{₁}, τₙ_{₁})-restricted Feynman paths

[symbol]

(qₙ_{₁},τₙ_{₁};qₙ_{₀},τₙ_{₀}) [symbol] {γ(τ)⊆ [symbol] (qₙ_{₁},τₙ_{₁}):τ∈[τₙ_{₀},τₙ_{₁}],γ(τₙ_{₀})=qₙ_{₀},γ(τₙ_{₁})=qₙ_{₁}}, (11)

to obtain a backward restricted path integral

$$\begin{matrix}{ρ}_{∋} ( {q}_{{n}_{1}} , {τ}_{{n}_{1}} ; {q}_{{n}_{0}} , {τ}_{{n}_{0}} ) {=}^{def} {\int }_{γ ∈ {Γ}_{∋} ( {q}_{{n}_{1}} , {τ}_{{n}_{1}} ; {q}_{{n}_{0}} , {τ}_{{n}_{0}} )} W ( γ ) d γ \\ = \{ \begin{matrix}ρ ( {ℱq}_{{n}_{1}} , {τ}_{{n}_{1}} ; & ∀ ( {q}_{{n}_{0}} , {τ}_{{n}_{0}} ) ∈ \\ {q}_{{n}_{0}} , {τ}_{{n}_{0}} ) , & 𝒯 ( {q}_{{n}_{1}} , {τ}_{{n}_{1}} ; ) , \\ 0 , & otherwise .\end{matrix}\end{matrix} \qquad ( 12 )$$

[symbol]

(qₙ_{₁}, τₙ_{₁}; qₙ_{₀}, τₙ_{₀}) is called a backward restricted Feynman spindle connecting (qₙ_{₀}, τₙ_{₀}) and (qₙ_{₁}, τₙ_{₁}), which comprises Feynman paths that never cross or touch the boundary ∂ [symbol] (qₙ_{₁}, τₙ_{₁}).

Therefore, for each single Feynman slab associated with a CF interaction Hₙ_{₁}_{∥K}, n₁∈ [symbol] , it is always easy to compute the fermionic Gibbs kernel ρ( [symbol] qₙ_{₁}, τₙ_{₁}; qₙ_{₀}, τₙ_{₀})=ρ(qₙ_{₁}, τₙ_{₁}; [symbol] qₙ_{₀}, τₙ_{₀}), ∀(qₙ_{₁}, qₙ_{₀})∈ [symbol] ², ∀τₙ_{₁}>τₙ_{₀}, n₀=n₁−1, since the cardinality of the group Gₙ_{₁}(qₙ_{₀}) or Gₙ_{₁}(qₙ_{₁}) is always upper-bounded by a small constant, and it is always easy to find a permutation π∈G_{*} to satisfy πqₙ_{₁}∈ [symbol] (qₙ_{₀}, τₙ_{₀}) such that ρ(qₙ_{₁}, τₙ_{₁}; [symbol] qₙ_{₀}, τₙ_{₀})=(−1)^{π}ρ(πqₙ_{₁}, τₙ_{₁}; [symbol] qₙ_{₀}, τₙ_{₀})=(−1)^{π}ρ_{∈}(πqₙ_{₁}, τₙ_{₁}; qₙ_{₀}, τₙ_{₀}), or to fulfill πqₙ_{₀}∈ [symbol] (qₙ_{₁}, τₙ_{₁}) such that ρ( [symbol] qₙ_{₁}, τₙ_{₁}; qₙ_{₀},τₙ_{₀})=(−1)^{π}ρ( [symbol] qₙ_{₁}, τₙ_{₁}, πqₙ_{₀}, τₙ_{₀})=(−1)^{π}ρ_{∈} (πqₙ_{₁}, τₙ_{₁}; qₙ_{₀}, τₙ_{₀}), where ρ_{∈}(πqₙ_{₁}, τₙ_{₁}; qₙ_{₀}, τₙ_{₀}) or ρ [symbol] (qₙ_{₁}, τₙ_{_{1; πq}}ₙ_{₀}, τₙ_{₀}) can be efficiently simulated by Monte Carlo for the forward or backward restricted path integral, so long as the nodal surface ∂ [symbol] (qₙ_{₀}, τₙ_{₀}) or δ [symbol] (qₙ_{₁}, τₙ_{₁}) is known or efficiently computable. Indeed, for any CFF interaction Hₙ_{₁}_{∥K}, n₁∈ [symbol] and a fixed q∈ [symbol] , the eigen system of Hₙ_{₁}_{∥K} or an associated Gibbs operator

$${e}^{- τ {H}_{{n}_{1} ∥ K}} , τ > 0 ,$$

restricted to the configuration space [symbol] ₙ_{₁}_{∥K}(q), can be solved either analytically or numerically at a constant computational cost, which enables efficient computation of any related fermionic Gibbs kernel and nodal surfaces.

Now consider to compute the Gibbs transition amplitude ρ(q_{N}, τ_{N}; [symbol] q₀, τ₀) for any given (q_{N}, q₀)∈ [symbol] ² with respect to a full Feynman stack associated with a sequence of Gibbs operators {Gₙ [symbol] e^{-δτH}^{_{n∥K}}}_{n∈[1, N]}, N∈ [symbol] , By the identity ρ(πq_{N}, τ_{N}; [symbol] q₀, τ₀)=(−1)^{π}ρ(πq_{N}, τ_{N}; [symbol] q₀,τ₀), ∀(q_{N}, q₀)∈ [symbol] ², ∀π∈G_{*} and the fact that the orbit of any nodal cell tiles up the configuration space C under the group action of G_{*} [6, 9], it is sufficient and WLOG to limit q_{N} to the nodal cell [symbol] (τ_{N}; q₀, τ₀), which is the connected component of the open set {q∈ [symbol] :ρ(q, τ_{N}; [symbol] q₀, τ₀)>0} that contains the point q=q₀. On the other hand, the identity ρ(εq_{N}, τ_{N}; [symbol] q₀,τ₀) [symbol] |A_{*}|⁻¹ Σ_{π∈A}_{_{*}} ρ(πq_{N}, τ_{N}; [symbol] q₀, τ₀)=ρ(q_{N}, τ_{N}; [symbol] q₀,τ₀), ∀(q_{N}, q₀)∈ [symbol] ² can be used freely to multiply an point q_{N} into orbit of end points A_{*}q_{N}, all of which lead to the same-valued fermionic Gibbs transition amplitude. The same can be done for a start point. Such multiplication of an end or start point to its A_{*}-orbit is called alternating broadcast.

By Feynman's rule of amplitude multiplication for events occurring in succession [17], which may be viewed as a generalization of the Chapman-Kolmogorov equation in probability theory to signed densities, the fermionic Gibbs transition amplitude ρ(q_{N}, τ_{N}; [symbol] q₀, τ₀) can be computed as

$$\begin{matrix}ρ ( {q}_{N} , {τ}_{N} ; ℱ {q}_{0} , {τ}_{0} ) = {\int }_{{q}_{1} ∈ C} ρ ( {q}_{N} , {τ}_{N} ; {q}_{1} , {τ}_{1} ) \\ ρ ( {q}_{1} , {τ}_{1} ; ℱ {q}_{0} , {τ}_{0} ) {dq}_{1} \\ = {\int }_{{q}_{1} ∈ {G}_{*} {R}_{1} ( {q}_{0} )} ρ ( {q}_{N} , {τ}_{N} ; {q}_{1} , {τ}_{1} ) \\ ρ ( {q}_{1} , {τ}_{1} ; ℱ {q}_{0} , {τ}_{0} ) {dq}_{1} \\ = {C}_{1} ( {q}_{0} ) {\sum }_{π ∈ {G}_{*}} {\int }_{{q}_{1} ∈ {𝒩}_{1} ( {q}_{0} )} ρ ( {q}_{N} , {τ}_{N} ; π {q}_{1} , {τ}_{1} ) \\ ρ ( π {q}_{1} , {τ}_{1} ; ℱ {q}_{0} , {τ}_{0} ) {dq}_{1} \\ = {C}_{1} ( {q}_{0} ) {\sum }_{π ∈ {G}_{*}} {\int }_{{q}_{1} ∈ {𝒩}_{1} ( {q}_{0} )} ρ ( {q}_{N} , {τ}_{N} ; π {q}_{1} , {τ}_{1} ) \\ {( - 1 )}^{π} ρ ( {q}_{1} , {τ}_{1} ; ℱ {q}_{0} , {τ}_{0} ) {dq}_{1} \\ = {C}_{1} ( {q}_{0} ) \vert {G}_{*} \vert {\int }_{{q}_{1} ∈ {𝒩}_{1} ( {q}_{0} )} ρ ( {q}_{N} , {τ}_{N} ; ℱ {q}_{1} , {τ}_{1} ) \\ ρ ( {q}_{1} , {τ}_{1} ; ℱ {q}_{0} , {τ}_{0} ) {dq}_{1} ,\end{matrix} \qquad ( 13 )$$

where [symbol] ₁(q₀) is the boltzmannonic reach of q₀ by H_{1∥K}, G_{*} [symbol] ₁(q₀) [symbol] ∪{π [symbol] ₁(q₀):π∈G_{*}} is the set of points that are boltzmannonically reachable from any point in the orbit G_{*}q₀, [symbol] ₁(q₀) [symbol] [symbol] (τ₁; q₀, τ₀), the third equality follows from the fact that [symbol] ₁(q₀) tiles up G_{*} [symbol] ₁(q₀) under the group action of G_{*} [6, 9], and C₁⁻¹(q₀) [symbol] |G_{*}|V_{g}( [symbol] ₁(q₀))/V_{g}(G_{*} [symbol] ₁(q₀)) is an integer counting how many times each point q∈G_{*} [symbol] ₁(q₀) almost surely is covered by the orbit of nodal cells {π [symbol] ₁(q₀):π∈G_{*}}, which is efficiently computable for any q₀∈C since H_{1∥K} is a CFF interaction. Then one uses alternating broadcast and proceeds as

$$\begin{matrix}ρ ( {q}_{N} , {τ}_{N} ; ℱ {q}_{0} , {τ}_{0} ) = ρ ( {ℰq}_{N} , {τ}_{N} ; ℱ {q}_{0} , {τ}_{0} ) \\ = {C}_{1} ( {q}_{0} ) \vert {G}_{*} \vert {\int }_{{q}_{1} ∈ {𝒩}_{1} ( {q}_{0} )} ρ ( ℰ {q}_{N} , {τ}_{N} ; ℱ {q}_{1} , {τ}_{1} ) \\ ρ ( {q}_{1} , {τ}_{1} ; ℱ {q}_{0} , {τ}_{0} ) {dq}_{1} \\ = {C}_{1} ( {q}_{0} ) \vert {G}_{*} \vert {\int }_{{q}_{1} ∈ {𝒩}_{1} ( {q}_{0} )} ρ ( ℰ {q}_{N} , {τ}_{N} ; ℱ {q}_{1} , {τ}_{1} ) \\ ρ ( ℰ {q}_{1} , {τ}_{1} ; ℱ {q}_{0} , {τ}_{0} ) {dq}_{1} \\ = 2 {C}_{1} ( {q}_{0} ) {\sum }_{{π}_{1} ∈ {A}_{*}} {\int }_{{q}_{1} ∈ {𝒩}_{1} ( {q}_{0} )} ρ ( ℰ {q}_{N} , {τ}_{N} ; \\ ℱ {q}_{1} , {τ}_{1} ) ρ ( {π}_{1} {q}_{1} , {τ}_{1} ; ℱ {q}_{0} , {τ}_{0} ) {dq}_{1} \\ = 2 {C}_{1} ( {q}_{0} ) {\sum }_{{π}_{1} ∈ {A}_{*}} {\int }_{{q}_{1} ∈ {𝒩}_{1} ( {π}_{1} {q}_{0} )} ρ ( ℰ {q}_{N} , {τ}_{N} ; \\ ℱ {q}_{1} , {τ}_{1} ) {ρ}_{∈} ( {q}_{1} , {τ}_{1} ; {π}_{1} {q}_{0} , {τ}_{0} ) {dq}_{1} ,\end{matrix} \qquad ( 14 )$$

so to have the first Feynman slab path-rectified, namely, represented by equivalent, non-negative definite, restricted path integrals ρ_{∈}(q₁, τ₁; π₁q₀, τ₀), each of which with a π₁∈A_{*} and a q₁∈ [symbol] ₁(π₁q₀) sums up non-negative Wiener densities of [symbol] (; π₁q₀, τ₀)-restricted paths.

It is straightforward to repeat the same procedure inductively and have all of the Feynman slabs path-rectified, so that ρ(q_{N}, τ_{N}; [symbol] q₀, τ₀) becomes an integral of all non-negative definite contributions as

$$\begin{matrix}ρ ( {q}_{N} , {τ}_{N} ; ℱ {q}_{0} , {τ}_{0} ) = ρ ( ℰ {q}_{N} , {τ}_{N} ; ℱ {q}_{0} , {τ}_{0} ) \\ = {\{ 2 {C}_{n} ( {q}_{n - 1} ) {\sum }_{{π}_{n} ∈ {A}_{*}} {\int }_{{q}_{n} ∈ {𝒩}_{n} ( {π}_{n} {q}_{n - 1} )} \}}_{n = 1}^{N - 1} \\ ρ ( ℰ {q}_{N} , {τ}_{N} ; ℱ {q}_{N - 1} , {τ}_{N - 1} ) \\ \times {\prod }_{n = 1}^{N - 1} {ρ}_{∈} ( {q}_{n} , {τ}_{n} ; {π}_{n} {q}_{n - 1} , {τ}_{n - 1} ) {\prod }_{n = 1}^{N - 1} {dq}_{n} \\ = {\{ 2 {C}_{n} ( {q}_{n - 1} ) {\sum }_{{π}_{n} ∈ {A}_{*}} {\int }_{{q}_{n} ∈ {𝒩}_{n} ( {π}_{n} {q}_{n - 1} )} \}}_{n = 1}^{N - 1} \\ {ρ}_{∈} ( {q}_{N} , {τ}_{N} ; {π}_{N} {q}_{N - 1} , {τ}_{N - 1} ) \\ \times {\prod }_{n = 1}^{N - 1} {ρ}_{∈} ( {q}_{n} , {τ}_{n} ; {π}_{n} {q}_{n - 1} , {τ}_{n - 1} ) {\prod }_{n = 1}^{N - 1} {dq}_{n} ,\end{matrix} \qquad ( 15 )$$

where [symbol] ₙ(qₙ₋₁) [symbol] [symbol] (τₙ; qₙ₋₁, τₙ₋₁) denotes the nodal cell of ρ(⋅, τₙ; [symbol] qₙ₋₁, τₙ₋₁) containing the point qₙ₋₁, Cₙ⁻¹ (qₙ₋₁) [symbol] |G_{*}|V_{g}( [symbol] ₙ(qₙ₋₁))/V_{g}(G_{*} [symbol] ₙ(qₙ₋₁)) is an efficiently computable integer counting how many times each point q∈G_{*} [symbol] ₙ(qₙ₋₁) is covered by the orbit of nodal cells {π [symbol] ₙ(qₙ₋₁):π∈G_{*}}, with [symbol] ₙ(qₙ₋₁) denoting the boltzmannomic reach of qₙ₋₁ by H_{n∥K}, for all n∈[1, N] and any qₙ₋₁∈ [symbol] . It is worth nothing that all path rectifications in equation (15) are done on a per Feynman slab basis, only requiring a solution for the nodal surface of the CFF interaction associated with each Feynman slab, which can be obtained at no more than a polynomial computational cost to within a polynomial accuracy, because every CFF interaction moves no more than a small constant number of degrees of freedom around any given configuration point. An alternative derivation of equation (15) uses equation (13) repeatedly for each of the Feynman slabs indexed by n∈[1, N−1] and takes advantage of the idempotency property of the exchange symmetrization operator to insert an [symbol] to the start point of each of the Gibbs transition amplitudes associated with the Feynman slabs [23,24] and obtain an identity

ρ(q_{N}, [symbol] _{N}; [symbol] q₀,τ₀)={Cₙ(qₙ₋₁)|G_{*}| [symbol] }ₙ₌₁^{N-1}ρ(q_{N},τ_{N}; [symbol] q_{N-1},τ_{N-1})×ₙ₌₁^{N-1}ρ(qₙ,τₙ; [symbol] qₙ₋₁,τₙ₋₁)Πₙ₌₁^{N-1}dqₙ, (16)

then path-rectifies each of the Feynman slabs, replaces ρ(qₙ_{₁}, τₙ; [symbol] qₙ₋₁, τₙ₋₁) by ρ_{∈}(qₙ_{₁}, τₙ; qₙ₋₁, τₙ₋₁) in accordance with equation (10), and uses alternating broadcast, for all n∈[1, N−1].

Equation (15) represents ρ(q_{N}, τ_{N}; [symbol] q₀, τ₀) by an RPI comprising restricted Feynman paths of the form γ_{N}*γ_{N-1}* . . . *γ₂*γ₁ with γₙ∈Γ_{∈}(qₙ, τₙ; qₙ₋₁, τₙ₋₁), qₙ∈ [symbol] ₙ(πₙ, qₙ₋₁), πₙ∈A_{*} for all n∈[1, N], where the restricted Feynman paths appear to undergo abrupt coordinate jumps in the space [symbol] ×[τ₀, τ_{N}] due to the frequent insertion of even permutations. In reality, such apparent coordinate jumps do not represent actual physical discontinuities, since all points in any orbit A_{*}q, q∈ [symbol] are physically equivalent and represent the same physical reality. Indeed, the restricted Feynman paths are actually continuous in the space (C/A_{*})×[τ₀, τ_{N}], where C/A_{*} is an orbifold regarding each orbit A_{*}q, q∈ [symbol] as a single point. A practical and effective means to incorporate such exchange equivalence is to have each point on a Feynman plane at time τₙ associated with a couple (πn, qₙ), n∈[0, N], which specify two equivalent coordinates qₙ∈ [symbol] and πₙqₙ∈A_{*}qₙ, with qₙ serving the Feynman stack or slice from τₙ₋₁ to τₙ, and πₙqₙ being used by the Feynman stack or slice from τₙ to τₙ₊₁. An even permutation πₙ∈A_{*} could be interpreted as the effect of a fermionic Gibbs kernel associated with an infinitesimally thin Feynman slice [25].

The insertion of a finite number of Feynman planes, here being done naturally for a Feynman stack associated with a sequence of Gibbs operators {Gₙ [symbol] e^{-δτH}^{_{n∥K}}}_{n∈[1, N]}, N∈ [symbol] , turns a Feynman path integral (or functional integration) into a finite-dimensional integral over a so-called cylinder set Cyl [symbol] {(q_{N}, . . . , qₙ, . . . , q₀): qₙ∈ [symbol] , ∀n∈[0, N]} consisting of cylinder points, where [symbol] = [symbol] /A_{*} or [symbol] = [symbol] depending upon whether alternating broadcast is used, every cylinder point of the form (q_{N}, . . . , qₙ, . . . , q₀) actually represents a series of connected Feynman spindles, each of which as specified by a pair of consecutive coordinates (qₙ, qₙ₋₁)∈ [symbol] ², n∈[1, N] integrates under a prescribed Wiener measure into a Gibbs transition amplitude ρ(qₙ,τₙ; [symbol] qₙ₋₁, τₙ₋₁). A restricted cylinder set ResCyl is a subset of Cyl consisting of restricted cylinder points (RCPS) of the form (q_{N}, . . . , qₙ, . . . , q₀) subject to the constraint that ∀n∈[1, N], qₙ∈ [symbol] (qₙ₋₁), or qₙ∈A_{*} [symbol] (qₙ₋₁) when alternating broadcast is used, in which case a (restricted) cylinder point may be specified by a particular representative of the form (π_{N}, q_{N}; . . . ; πₙ, qₙ; . . . ; π₀=1, q₀), with each couple (πₙ, qₙ)∈∈ [symbol] /A_{*}, n∈[0, N] representing a configuration point on the quotient manifold [symbol] /A_{*}.

Equations (10), (12), and (15) provide a general method for simulating any quantum SCFF system or Hamiltonian on a classical computer using Monte Carlo without a numerical sign problem. A Monte Carlo procedure may employ either a homogeneous Markov chain sampling an RCP as a whole from the cylinder set ( [symbol] /A_{*})^{N+1}, or an inhomogeneous Markov chain driving a random walk in discrete time n∈[0, N] over the configuration space [symbol] /A_{*}, involving a Markov transition associated with ρ_{∈}(⋅, [symbol] ₙ; ⋅, [symbol] ₙ₋₁) for each n∈[1, N], so to evolve an initial probability distribution Pr(π₀=1, q₀), (π₀, q₀)∈∈∈ [symbol] /A_{*} into a sequence of probability distributions {Pr(πₙ, qₙ; . . . ; π₀=1, q₀):n∈[0, N]} for Markov sample paths, with P₀ being essentially the positive part of a wavefunction ψ₀, while the probability Pr(π_{N}, q_{N}; . . . ; π₀, q₀) of any Markov sample path (π_{N}, q_{N}; . . . ; π₀, q₀) at the end is proportional to the Wiener density of (π_{N}, q_{N}; . . . ; π₀, q₀) as an RCP. Also, a suitable boundary condition should be chosen for the Feynman planes at the two ends. One usual choice enforces periodicity by identifying the 0-th and N-th Feynman planes as one and the same. Another frequent choice provides a known probability distribution in q₀ or q_{N}∈ [symbol] /A_{*} at each end.

In one exemplary embodiment of Markov chain Monte Carlo (MCMC) using a homogenous chain to sample RCPs subject to the periodic boundary condition, a suitable random coordinate q₀∈ [symbol] /A_{*} is chosen such that it extends into an initial RCP {qₙ=q₀}ₙ₌₁^{N} as a suitable start point, then the RPI of equation (15) is approximated by iterating three steps of random moves to wiggle the RCP for a predetermined and poly(size( [symbol] ))-bounded number of times. At the start of each iteration, let (π_{N}, q_{N}; . . . ; πₙ, qₙ; . . . ; π₀=1, q₀) denote the instantaneous RCP. The first step draws a random integer n∈[1, N] uniformly to name the n-th component of the instantaneous RCP, that is a couple (πₙ, qₙ)∈∈ [symbol] /A_{*} representing a configuration point on the n-th Feynman plane. Let the couples (π_{(n-1)∥}, q_{(n-1)∥N}) (π_{(n+1)∥N}, q_{(n+1)∥N})∈∈ [symbol] /A_{*} be associated with the Feynman planes immediately before or after the n-th Feynman plane. The second step simply chooses a π∈A_{*} uniformly and makes the substitutions πₙ←ππₙ, qₙ←πqₙ, π_{(n+1)∥N}←π_{(n+1)∥N}π⁻¹. The third step performs a random walk of qₙ∈ [symbol] using either Metropolis-Hastings or Gibbs sampling [26-28] in accordance with a conditional probability

Pr(qₙ| . . . ) [symbol] Pr(qₙ|π_{(n+1)∥N};q_{(n+1)∥N};πₙq_{(n-1)∥N})∝C_{(n+1)∥N}(qₙ)ρ_{∈}(q_{(n+1)∥N},τ_{(n+1)∥N};π_{(n+1)∥N}qₙ,τₙ)×Cₙ(q_{(n-1)∥N})ρ_{∈}(qₙ,τₙ,πₙq_{(n-1)∥N},τ_{(n-1)∥N}) (17)

which vanishes whenever qₙ∉ [symbol] (πₙq_{(n-1)∥N}) or qₙ₊₁ [symbol] [symbol] _{n+1)∥N}(π_{(n+1)∥N}qₙ). In an exemplary sampler, a random coordinate rₙ is drawn according to the probability distribution Pr(rₙ| . . . ), rₙ∈ [symbol] , then a substitution qₙ←rₙ is executed to update the coordinate. Note that the conditional probability Pr(qₙ| . . . ) is always efficiently computable, since all of the C·(⋅) and ρ_{∈}(⋅) quantities involve CFF interactions and can be computed either analytically or numerically at a constant cost.

Another exemplary embodiment uses the method of reputation quantum Monte Carlo (RQMC) [9, 29-31] and path integral to compute a mirror-symmetric sequence of Gibbs operators {Gₙ}ₙ₌₁^{2N} with Gₙ [symbol] e^{-δτH}^{ₙ}, ∀n∈[1, N] and Gₙ [symbol] G_{2N-n+1}, ∀n∈[N+1, 2N], where N=(m+1)K, K∈ [symbol] , m∈ [symbol] , and the constant δτ∈(0, ∞) is sufficiently small such that ∀l∈[0, m], the product operator Π_{n=1K+1}^{(l+1)K} Gₙ is substantially the same as the Gibbs operator exp[−δτH(l)], with H(l) [symbol] Σ_{n=1K+1}^{(l+1)K}Hₙ being an LTK-decomposed SCFF Hamiltonian. With the boundary condition that assigns a probability density Pr(q₀)=max(0, ϕ₀(q₀))/D₀ for all q₀∈ [symbol] /A_{*} at the start on the first Feynman plane and similarly at the end, D₀ [symbol] ½∫_{q∈} [symbol] _{/A}_{_{*}}|ϕ₀(q)|dq, ϕ₀∈L²( [symbol] /A_{*}) being any given MFS wavefunction, the method of RQMC computes the expectation value of any G_{*}-invariant, ( [symbol] /G_{*})-diagonal operator V under G_{*}|ϕ₀ [symbol] , G_{*} [symbol] Πₙ₌₁^{N}Gₙ through

$$\frac{〈 {ϕ}_{0} \vert {G}_{*}^{+} {VG}_{*} \vert {ϕ}_{0} 〉}{〈 {ϕ}_{0} \vert {G}_{*}^{+} {G}_{*} \vert {ϕ}_{0} 〉} = \frac{{\int }_{ξ ∈ ResCyl} {ϕ}_{0} ( ξ [ 2 N ] [ 1 ] ) V ( ξ [ N ] [ 1 ] ) W ( ξ ) d ξ}{{\int }_{ξ ∈ ResCyl} {ϕ}_{0} ( ξ [ 2 N ] [ 1 ] ) W ( ξ ) d ξ} , \qquad ( 18 )$$

where ξ [symbol] (π_{2N}, q_{2N}; . . . ; πₙ, qₙ; . . . ; π₀=1, q₀) traverses the restricted cylinder set ResCyl, and ∀ξ∈ResCyl, ∀n∈[0, 2N], ξ[n] [symbol] (πₙ, qₙ) denotes the n-th component of ξ, ξ[n][0] [symbol] πₙ, ξ[n][1] [symbol] qₙ, W(ξ) is the Wiener density at the RCP ξ=(π_{2N}, q_{2N}; . . . ; πₙ, qₙ; . . . ; π₀, q₀) evaluated as

W(ξ) [symbol] W(πₙ,qₙ; . . . ;π₀,q₀) [symbol] ϕ₀(q₀)Πₙ₌₁^{2N}{Cₙ(qₙ₋₁)ρ_{∈}(qₙ, [symbol] ₙ;πₙqₙ₋₁, [symbol] ₙ₋₁)}, (19)

where τₙ [symbol] nδτ, ∀n∈[0, 2N], the ∫_{ξ∈ResCyl}dξ operation on the right-hand side of equation (18) involves integrating q₀ over a nodal cell of ϕ₀, then for each n∈[1, 2N], integrating qₙ over the nodal cell [symbol] (πₙqₙ₋₁) and summing πₙ over A_{*}. In practice, the integration ∫_{ξ∈ResCyl}dξ is of course approximated by summing up a finite number of RCPs obtained by importance sampling through an MCMC procedure.

Interestingly, the desired RCP samples can be generated by running an inhomogeneous Markov chain over the state space [symbol] /A_{*} when the CFF interactions satisfy a suitable condition. The inhomogeneous Markov chain starts with a random walker having an initial probability density Pr(π₀=1, q₀), (π₀, q₀)∈∈ [symbol] /A_{*}, proceeds inductively in steps indexed by n∈[1, 2N] and records a sequence of configuration coordinates as a Markov sample path or trajectory of the random walker. At the beginning of each step n∈[1, 2N], the walker has reached a point (πₙ₋₁, qₙ₋₁)∈∈ [symbol] /A_{*} via a Markov sample path (πₙ₋₁, qₙ₋₁; . . . ; π₀=1, q₀), which is associated with a probability density Pr(πₙ₋₁, qₙ₋₁; . . . ; π₀, q₀). The walker then undergoes a Markov transition from the present position (πₙ₋₁, qₙ₋₁) to a new coordinate (πₙ, qₙ)∈∈ [symbol] /A_{*}, qₙ∈ [symbol] (λₙqₙ₋₁) in accordance with a Markov transition probability

$$Pr ( {q}_{n} \vert {π}_{n} {q}_{n - 1} ) = \frac{{C}_{n} ( {q}_{n - 1} ) {ρ}_{∈} ( {q}_{n} , {τ}_{n} ; {π}_{n} {q}_{n - 1} , {τ}_{n - 1} )}{\begin{matrix}{D}_{n} ( {q}_{n - 1} ) {=}^{def} \\ \{ {C}_{n} ( {q}_{n - 1} ) \int {ρ}_{∈} ( {r}_{n} , {τ}_{n} ; {π}_{n} {q}_{n - 1} , {τ}_{n - 1} ) {dr}_{n} \}\end{matrix}} , \qquad ( 20 )$$

so to extend the Markov sample path into (πₙ, qₙ; . . . ; π₀, q₀) with a probability

Pr(πₙ,qₙ; . . . ;π₀,q₀)=Pr(qₙ|πₙqₙ₋₁)Pr(πₙ₋₁,qₙ₋₁; . . . ;π₀,q₀),

where Dₙ(qₙ₋₁) is called the amplitude integral of ρ(⋅,τₙ; πₙqₙ₋₁,τₙ₋₁)= [symbol] ⋅|e^{-(τ}^{ₙ}^{-τ}^{_{n−1}}^{)H}^{ₙ}|qₙ₋₁ [symbol] over the nodal cell containing πₙqₙ₋₁∈ [symbol] . At the end, the inhomogeneous Markov chain generates a Markov sample path (π_{2N}, q_{2N}; . . . ; π₀, q₀) with an associated probability density

$$Pr ( {π}_{2 N} , {q}_{2 N} ; … ; {π}_{0} , {q}_{0} ) = Pr ( {π}_{0} , {q}_{0} ) {\prod }_{n = 1}^{2 N} Pr ( {q}_{n} \vert {π}_{n} {q}_{n - 1} ) = \frac{W ( {π}_{2 N} , {q}_{2 N} ; … ; {π}_{0} , {q}_{0} )}{{\prod }_{n = 1}^{2 N} {D}_{n} ( {q}_{n - 1} )} , \qquad ( 21 )$$

which is substantially the same as the Wiener density W(π_{2N}, q_{2N}; . . . ; π₀, q₀) at (π_{2N}, q_{2N}; . . . ; π₀, q₀) as an RCP representing a series of restricted Feynman spindles, when the sequence of Gibbs operators {Gₙ}ₙ₌₁^{N} is amplitude integral-balanced as defined below, such that, running said inhomogeneous Markov chain repeatedly and independently generates a polynomial number of Markov sample paths that are effectively RCPs and can be used to estimate to within a polynomial accuracy the expectation value of any G_{*}-invariant, ( [symbol] /G_{*})-diagonal observable V according to equation (18).

Definition 3. A sequence of Gibbs operators {Gₙ [symbol] e^{-τH}^{ₙ}}ₙ₌₁^{N}, N∈ [symbol] , τ∈(0, ∞) in association with a sequence of CFF interactions {Hₙ}ₙ₌₁^{N} is said to be amplitude integral-balanced (AIB), when the product Πₙ₌₁^{N} Dₙ(qₙ₋₁), with Dₙ(qₙ₋₁) being defined as in equation (20), always evaluates into the same constant for any RCP (π_{N}, q_{N}; . . . ; π₀=1, q₀) with (π₀, q₀)∈∈ [symbol] A_{*}, πₙ∈A_{*}, qₙ∈ [symbol] (πₙqₙ₋₁), ∀n∈[1, N].

Yet another exemplary embodiment uses RQMC and path integral to compute a mirror-symmetric sequence of Gibbs operators {Gₙ}ₙ₌₁^{2N} with Gₙ [symbol] e^{-τH}^{ₙ}, ∀n∈[1, N] and Gₙ [symbol] G_{2N-n+1}, ∀n∈[N+1,2N], where N=(m+1)m₀K, K∈ [symbol] , m₀∈ [symbol] , m∈ [symbol] , Hₗₘ_{₀}_{K+n}=Hₗₘ_{₀}_{K+(n∥K)} for all l∈[0, m] and for all n∈[1, m₀K], the constant τ=O(poly(size [symbol] ))∈(0, ∞) is no longer small but sufficiently large such that ∀n∈[1, N], Gₙ is essentially the same as Πₙ=lim_{t→∞}e^{-t[H}^{ₙ}^{-λ}^{₀}^{(H}^{ₙ}^{)]} up to an error that is exponentially small, while m₀=O(poly(size( [symbol] ))) is sufficiently large such that ∀l∈[0, m], G(l) [symbol] Πₙ₌ₗₘₙ_{₀}_{K+1}^{(l+1)m}^{₀}^{K}Gₙ is essentially the same as Π(l)=lim_{t→∞}e^{-t{H(l)-λ}^{₀}^{[H(l)]}} up to a constant Aₘ_{₀}>0 and an error that is O(1/poly(m₀)), with H(l) [symbol] Σₖ₌ₗₘ_{₀}_{K+1}^{(l+1)m}^{₀}^{K}Hₖ being a GSP-decomposed SCFF Hamiltonian. If the sequence of Gibbs operators {Gₙ}ₙ₌₁^{N} is AIB, then it is efficiently simulatable via Monte Carlo in exactly the same manner as described above when dealing with LTK-decomposed Hamiltonians.

Major Utility 1. Let {Gₙ [symbol] e^{-τH}^{ₙ}}ₙ₌₁^{N}, N∈ [symbol] , τ∈(0, ∞) be an AIB sequence of Gibbs operators associated with a sequence of SCFF Hamiltonians {Hₙ}ₙ₌₁^{N} supported by space [symbol] and satisfying λ₁(Hₙ)−λ₀(Hₙ)=Ω(1/poly(size( [symbol] ))), ∀n∈[1, N]. There is a fully polynomial randomized approximation scheme (FPRAS) [32] to estimate [symbol] V [symbol] [symbol] [symbol] ϕ₀|G_{*}⁺VG_{*}|ϕ₀ [symbol] / [symbol] ϕ₀|G_{*}⁺G_{*}|ϕ₀ [symbol] >0 with G_{*} [symbol] Πₙ₌₁^{N} Gₙ, for any given MFS wavefunction ϕ₀∈L²( [symbol] /A_{*}) and any G_{*}-invariant, ( [symbol] /G_{*})-diagonal operator V≥0.

Demonstration. As specified above, running an inhomogeneous Markov chain for an O(poly(size( [symbol] ), ϵ⁻¹)) number of times can generate a sufficient number of RCPs to produce an estimate V_{*}∈ [symbol] according to equation (18), such that Pr{|(V_{*}− [symbol] V [symbol] )/ [symbol] V [symbol] |<ϵ}>⅔. For any n∈[1, N], any (πₙ, qₙ, qₙ₋₁)∈A_{*}× [symbol] ², since Hₙ is an CFF interaction with λ₁(Hₙ)−λ₀(Hₙ)=Ω(1/poly(size( [symbol] ))), the Markov transition probability Pr(qₙ|πₙqₙ₋₁) of equation (20) is always efficiently computable with an O(poly(ϵ)) accuracy at an O(poly(ϵ⁻¹)) cost either analytically or using a deterministic or randomized numerical routine, the mixing time of each said Markov transition moving no more than a small constant number of degrees of freedom is always O(poly(size( [symbol] ), ϵ⁻¹))-bounded. The overall runtime is clearly O(poly(size( [symbol] ), N, ϵ⁻¹)). □

A particular application of RQMC and Major Utility 1 is to simulate the ground state of a given Hamiltonian, where an AIB sequence of Gibbs operators {Gₙ [symbol] e^{-τH}^{ₙ}}ₙ₌₁^{N}, N∈ [symbol] , τ∈(0, ∞) is associated with sequence of SCFF Hamiltonians {H(l)}ₗ₌₀^{m}, m∈ [symbol] , which evolves adiabatically from an initial Hamiltonian H(0) with a known non-degenerate ground state ϕ₀ [symbol] ψ₀(H(0)) to a final Hamiltonian H(m) [9] whose ground state ϕₘ [symbol] ψ₀(H(m)) is of interest, where each H(l), l∈[0, m] is an SCFF Hamiltonian with a non-degenerate and polynomial-gapped ground state, whose defining form sum H(l)=Σₖ₌₁^{K}Hₗₘ_{₀}_{K+k} is LTK-decomposed with m₀=1 or GSP-decomposed with m₀=O(poly(size( [symbol] )))∈ [symbol] , while Hₗₘ_{₀}_{K+n}=Hₗₘ_{₀}_{K+(n∥K)} for all 1∈[0, m] and all n∈[1, m₀K] in both cases. Clearly, N [symbol] (m+1)m₀K. For an LTK-decomposition, the time constant τ is sufficiently small such that the difference between e^{-τH(l)} and Πₖ₌₁^{K}e^{-τH}^{_{lK+k}} is sufficiently small for all l∈[0, m], whereas for a GSP-decomposition, the time constant τ is sufficiently large such that the Gibbs operator Gₙ is exponentially close to Πₙ=lim_{t→∞}e^{-t[H}^{ₙ}^{-λ}^{₀}^{(H}^{ₙ}^{)]} for all n∈[1, N], while m₀ is sufficiently large such that G(l) [symbol] Πₙ₌ₗₘ_{₀}_{K=1}^{(l+1)m}^{₀}^{K} Gₙ is essentially the same as Π(l)=lim_{t→∞}e^{-t{(H(l)-λ}^{₀}[H(l)]} up to a constant for all l∈[0, m]. Finally, m is chosen sufficiently large such that ∥H(l+1)−H(l)∥=O(1/poly(m)) is sufficiently small comparing to λ₁[H(l)]−λ₀[H(l)] for all l∈[0, m]. As such, the final H(m) is called an adiabatic-reachable SCFF Hamiltonian. Major Utility 1 guarantees an FPRAS for simulating the ground state ϕm of an adiabatic-reachable SCFF Hamiltonian H(m), producing a good estimate for the expectation value [symbol] ϕₘ|V|ϕₘ [symbol] / [symbol] ϕₘ|ϕₘ [symbol] of any G_{*}-invariant, ( [symbol] /G_{*})-diagonal observable V≥0.

Not only SCFF Hamiltonians can be simulated efficiently, but also they are universal for many-body physics and quantum computing. For any θ∈[−π, π), let R(θ) [symbol] I cos θ+XZ sin θ denote a rotation gate and R(θ) [symbol] Z cos θ+X sin θ denote an R-gate [9,13], where X [symbol] σₓ and Z [symbol] σ_{z} are the familiar Pauli matrices acting on a single rebit as the simplest quantum system ( [symbol] ₀, [symbol] ₀, [symbol] ₀), with [symbol] [symbol] {0, 1}, [symbol] ₀ [symbol] {α|0 [symbol] +β|1 [symbol] : α, β∈ [symbol] }, [symbol] ₀ being the Banach algebra of 2×2 real matrices. Define Z^{±} [symbol] (I±Z)/2. It is well known that controlled rotation gates of the form I⊗Z⁺+R(θ₀)⊗Z⁻ all using the same angle θ₀∈[−π, π) are already universal for quantum computation, when θ₀/π is irrational [9,12]. In this specification, any universal quantum computing process is allowed to use any controlled rotation gate U(θ) [symbol] I⊗Z⁺+R(θ)⊗Z⁻ with any angle θ∈[−π, π), each of which is realized by a controlled R-gate R(θ/2)⊗Z⁺+R(−θ/2)⊗Z⁻ followed by a free R-gate R(θ/2)=R(θ/2)⊗I. The following will show that any BQP computing process given as an ordered sequence of free or controlled R-gates {Uₜ(θₜ) [symbol] Rᵢ₍ₜ₎(θₜ) or Rᵢ₍ₜ₎(θₜ)⊗Zⱼ₍ₜ₎⁺+Rᵢ₍ₜ₎(−θₜ)⊗Zⱼ₍ₜ₎⁻}_{t∈[1,T]}, T∈ [symbol] on a quantum computer of n∈ [symbol] rebits can be mapped to an LTK- or GSP-decomposed SCFF Hamilton generating an AIB sequence of Gibbs operators, where each R-gate Rᵢ₍ₜ₎(θₜ), θt∈[−π, π) acts on a rebit indexed by an i(t)∈[1, n], and Zᵢ₍ₜ₎^{±} operate on a control rebit indexed by a j(t)∈[1, n], ∀t∈[1, T]. Such a BQP computing process, or its associated quantum circuit, is said have a computational size T+n.

Definition 4. A homophysics [symbol] :( [symbol] , [symbol] , [symbol] ) [symbol] ( [symbol] ′, [symbol] ′, [symbol] ′) between two quantum systems with Hamiltonians H∈ [symbol] and H′∈ [symbol] ′ is an injective mapping at sends any subset [symbol] ⊆ [symbol] to a unique [symbol] ′ [symbol] [symbol] ( [symbol] )⊆ [symbol] ′, maps any ψ∈ [symbol] to a unique ψ′ [symbol] [symbol] (ψ)∈ [symbol] ′, and sends any [symbol] ∈ [symbol] to a unique [symbol] ′ [symbol] [symbol] ( [symbol] )∈ [symbol] ′, such that [symbol] ⊇ [symbol] [symbol] [symbol] ( [symbol] )⊆ [symbol] ′ embeds the Boolean algebra of subsets [ [symbol] ] of [symbol] into the Boolean algebra of subsets of [symbol] ′; [symbol] ) [symbol] [symbol] ψ [symbol] [symbol] (ψ)∈ [symbol] embeds the Hilbert space [symbol] into [symbol] ′; 3) [symbol] [symbol] ∈ [symbol] [symbol] ( [symbol] )∈ [symbol] ′ embeds the Banach algebra [symbol] into [symbol] ′; [symbol] ) there exists a constant c>0, c+c⁻¹=O(poly(size(H))), with which [symbol] [symbol] (ψ)| [symbol] ( [symbol] )| [symbol] (ϕ) [symbol] =c [symbol] ψ| [symbol] |ϕ [symbol] holds ∀ψ, ϕ∈ [symbol] , ∀ [symbol] ∈ [symbol] ; 5) size(H)=O(poly(size(H′))) and size(H′)=O(poly(size(H). An homophysics [symbol] is called an isophysics when the mapping [symbol] is also surjective.

Firstly, it is useful to construct a bi-fermion system ( [symbol] ₁, [symbol] ₁, [symbol] ₁) consisting of two non-interacting identical fermions moving on a circle [symbol] [symbol] [symbol] /2 [symbol] [9], governed by a single-particle Hamiltonian −(½)∂²/∂x²+V(x), x∈ [symbol] with an external potential V(x)=V₀[d(x, 0)>1−a₀]_{Iver}−V₀[d(x,0)<1−a₀]_{Iver}, x∈[−1,1) (mod 2)≅ [symbol] , a₀=γ₀¹, V₀=γ₀², β₀>>1 being a large constant, where d(x,y) denotes the geodesic distance between x∈ [symbol] and y∈ [symbol] along the circle, [⋅]_{Iver}, is an Iverson bracket [34] which returns a number valued to 1 or 0 depending on if the Boolean expression inside the bracket is true or false. When γ₀ is sufficiently large, the potential well and barrier become essentially Dirac deltas, V(x)≅γ₀δ(x+1)−γ₀δ(x), x∈[−1, 1) (mod 2), such that a bi-fermion under a nominal Hamiltonian H_{BF}=(γ₀²−π²)/2+Σᵢ₌₁²[−(½)∂²/∂xᵢ²+V(xᵢ)], (x₁, x₂)∈ [symbol] ² behaves like a rebit with two low-energy states

ψ+(x₁,x₂)=(1−π₁₂)sin π[d(x₁,0)−a₀]e^{-γ}^{₀}^{d(x}^{₂}^{,0)},(x₁,x₂)∈[−1,1)², (22)

ψ−(x₁,x₂)=(1−π₁₂)sin πx₁e^{-γ}^{₀}^{d(x}^{₂}^{,0)},(x₁,x₂)∈[−1,1)², (23)

that are degenerate at E₀=0, where π₁₂ is the fermion exchange operator swapping the particle labels 1 and 2. Choose α₀=2γ₀⁻¹ log γ₀, then for all x such that d(x, 0)>α₀, the amplitude of the single-particle bound state |e^{-γ}^{₀}^{d(x,0)}|γ₀⁻², which is rather small. Construct potential functions

X(x₁,x₂)=γ₀(1+π₁₂)[d(x₁,0)>1−a₀∧d(x₂,0)<α₀]_{Iver}−(π²/4γ₀²), (24)

Z⁺(x₁,x₂)=(1+π₁₂)[d(x₁,+½)<½∧d(x₁,0)>α₀∧d(x₂,0)<α₀]_{Iver}, (25)

Z⁻(x₁,x₂)=(1+π₁₂)[d(x₁,−½)<½∧d(x₁,0)>α₀∧d(x₂,0)<α₀]_{Iver}, (26)

∀(x₁,x₂)∈[−1,1)²≅ [symbol] ², which can be regarded as {1, π₁₂}-invariant, [symbol] ²-diagonal operators. It is straightforward to verify that such a bi-fermion implements a rebit [9] through a homophysics [symbol] ₁:( [symbol] ₀, [symbol] ₀, [symbol] ₀) [symbol] ( [symbol] ₁, [symbol] ₁, [symbol] ₁) such that, with |± [symbol] [symbol] (|0 [symbol] ±|1 [symbol] )/\sqrt{1},

[symbol]

₁(|± [symbol] ∈ [symbol] ₀)=ψ±(x₁,x₂)∈ [symbol] ₁, (27)

[symbol]

₁(X∈ [symbol] ₀)=(2γ₀²/π²)[H_{BF}+X(x₁,x₂)]∈ [symbol] ₁, (28)

[symbol]

₁(Z^{±}∈ [symbol] ₀)=γ₀H_{BF}+Z^{±}(x₁,x₂)∈ [symbol] ₁. (29)

Via linear combinations, the operators [symbol] ₁(X), [symbol] (Z⁺), [symbol] ₁(Z⁻) generate all partial Hamiltonians that are of interest for quantum computing on a single bi-fermion, because span{X, Z⁺, Z⁻} contains all Hermitian elements in [symbol] ₀. It is noted in passing that, although it is preferred for the single-particle potential V(x), x∈ [symbol] to have a narrow and deep potential well around x=0, approximating a fairly strong Dirac delta to localize one of the two fermions in a small neighborhood of x=0, there is no practical necessity other than convenience of mathematical analysis, to require a steep potential barrier around x=±1. Rather, it is perfectly fine to place a relatively wide and low potential barrier, as long as its width and height are chosen properly to be commensurate with the Delta-like potential well around x=0, such that the nominal bi-fermion Hamiltonian H_{BF} defines a degenerate two-state Hilbert space implementing a rebit.

Next, it is straightforward to construct a homophysics [symbol] ₂:( [symbol] ₀², [symbol] ₀², [symbol] ₀²) [symbol] ( [symbol] ₁², [symbol] ₀², [symbol] ₀²), with [symbol] ᵢ² [symbol] [symbol] ᵢ× [symbol] ᵢ, [symbol] ᵢ² [symbol] [symbol] ᵢ⊗ [symbol] ᵢ, [symbol] ᵢ² [symbol] [symbol] ᵢ⊗ [symbol] ᵢ, ∀i∈{0,1}, so to implement a pair of interacting rebits using two bi-fermions conditioned and interacting through the following partial Hamiltonians,

[symbol]

₂(X₁⊗Z₂^{±})=(2γ₀²/π²)[H_{BF,1}+H_{BF,2}+X(x₁₁,x₁₂)Z^{±}(x₂₁,x₁₂)], (30)

[symbol]

₂(Z₁^{±}⊗Z₂^{±})=γ₀H_{BF,1}+γ₀H_{BF,2}+Z^{±}(x₁₁,x₁₂)Z^{±}(x₂₁,x₂₂), (31)

where ∀i∈{1, 2}, Xᵢ, Zᵢ^{±}, Zᵢ=Zᵢ⁺−Zᵢ⁻ are the X- and Z-gates on the i-th rebit, H_{BF,i} is the nominal Hamiltonian of the i-th bi-fermion, (xᵢ₁, xᵢ₂)∈ [symbol] ² is the two-fermion configuration of the i-th bi-fermion. X₁⊗Z₂^{±} and Z₁⊗Z₂^{±} are called single-rebit-controlled gates, whose linear combinations include all single-rebit-controlled R gates, which are already universal for ground state quantum computation (GSQC) [3, 9, 14, 15, 35] in the sense that, using the so-called perturbative gadgets, up to an error tolerance ϵ>0, the low-energy physics of any system of n∈ [symbol] rebits und a computationally k-local Hamiltonian, k∈ [symbol] being a fixed number, can be homophysically mapped to the low-energy physics of another system of poly(n, ϵ⁻¹) rebits under a Hamiltonian that involves only one-body and two-body interactions, especially the controlled R-gates, whose operator norms are upper-bounded by poly(ϵ⁻¹) [13, 36-38]. In particular, the “XX from XZ gadget” of Biamonte and Love [13] can be employed to effect homophysically an X⊗X interaction between a first and a second rebits through X⊗Z interactions with a zeroth rebit,

I−X₁⊗X₂ [symbol] γ₀²(I−X₀)+(I−X₁⊗X₂) [symbol] β₀²(I−X₀)+γ₀(X₁+X₂)⊗Z₀+2I+O(γ₀⁻¹), (32)

where [symbol] reads and stands for “is homophysically mapped to”, γ₀>>1 is a large constant. Then the linear combinations of X⊗X and X⊗Z include all two-rebit interactions of the form X⊗R(θ), with R(θ) [symbol] Z cos θ+X sin θ, θ∈[−π, π). Alternatively, there is a special class of multi-rebit interactions called multi-rebit-controlled gates of the form Rᵢ(θ)⊗Π_{j∈J}Zⱼ^{±}, with θ∈[−π, π), i indexing a rebit being operated upon, J being a set indexing a fixed number of control rebits. Such a multi-rebit-controlled R-gate does not require a decomposition into two-rebit couplings, but can be implemented through a linear combination of the following homophysics,

[symbol]

(Xᵢ⊗Π_{j∈J}Zⱼ^{±})=(2γ₀²/π²)[H_{BF,i}+Σ_{j∈J}H_{BF,j}+X(xᵢ₁,xᵢ₂)Π_{j∈J}Z^{±}(xⱼ₁,xⱼ₂)], (33)

[symbol]

(Zᵢ^{±}⊗Π_{j∈J}Zⱼ^{±})=γ₀H_{BF,i}+γ₀Σ_{j∈J}H_{BF,j}+Z^{±}(xᵢ₁,xᵢ₂)Π_{j∈J}Z^{±}(xⱼ₁,xⱼ₂), (34)

At any rate, it has been established that any computationally k-local Hamiltonian H involving n∈ [symbol] rebits, with k∈ [symbol] being a fixed number and n a variable, can be homophysically implemented as an SCFF Hamiltonian [symbol] (H) involving no more than poly(n, ϵ⁻¹) bi-fermions, such that the low-energy physics of H and [symbol] (H) are homophysical up to an error tolerance ϵ>0, where each CFF interaction in [symbol] (H) moves no more than k′∈ [symbol] bi-fermions, with k′ being another fixed number, and has an operator norm that is upper-bounded by poly(ϵ⁻¹), while all bi-fermions are mutually distinguishable entities.

Given a universal BQP computing process {Uₜ(θₜ) [symbol] Rᵢ₍ₜ₎(θₜ) or Rᵢ₍ₜ₎(θₜ)⊗Zⱼ₍ₜ₎⁺+Rᵢ₍ₜ₎(−θₜ)⊗Zⱼ₍ₜ₎⁻}_{t∈[1,T]}, T∈ [symbol] , with each free or controlled R-gate Uₜ(θₜ), θₜ∈[−π, π) operating on an i(t)-th, i(t)∈[1, n] and possibly a j(t)-th, j(t)∈[1, n] rebits in an n-rebit logic ter represented by ( [symbol] _{L} [symbol] {0, 1}ⁿ, [symbol] _{L}, [symbol] _{L}) as a quantum subsystem, ∀t∈[1, T], where the of the free or controlled R-gates are meant to generate a series of quantum states |ϕₜ [symbol] _{L} [symbol] Uₜ|ϕₜ₋₁ [symbol] _{L}, t∈[1, T], from a given initial state |ϕ₀ [symbol] _{L} till a computational result |ϕ_{T} [symbol] _{L}=(Πₜ₌₁^{T}Uₜ)|ϕ₀ [symbol] _{L} at the end, the celebrated Feynman-Kitaev construct [3, 9, 14, 15] introduces a clock register represented by ( [symbol] _{C}, [symbol] _{C}, [symbol] _{C}) as a quantum subsystem to support clock states {|t [symbol] _{C}}_{t∈[0, T]}⊆ [symbol] _{C}, so that the clock and logic registers constitute a GSQC system represented by ( [symbol] _{C}× [symbol] _{L}, [symbol] _{C}⊗ [symbol] _{L}, [symbol] _{C}⊗ [symbol] _{L}), on which the product states {|t [symbol] _{C}|ϕₜ [symbol] _{L}}_{t∈[0, T]}⊆ [symbol] _{C}⊗ [symbol] _{L} map and encode the entire computational history of the BQP computing process. Then Feynman's clocked Hamiltonians H_{Feyn, t} [symbol] |t [symbol] _{C} [symbol] (t−1)|_{C}⊗(Uₜ+|(t−1) [symbol] _{C} [symbol] t|_{C}⊗Uₜ, t∈[1, T] ensure that the associated quantum gates Uₜ, t∈[1, T] are applied to the logic register in the correct order when the clock register undergoes transitions between what he called the program counter sites (namely, the clock states, also referred to as clock sites) |t [symbol] _{C}, t∈[1, T] [3]. Finally, Kitaev's GSQC Hamiltonian (also called the Feynman-Kitaev Hamiltonian) H_{FK} [symbol] H_{clock}+Hᵢₙᵢₜ+Hₚᵣₒₚ enforces computational constraints via energy penalties, with H_{clock} restricting the clock register to the manifold of span({|t [symbol] _{C}:t∈[0, T]}), Hᵢₙᵢₜ setting the initial state, while Hₚᵣₒₚ performing the quantum computation as Feynman suggested, such that the ground state ψ₀(H_{FK})=(T+1)^{-1/2}Σₜ₌₀^{T}|t [symbol] _{C}|ϕₜ [symbol] _{L} is unique and polynomially gapped [14, 15]. It is WLOG to assume that the initial state |ϕ₀ [symbol] _{L} is a [symbol] _{L}-coordinate eigenstate, because, otherwise, it must be preparable from a [symbol] _{L}-coordinate eigenstate by another BQP computing process. It is convenient and WLOG to assume that all logic rebits are initially set to their |1 [symbol] state [12].

There are several choices of encoding a clock register for the clock states {|t [symbol] _{C}}_{t∈[0,T] [}39,40]. Take Kitaev's domain wall clock for example which can be realized by a clock register consisting of T+2 rebits indexed by integers within [0, T+1] and using |t [symbol] _{C} [symbol] |1 [symbol] _{C}^{⊗(t+1)}|0 [symbol] _{C}^{⊗(T-t+1)}, t∈[0, T], such that [9, 14, 15]

H_{FK} [symbol] γ₀H_{clock}+γ₀Hᵢₙᵢₜ+Σₜ₌₁^{T}H_{prop,t}, (35)

H_{clock} [symbol] Z_{C,0}⁺+Z_{C,T+1}⁻+Σₜ₌₁^{T}Z_{C,t-1}⁺⊗Z_{C,t}⁻, (36)

Hᵢₙᵢₜ [symbol] Σᵢ₌₁ⁿZ_{C,1}⁺⊗Z_{L,i}⁺, (37)

H_{prop,t} [symbol] Z_{C,t-1}⁻⊗Z_{C,t+1}⁺⊗[I−X_{C,t}⊗Uₜ(θₜ)],∀t∈[1,T], (38)

where θₜ∈[−π, π) for all t∈[1, T], [symbol] _{C,t}^{δ} means to apply a single-rebit operator [symbol] ^{δ} to the t-th rebit of the clock register, ∀ [symbol] ∈{X, Z}, ∀δ∈{+, −, void}, ∀t∈[0, T+1], the energy constant γ₀>0 is sufficiently large but still O(poly(T+n))-bounded such that the system can only move in the ground state subspace of H_{clock}+Hᵢₙᵢₜ, any escape from ψ₀(H_{clock}+Hᵢₙᵢₜ) is exponentially suppressed and negligible. It is clear that size(H_{FK})=O(T+n). With each of Z_{C,t}^{±}, t∈[0, T+1], Z_{L,i}⁺, i∈[1, n], and h_{prop,t} [symbol] I−X_{C,t}⊗Uₜ, t∈[1, T] regarded as a single operator, the Feynman-Kitaev Hamiltonian H_{FK} is a sum of few-body moving (FBM) tensor monomials [9] as specified in equations (36-38), each of which is a tensor product of no more than three single operators that involves no more than five interacting rebits in total. For each t∈[1, T], the single operator h_{prop,t} and the FBM tensor monomial H_{prop,t}=Z_{C,t-1}⁻⊗Z_{C,t+1}⁺⊗h_{prop,t} are called the t-th free and controlled Feynman-Kitaev propagators respectively.

It is straightforward to implement such an H_{FK} into an [symbol] (H_{FK}) for a system of 2T+n+2 bi-fermions, where each of the T+2 clock rebits and n logic rebits corresponds to one unique bi-fermion, each of the FBM tensor monomials in equations (36) and (37) is mapped to an interaction among the corresponding bi-fermions as in equation (34), while the remaining T bi-fermions supply enough auxiliary rebits for perturbative gadgets to implement logic gates of the form X⊗R(θ), θ∈[−π, π) for Feynman-Kitaev propagators. Such an [symbol] (H_{FK})=Σₖ₌₁^{K} [symbol] (Hₖ), K [symbol] 2T+n+2 as an SCFF Hamiltonian is both LTK-decomposed and GSP-decomposed, with each FBM tensor monomial Hₖ, k∈[1, K] being either of the form Z₁^{±}⊗Z₂^{±} or a tensor product of an FBM tensor monomial Z₁⁻⊗Z₂⁺ and a free Feynman-Kitaev propagator h_{prop,t}, t∈[1, T], where Z₁ and Z₂ represent a Z-operator acting on a clock or logic rebit. The unique ground state of [symbol] (H_{FK}) can be simulated using Monte Carlo on a classical computer by repeating a sequence of Gibbs operators {exp[−τ [symbol] (Hₖ)]}ₖ₌₁^{K} with a suitable τ>0 such that τ+τ⁻¹=O(poly(T+n)) for an O(poly(T+n))-bounded number of times to approximates a Gibbs operator associated with [symbol] (H_{FK}). It is also straightforward to construct an adiabatic sequence of Feynman-Kitaev Hamiltonians {H_{FK}(l):l∈[0, m]} that evolves from an initial H_{FK}(0) with a known ground state ψ₀(H_{FK}(0)) to the final H_{FK}(0)=H_{FK} of equation (35). An exemplary embodiment uses an adiabatic sequence of Feynman-Kitaev Hamiltonians with the l-th Hamiltonian H_{FK}(l) [symbol] γ₀H_{clock}+γ₀Hᵢₙᵢₜ+Σₜ₌₁^{T}H_{prop,t}(l), H_{prop,t}(l) [symbol] Z_{C,t}⁻⊗Z_{C,t+1}⁺⊗h_{prop,t}(l), and h_{prop,t}(l) [symbol] I−X_{C,t}⊗Uₜ(lθₜ/m), ∀l∈[0, m], in conjunction with an initial ground state

ψ₀(H_{FK}(0) [symbol] (T+1)^{-1/2}Σₜ₌₀^{T}|t [symbol] _{C}|ϕ₀ [symbol] _{L}.

For a sequence of Gibbs operators {exp[−τ [symbol] (Hₖ)]}ₖ₌₁^{K}, τ>0 associated with a sequence of FBM tensor monomials {Πₖ}ₖ₌₁^{K} LTK- and GSP-decomposing a Feynman-Kit H_{FK}=Σₖ₌₁^{K}Hₖ, when Hₖ, k∈[1, K] is ( [symbol] _{C}× [symbol] _{L})-diagonal of the form Z₁^{±}⊗Z₂^{±}, it is obvious that exp[−τ [symbol] (Hₖ)] has the same amplitude integral Dₖ(πₖqₖ₋₁) with respect to any πk∈A_{*} and any qₖ₋₁ in the support of any ground state of [symbol] (Z₁^{±}⊗Z₂^{±}), while the probability of encountering a qₖ₋₁ out of the supports of the ground states of [symbol] (Z₁^{±}⊗Z₂^{±}) can be made negligible by choosing a sufficiently large energy constant γ₀. For a Gibbs operator of the form exp[−τ [symbol] (X⊗R(2θ))], θ∈[−π/2, π/2), the only relevant states are the two ground states |+ [symbol] |θ₊ [symbol] , |− [symbol] |θ₋ [symbol] and the two lowest excited states |+ [symbol] |θ₋ [symbol] , |− [symbol] |θ₊ [symbol] , with |± [symbol] [symbol] (|0 [symbol] ±|1 [symbol] )/\sqrt{2}, |θ₊ [symbol] [symbol] cos θ|0 [symbol] +sin θ|1 [symbol] , |θ₋ [symbol] [symbol] _{cos θ|}1 [symbol] −sin θ|0 [symbol] . It is easy to verify that for any of the cases of qₖ₋₁ falling into the support of the basis state [symbol] (|0 [symbol] |0 [symbol] ), [symbol] (|0 [symbol] |1 [symbol] ), [symbol] (|1 [symbol] |0 [symbol] ), or [symbol] (|1 [symbol] |1 [symbol] ), the amplitude integral Dₖ(qₖ₋₁) of [symbol] ⋅|exp[−τ [symbol] (X⊗R(2θ))]|qₖ₋₁ [symbol] always yields the same value (1+e_{-τ})+(1−e^{-τ})(|cos 2θ|+|sin 2θ|), so long as the strength of the Dirac potential barrier and well for each bi-fermion is set to γ₀>0, which is sufficiently large such that the wavefunction within each logic well of each bi-fermion always approximates a half-sine with an O(γ₀⁻²) error [9]. Therefore, any Gibbs operator exp[−τ [symbol] (X⊗(R(2θ))] associated with a free Feynman-Kitaev propagator involving a free R-gate R(2θ) does not induce any path dependency of amplitude integrals. It follows straightforwardly that the same is true for a Gibbs operator associated with a free Feynman-Kitaev propagator involving a controlled R-gate R(2θ)⊗Z⁺+R(−2θ)⊗Z⁻ because the amplitude integral yields the same value regardless of the control logic rebit is in the null state of Z⁺ or Z⁻. Finally, any Gibbs operator exp[−τ [symbol] (Z⁻⊗Z⁺⊗(I−X⊗U))] associated with a controlled Feynman-Kitaev propagator with any τ=O(poly(T+n)) can be realized by repeating applications of G_{free}(δτ) [symbol] exp[−δτ [symbol] (I−X⊗(U)] followed by G_{ctrl}(δτ) [symbol] exp[−δτ [symbol] (Z⁻⊗Z⁺⊗(I−X⊗U)+(I−Z⁻⊗Z⁺)⊗(I+X⊗U))] for m=O(poly(T+n)) times, δτ [symbol] τ/m, such that each of G_{free}(δτ) and G_{ctrol}(δτ) is already AIB, and the product operator exp[−τ [symbol] (Z⁻⊗Z⁺⊗(I−X⊗U))]=[G_{ctrl}(δτ)G_{free}(δτ)]^{m}+O(1/poly(m)) is naturally AIB.

Major Utility 2. A homophysics [symbol] exists, which maps the Feynman-Kitaev Hamiltonian H_{FK} as defined in equations (35-38) to an SCFF Hamiltonian [symbol] (H_{FK}) that is both LTK- and GSP-decomposed into a sequence of CFF interactions, such that any Gibbs operator generated by [symbol] (H_{FK}) is well approximated by an AIB sequence of Gibbs operators generated by said sequence of CFF interactions.

Demonstration. An [symbol] (H_{FK}) as constructed above is obviously SCFF and frustrate-free [9, 41, 42], which is both LTK- and GSP-decomposed into a sequence of CFF interactions, where each CFF interaction homophysically implements one of the FBM tensor monomials in equations (36-38), involves no more than 6 bi-fermions and moves even less. For any τ>0, τ=O(poly(T+n)), an AIB sequence of an O(poly(T+n)) number of Gibbs operators can be generated from the sequence of CFF interactions as described above, whose product approximates exp[−τ [symbol] (H_{FK})] to within an O(1/poly(T+n)) accuracy. □

It is noted that the above-specified technique to render a sequence of Gibbs operators AIB is only by way of example but no means of limitation. It should be obvious to one skilled in the art that many other ways can achieve the same effect. Furthermore, the AIB property is only used for mathematical rigor in theory to establish rapid mixing of one particular Monte Carlo sampling method. A practical Monte Carlo simulation can sample restricted Feynman paths efficiently using an alternative method without requiring an AIB property of the associated sequence of Gibbs operators.

Major Utility 3. BQP⊆BPP, therefore BPP=BQP, as BPP⊆BQP is well known.

Demonstration. Using the Feynman-Kitaev construct as specified equations (35-38), any BQP computing process of T∈ [symbol] gates on a quantum register of n∈ [symbol] rebits can be mapped to the ground state of a Feynman-Kitaev Hamiltonian H_{FK} of an O(poly(T+n)) size, whose ground state is non-degenerate and polynomial-designed gapped. Moreover, an adiabatic sequence of Feynman-Kitaev Hamiltonians {Π_{FK}(l)}ₗ₌₀^{m}, m∈ [symbol] can De designed to reach the final H_{FK}(m)=H_{FK} from an initial H_{FK}(0) with trivial Feynman-Kitaev propagators h_{prop,t}(0) [symbol] I−X_{C,t}, ∀t∈[1,T] and a trivial ground state ψ₀(H_{FK}(0)) [symbol] (T+1)^{-1/2} Σₜ₌₀^{T}|t [symbol] _{C}|ϕ₀ [symbol] _{L}. By Major Utility 2, each H_{FK}(l), l∈[0,m] can be homophysically mapped to an SCFF Hamiltonian [symbol] [H_{FK}(l)] that is both LTK- and GSP-decomposed into a sequence of CFF interactions, which generates an AIB sequence of Gibbs operators to project out the ground state ψ₀(H_{FK}(l)) to within an O(1/poly(T+n)) accuracy. Major Utility 1 guarantees an FPRAS, which is in BPP, to simulate an AIB sequence of Gibbs operators comprising concatenated subsequences of Gibbs operators, each subsequence corresponding to an H_{FK} (l), l∈[0, m]. This establishes BQP⊆BPP, therefore BPP=BQP. □

In conclusion, it has been proved that BPP and BQP are exactly the same computational complexity class. As a consequence, any computational problem admitting a BQP computing process has a BPP solution by mapping the BQP computing process into a GSQC problem, and simulating the GSQC system by Monte Carlo on a BPP machine. The overall method is called Monte Carlo quantum computing (MCQC) [9]. The significance of BPP=BQP can hardly be overstated. Despite providing a negative answer to the long outstanding question of whether the laws of quantum mechanics endow more computational power, it opens up new avenues for developing and identifying efficient computing processes for classical computers from the vantage point of quantum computing. Any quantum based or inspired solution to a computational problem translates automatically into an efficient classical probabilistic computing process. For instance, it is now certain that integer factorization is in BPP, thanks to Shor's celebrated quantum discovery [43] that catalyzed the quest of quantum computing. Besides the standard decision or promise problems [44-46] in BPP=BQP, there are a vast number of problems in the forms of function evaluation, objective optimization, and target search, etc. [46] that are either equivalent or polynomially reducible to a problem in BQP, therefore, also efficiently solvable via MCQC. An excellent example is the quantum computing process of Harrow, Hassidim, and Lloyd for linear systems of equations [47], which now gets an efficient MCQC implementation.

Being able to simulate quantum systems efficiently was one of the reasons that Feynman and others proposed quantum computing and quantum computers [3, 4]. One important application of MCQC without a sign problem is naturally to simulate many-body quantum systems efficiently via Monte Carlo on a classical computer, by just constructing a BQP computing process simulating the quantum system, then mapping the BQP computing process to an efficient MCMC through a Feynman-Kitaev construct. Such many-body quantum systems include any FSFS as a special case.

On the other hand, an FSFS can be directly simulated via a restricted path integral method without devising a BQP computing process then using a Feynman-Kitaev construct. In one exemplary embodiment for an FSFS of S∈ [symbol] species, each species s∈[1, S] having nₛ∈ [symbol] identical fermions, the Hamiltonian is a Schrödinger operator and written as H=Σₛ₌₁^{s}Σₗ₌₁ⁿ^{ₛ}Σₘ₌₁ⁿ^{ₛ} Hₛₗₘ, with Hₛₗₘ=−(Δₛₗ, +Δₛₘ₎/2nₛ+V/Σₛ₌₁^{s}nₛ² moves only the l-th and the m-th labeled particle of the s-th species through the Laplace-Beltrami operators Δₛₗ and Δₛₘ, for each (s,l,m)∈[1,S]×[1, nₛ]². Using the method of LTK-decomposition, a Gibbs operator e^{-τH}, [symbol] ∈(0, ∞) is approximated by applying a sequence of Gibbs operators {Gₛₗₘ [symbol] e^{-τH}^{ₛₗₘ}^{/m}}_{(s,l,m)} for a polynomial-bounded m∈ [symbol] times, each Gₛₗₘ associated with a single Feynman slice being partially fermionic exchange-symmetrized with respect to an order-2 group Gₛₗₘ that permutes the l-th and m-th identical fermions of the s-th species, for all (s,l,m)∈[1, S]×[1, nₛ]²}. By a theorem of Diaconis and Shahshahani [48], a typical Feynman path with such partial fermionic symmetrizations effectively selects a sample of fully symmetrized and signed Feynman path almost surely and uniformly, such that an integral of signed Wiener measure densities of said Feynman paths with symmetrizations well approximate the FSFS. It is important to note that ∀(s,l,m)∈[1, S]×[1, nₛ]², ∀τ∈(0, ∞), and any given configuration point q, the partially fermionic symmetrized Gibbs kernels [symbol] ⋅|e^{-τH}^{ₛₗₘ}| [symbol] ₛₗₘq [symbol] = [symbol] [symbol] ₛₗₘ⋅|e^{-τH}^{ₛₗₘ}|q [symbol] = [symbol] [symbol] ₛₗₘ⋅|e^{-τH}ₛₗₘ| [symbol] ₛₗₘq [symbol] , with [symbol] ₛₗₘ [symbol] |Gₛₗₘ|₋₁Σ_{π∈G}_{ₛₗₘ}(−1)^{π}π, are all efficiently computable whose nodal surfaces can be determined at an O(poly(size(H), ϵ)) computational cost, e being any desired numerical accuracy.

Changing the perspective again, when an MFS comprises a certain fermion species that has many identical fermions residing separately in multiple non-overlapping regions of a substrate space [9] or a phase space (e.g., a position-momentum space) of single particles, then the identical fermions are divided into separated clusters each of which corresponds to a specific spatial region separated from other spatial regions and becomes a unique effective species distinguishable from other effective species corresponding to other spatial regions [49], where the identical fermions within each effective species residing in a separated spatial region are indistinguishable and obey fermionic exchange symmetry, whereas different clusters of fermions residing in different spatial regions are mutually distinguishable as different effective species. Such an MFS is homophysical to an effective system comprising multiple effective species.

Finally, it is useful to note that the analyses, computing processes, and methods presented supra can be extended straightforwardly to physical and computational systems over a discrete or continuous-discrete product configuration space [9], only that the nodal restriction or path rectification may need to invoke the so-called lever rule [9, 50, 51] using efficiently solved nodal structures of CFF interactions or their associated Gibbs kernels. Besides, when a compact configuration space is approximated by a lattice with the spacing between neighbor lattice points being sufficiently small, the error in localizing nodal surfaces becomes negligibly small and the simulation results from continuous and discrete configuration spaces converge.

Definition 5. A partial Hamiltonian H=Σₖ₌₁^{K}Hₖ, K∈ [symbol] , with {Hₖ:k∈[1, K]} being FBM tensor monomials, is called frustration-free if any ground state of H is necessarily a ground state of each Hₖ, ∀k∈[1, K]. Such a frustration-free Hamiltonian is called strongly frustration-free, when each Hₖ, k∈[1, K] is O((size(H))^{-ξ})-almost node-determinate for a predetermined sufficiently large constant ξ∈ [symbol] , ξ>0, and the ground state of H is non-degenerate, the excited states of H and of all {Πₖ:k∈[1, K]} are separated from their corresponding ground states by an Ω(1/poly(size(H))) energy gap.

Definition 6. A partial Hamiltonian H on a configuration space [symbol] of size N [symbol] size(C) is called ground state frustration-free, when it is polynomially Lie-Trotter-Kato decomposable in the form H=Σᵢ₌₁^{J}Hᵢ, J∈ [symbol] , J=O(poly(N)) and has a non-degenerate ground state ψ₀(H), that is separated from all of the excited states by an energy gap sized as Ω(1/poly(N)), where each H, is O(1/poly(N))-almost node-determinate and has ψ₀(H) as its ground state or one of its ground states, ∀i∈[1, J]. Each such additive partial Hamiltonian Hᵢ, i∈[1, J] is called GFF-compatible with respect to H.

Definition 7. A partial Hamiltonian H on a configuration space [symbol] of size N [symbol] size(C) is called directly frustration-free, when it is a direct sum of partial Hamiltonians in the form H=Σᵢ₌₁Hᵢ, J∈ [symbol] , J=O(poly(N)), with the energy gap between the ground state and the excited states Ω(1/poly(N)) lower-bounded for H and every Hᵢ, i∈[1, J], where each Hᵢ, i∈[1, J] has 0 as the smallest eigenvalue and moves an O(log(N))-sized configuration subspace [symbol] ᵢ, which is annihilated by any other Hⱼ, j∈[1, J], j≠i, namely, Hⱼϕᵢ=0 holds true, ∀ϕᵢ∈L²( [symbol] ᵢ), so long as j≠i. Each such additive partial Hamiltonian Hᵢ, i∈[1, J] is called DFF-compatible with respect to H.

Definition 8. A partial Hamiltonian H that generates a Gibbs operator exp{−t[H−λ₀(H)]} of interest at a fixed t∈0, ∞] is called separately frustration-free, when it is a sum of partial Hamiltonians as H=Σₖ₌₁^{K} Hₖ, K∈ [symbol] , K=O(poly(N)), N [symbol] size(H), with each shifted partial Hamiltonian Hₖ−λ₀(Hₖ), k∈[1, K] being either DFF or GFF, and the Gibbs operator exp{−t[H−λ₀(H)]} can be simulated, to within an error no more than O(1/poly(N)), by iterating a sequence of Gibbs operators {exp{−τ[Hₖ−λ₀(Hₖ)]}:k∈[1, K]}, τ∈(0, ∞] for no more than O(poly(N)) times.

Definition 9. Given a measurable space ( [symbol] ^{K}, [symbol] ), K∈ [symbol] , where [symbol] is a configuration space, [symbol] ^{K} [symbol] Πₙ₌₁^{K} [symbol] is a product space of [symbol] , and [symbol] [symbol] [symbol] ( [symbol] ^{K}) is a σ-algebra of subsets of [symbol] ^{K}, a scalar density associated with [symbol] is a ( [symbol] , [symbol] )-measureable function from [symbol] ^{K} to an algebraic field [symbol] . A density associated with C is a tuple- or vector-valued function having either just one or a plurality of scalar densities as components. In particular, a scalar density associated with [symbol] is a density associated with C that has just one component. A scalar or a tuple or vector value ƒ(q_{K}, . . . , q₁) that a density ƒ assumes is called a density value at a tuple, vector, or sequence of configuration points (q_{K}, . . . , q₁)∈ [symbol] ^{K}. A density ƒ associated with C is said to be signed, when ƒ has two components ƒ₁ and ƒ₂ as scalar densities that are not necessarily different, and two tuples of configuration points q₁ [symbol] (q_{1K}, . . . , q₁₁)∈ [symbol] ^{K} and q₂ [symbol] (q_{2K}, . . . , q₂₁)∈ [symbol] ^{K} exist which need not to differ, such that the value of the quotient ƒ₁(q₁)/ƒ₂(q₂) is different from zero and a positive number in [symbol] .

Definition 10. A density defined on a product space [symbol] ^{K}, K∈ [symbol] of a configuration space [symbol] of a variable size is said to be minimally entangled, when it can be written as ƒ({gᵢ}ᵢ₌₁ⁿ) [symbol] ƒ(g₁, . . . , gₙ), with n=O(poly(size(C^{K}))), ƒ being a Borel measurable function defined on [symbol] ⁿ, [symbol] being a field, each gᵢ, i∈[1,n] being a [symbol] -valued scalar density associated with a submanifold [symbol] ᵢ as a tensor factor of [symbol] ^{K} such that size(Cᵢ) O(log(size( [symbol] ^{K}))), wherein all of the function ƒ and {gᵢ}ᵢ₌₁ⁿ have a representation in a closed mathematical form that is efficiently computable, such that ∀q∈ [symbol] ^{K}, K∈ [symbol] , the point-value ƒ({gᵢ(q|cᵢ)}ᵢ₌₁ⁿ), with q|cᵢ denoting the coordinate restriction of q to the submanifold [symbol] ᵢ, ∀i∈[1, n], can be computed to within any predetermined relative error ϵ>0, at the cost of an O(poly(size( [symbol] ^{K})+|log ϵ|)) computational complexity.

Definition 11. A density associated with a configuration space [symbol] of a variable size is said to be substantially entangled when it is signed and can not be represented in the form of a minimally entangled density associated with [symbol] . A density associated with the same [symbol] is said to be practically substantially entangled when it is signed and has no known representation in the form of a minimally entangled density associated with [symbol] .

Definition 12. For any signed density ƒ defined on a product space [symbol] ^{K}, K∈ [symbol] of a configuration space [symbol] , the integral ∫_{q∈} [symbol] _{^{K}} ƒ(q) dq is called the signed integral of ƒ over [symbol] ^{K}, the integral ∫_{q∈} [symbol] _{^{K}}|ƒ(q)|dq is called the absolute integral of ƒ over [symbol] ^{K}, where |θ| [symbol] (|ƒ₁|, |ƒ₂|, . . . , |ƒₙ|) when ƒ is tuple- or vector-valued in the form of ƒ=(ƒ₁, ƒ₂, . . . , ƒₙ), n∈ [symbol] .

Definition 13. For any scalar-valued signed density ƒ and any prescribed observable υ as another function defined on a product space [symbol] ^{K}, K∈ [symbol] of a configuration space [symbol] , the value of [symbol] υ [symbol] _{ƒ} [symbol] [symbol] ƒ(q)υ(q)dq is called the signed expectation value of υ due to ƒ, the value of [symbol] υ [symbol] _{|ƒ|} [symbol] [symbol] |ƒ(q)|υ(q)dq is called the absolute expectation value of υ due to ƒ.

In one exemplary embodiment, the signed expectation value [symbol] υ [symbol] _{ƒ} of υ due to ƒ is normalized by dividing by the integral ∫_{q∈} [symbol] ƒ(q)dq. In another exemplary embodiment, the absolute expectation value [symbol] υ [symbol] _{|ƒ|} of υ due to ƒ is normalized by dividing by the integral ∫_{q∈} [symbol] |ƒ(q)|dq. In still another exemplary embodiment, the prescribed observable υ is the constant 1, and a plurality of discrete sample points and their ƒ-values are obtained and used to compute a signed expectation value [symbol] ƒ(q)/ [symbol] 1 to estimate the distribution of ƒ on [symbol] , or an absolute expectation value [symbol] |ƒ(q)|/ [symbol] 1 to estimate the distribution of |ƒ| on [symbol] , where [symbol] ⊆ [symbol] is a finite set of discrete sample points, [symbol] 1 yields the cardinality of [symbol] . In yet another embodiment, the prescribed observable υ is another constant on [symbol] . In further alternative embodiments, the prescribed observable υ is a function on [symbol] that is, by way of example but no means of limitation, a functional-analytic operator supported by [symbol] , a Hermitian operator as a physical or quantum observable supported by [symbol] , a total or partial Hamiltonian supported by [symbol] , or a Gibbs operator generated by a total or partial Hamiltonian supported by [symbol] .

Definition 14. Let ƒ be a signed density associated with a configuration space [symbol] of a variable size N [symbol] size( [symbol] ), which is tuple- or vector-valued in the form of ƒ=(ƒ₁, ƒ₂, . . . , ƒₙ), n∈ [symbol] . Let (s₁, s₂, . . . , sₙ)=∫_{q∈} [symbol] _{^{K}}ƒ(q)dq be the signed integral and (a₁, a₂, . . . , aₙ)=∫_{q∈} [symbol] _{^{K}}|ƒ(q)|dq be the absolute integral of ƒ over [symbol] ^{K}, K∈ [symbol] . Such a signed density ƒ is said to have a severe sign problem when an index k∈[1, n] exists such that aₖ/sₖ is asymptotically greater than any prescribed polynomial of N, when N becomes sufficiently large.

It is useful to note that, in each of the above Definition 12, Definition 13, and Definition 14, both the signed density ƒ and the variable v can be scalar-valued as a special case with n=1. It is also useful to note that, in Definition 13, the signed and absolute expectation values of v due to ƒ are one and the same when the signed density ƒ is non-negative-valued.

Definition 15. A linear operator T supported by a configuration space [symbol] and its associated integral kernel [symbol] ⋅|T|⋅ [symbol] : [symbol] × [symbol] [symbol] [symbol] , with [symbol] being a field of scalars, are called quasi-stochastic if the right marginal distribution defined as ∫_{C} [symbol] r|T|q [symbol] dV_{g}(r) reduces to a constant scalar λ∈ [symbol] , ∀q∈ [symbol] . It follows that λ is an eigenvalue of T, associated with an eigenvector ψ₀(T) such that T⋅₀(T)=λψ₀(T), which is called the stationary distribution of the quasi-stochastic operator T.

A quasi-stochastic operator T, also called a quasi-Markov transition matrix, is said to generate a quasi-Markov chain (or called a quasi-Markov process) {Xₜ} indexed by a time variable t∈ [symbol] , with the index set [symbol] being either finite or countably infinite or uncountable, if for every t∈ [symbol] , Xₜ:Ω [symbol] [symbol] is a measurable function on a certain domain set Ω, which is associated with a t-dependent signed density ψ(⋅, ⋅): [symbol] × [symbol] [symbol] [symbol] , called a t-dependent quasi-probability density, such that ψ(⋅, t+1)=Tψ(⋅, t) [symbol] ∫_{C} [symbol] ⋅|T|q [symbol] ψ(q,t)dV_{g}(q) when [symbol] ⊆ [symbol] is discrete or dψ(⋅, t)/dt=Tψ(⋅, t) [symbol] ∫_{c} [symbol] ⋅|T|q [symbol] ψ(q,t)dV_{g}(q) when [symbol] ⊆ [symbol] is continuous, where ∀(q,t)∈ [symbol] × [symbol] , ψ(q,t) is a signed measure density assigned to the preimage Xₜ⁻¹(q) [symbol] {ω∈Ω:Xₜ)(ω)=q}. The stationary distribution ψ₀(T) of a quasi-stochastic operator T is called the stationary distribution of the quasi-Markov chain (or called quasi-Markov process) generated by T. The configuration space [symbol] is called the state space of the quasi-Markov chain.

It is noted that the quasi-Markov chain specified in definition 15 is homogeneous in the sense that the generating quasi-stochastic operator T is independent of time. It is straightforward to extend the definition and all derivations as well as related methods and processes to inhomogeneous quasi-Markov chains or processes, where a generating quasi-stochastic operator T depends on time. In particular, the Lie-Trotter-Kato product formula and decomposition as well as the related path integral method apply straightforwardly to quasi-stochastic operators and lead to inhomogeneous quasi-Markov chains or processes.

Definition 16. For any prescribed K≥0, let (t_{K}, . . . , tₖ, . . . , t₀)∈ [symbol] ^{K+1} with tₖ>tₖ₋₁ for all k∈[1, K] be an ordered sequence of time instants, an inhomogeneous quasi-Markov chain is generated by a sequence of quasi-stochastic operators (T_{K}, . . . , Tₖ, . . . , T₁) with each Tₖ, k∈[1, K] taking effect during the time interval (tₖ₋₁, tₖ]. For each k∈[0, K], a single qₖ∈ [symbol] realized at t=tₖ is a called a sample point of the inhomogeneous quasi-Markov chain at time t=tₖ. An ordered sequence of sample points of the form (q_{K}, . . . , qₖ, . . . q₀)∈ [symbol] ^{K+1}, K≥0 is called a sample path of the inhomogeneous quasi-Markov chain. The set of all sample paths [symbol] ^{K+1} [symbol] {(q_{K}, . . . , qₖ, . . . , q₀):qₖ∈ [symbol] , ∀k∈[0, K]} is called an (K+1)-fold product state space (or product sample space [52], or cylinder set [53]) of the inhomogeneous quasi-Markov chain {Xₜ}. A signed density Ψ is defined on a product state space [symbol] ^{K+1}, K≥0, called the joint quasi-probability density of sample paths which assigns to each sample path (q_{K}, . . . , qₖ, . . . , q₀)∈ [symbol] ^{K+1} a signed density value Ψ(q_{K}, . . . , . . . qₖ, . . . , q₀) [symbol] ψ(q₀, t₀)Πₙ₌₁ⁿ [symbol] qₖ|T|qₖ₋₁ [symbol] , with ψ(⋅, t₀) denoting an initial quasi- probability density at the start time t₀∈ [symbol] , which is often initialized to measure at a certain q₀∈ [symbol] .

For any pair of time instants tₘ, tₙ∈ [symbol] , a signed density [symbol] ⋅|Πₖ₌ₘ₊₁ⁿTₖ|⋅ [symbol] : [symbol] × [symbol] [symbol] [symbol] is defined to assign to any (qₙ, qₘ)∈ [symbol] ² a signed density value [symbol] qₙ|Πₖ₌ₘ₊₁ⁿTₖ|qₘ) [symbol] [symbol] qₙ|Tₙ|qₙ₋₁ [symbol] when n=m+1 or [symbol] qₙ|Πₖ₌ₘ₊₁ⁿTₖ|qₘ [symbol] [symbol] {∫_{q}_{ₖ}_{∈} [symbol] }ₖ₌ₙ₊₁ⁿ⁻¹ [symbol] qₙ|Tₙ|qₙ₋₁ [symbol] Πₖ₌ₘ₊₁ⁿ⁻¹ [symbol] qₖ|Tₖ|qₖ₋₁ [symbol] Πₖ₌ₘ₊₁ⁿ⁻¹dqk when n≥m+2, which is called the quasi-Markov transition probability density from (qₘ, tₘ) to (qₙ, tₙ) due to the inhomogeneous quasi-Markov chain generated by the sequence of quasi-stochastic operators (T_{K}, . . . , Tₙ, . . . , T₁). In the special case with all of the quasi-stochastic operators being the same, Tₖ=T, ∀k∈[1, K], the inhomogeneous quasi-Markov chain is actually homogenous, and the signed density [symbol] qₙ|T^{n-m}|qₘ [symbol] [symbol] qₙ|T|qₙ₋₁ [symbol] when n=m+1 or [symbol] qₙ|T^{n-m}|qₘ [symbol] [symbol] {∫_{q}_{ₖ}_{∈} [symbol] }ₖ₌ₘ₊₁ⁿ⁻¹ [symbol] qₙ|T|qₙ₋₁ [symbol] Πₖ₌ₘ₊₁ⁿ⁻¹ [symbol] qₖ|T|qₖ₋₁ [symbol] Πₖ₌ₘ₊₁ⁿ⁻¹dqₖ when n≥m+2 is called the quasi-Markov transition probability density from (qₘ, tₘ) to (qₙ, tₙ) due to the homogeneous quasi-Markov chain generated by the quasi-stochastic operator T, for all (qₙ, qₘ)∈ [symbol] ².

A quasi-stochastic operator is said to induce, generate, or be associated with a signed density when any the following or similar relationships exist: said signed density is a ground state of said quasi-stochastic operator; said signed density is a stationary distribution of said quasi-stochastic operator; said signed density is an eigenvector or eigenstate of said quasi-stochastic operator; said signed density is an integral kernel of said quasi-stochastic operator; said signed density is the result of applying said quasi-stochastic operator to another predetermined signed density; said signed density is associated with said quasi-stochastic operator; said signed density is due to a quasi-Markov chain generated by said quasi-stochastic operator; said signed density is associated with a quasi-Markov chain generated by said quasi-stochastic operator.

It is noted that the notions of quasi-stochastic operator or quasi-Markov transition matrix, sample path, product state space or cylinder set, quasi-probability density, quasi-Markov transition probability density, and joint quasi-probability density of sample paths associated with a quasi-Markov chain respectively generalize the notions of Gibbs operator, Feynman path or a series of connected Feynman spindles, Feynman stack or cylinder set, Gibbs wavefunction, Gibbs transition amplitude or Gibbs kernel, and Wiener density of Feynman paths or series of connected Feynman spindles associated with a quantum system governed by a total Hamiltonian, with said total Hamiltonian generating said Gibbs operator. Most of the methods, derivations, and demonstrations translate well from the particular context of Gibbs statistical mechanics of quantum systems to the general context of quasi-Markov chains or processes.

On the other hand, a quasi-stochastic operator quasi-Markov transition matrix T becomes a bona fide stochastic operator or Markov transition matrix, which generates a bona fide Markov chain, with the associated quasi-probability density and the quasi-Markov transition probability density becoming the conventional probability density and the Markov transition probability density respectively, when the associated integral kernel [symbol] r|T|q [symbol] , (r,q)∈ [symbol] × [symbol] is re valued and nowhere negative, and the operator is scaled properly to have a unit spectral rai in which case, the meaning of stationary distribution coincides with the standard and well-known definition in association with a stochastic matrix and a Markov chain.

This specification discloses methods, processes, and systems for simulating many-variable signed densities and solving computational problems using MCQC. Exemplary applications of said methods, processes, and systems include, but are not limited to, simulating quantum systems via Monte Carlo sampling of signed densities and solving computational problems by simulating a homophysical quantum system implementing a quantum circuit. Signed densities occur naturally in representing quantum systems, particularly those comprising many fermions that are not all distinguishable, more particularly those involving many species of multiple fermion. Exemplary densities or signed densities associated with a quantum system include the ground state wavefunction, Gibbs wavefunctions, Gibbs kernels, Gibbs transition amplitudes, joint quasi-probability density of sample paths, and Wiener densities assigned to Feynman paths or Feynman spindles, many of which are generated by a Gibbs operator that is in turn generated by a total Hamiltonian governing said quantum system. There are also densities or signed densities induced by quasi-stochastic operators generating quasi-Markov chains or processes, examples of such densities or signed densities include, but are not limited to, quasi-probability densities, quasi-Markov transition probability densities, and joint quasi-probability densities of sample paths associated with quasi-Markov chains.

The present invention comprises methods, processes, and systems for simulating signed densities and/or solving computational problems. Means for simulating a signed density on a certain product space of a prescribed configuration space include, but are not limited to, substantially computing the function values or called numerical values of said signed density, substantially determining or selecting Markov chain state transitions or walker moves during a random walk or Monte Carlo with importance sampling such as Metropolis-Hastings sampling or Gibbs sampling using computed function values or numerical values of said signed density, and substantially computing an expectation value of a prescribed observable due to said signed density.

The present invention provides advantages over the prior art in computational accuracy by providing methods, processes, and systems for simulating signed densities rigorously without suffering any systematic error due to a heuristic approximation used in the prior art, such as the fixed-node approximation of either a ground state or a density matrix associated with a quantum system for QMC, the local-density approximation and other approximations for the exchange and correlation interactions among electrons in computational quantum mechanical modeling methods using the density-functional theory. The present invention provides advantages over the prior art in computational efficiency by providing methods, processes, and systems for simulating signed densities without the dreaded numerical sign problem, so that the computational cost to simulate a signed density of a computational size N∈ [symbol] up to a relative error ϵ>0, or to solve a computational problem of size N∈ [symbol] up to an error tolerance ϵ>0, is substantially upper-bounded by a polynomial P(N, ϵ⁻¹), when either N or ϵ⁻¹ becomes or both N and ϵ⁻¹ become substantially large-valued. This is in contrast to the substantially exponential increase of computational cost with many conventional methods, processes, and systems in the prior art. A polynomial P(N, ϵ⁻¹) of variables N and ϵ refers to a sum of a predetermined finite number of monomials of N and ϵ, with each of said monomials being of the form C×N^{a}×ϵ^{-b}, where each of a, b, C is a predetermined constant.

As it is a convention and standard practice in the fields of computing and computational complexity, the size of a computational problem is substantially a descriptive complexity of the computational problem like how many bits of information are needed to describe it, and similarly, the computational size of a signed density is substantially its descriptive complexity such as how many coordinate variables are needed to describe it. Measures of the computational cost include, but are not limited to, a computational runtime, a number of clock cycles of either a central processing unit (CPU) or a graphics processing unit (CPU) or a tensor processing unit (TPU) or a digital signal processing (DSP) chip, a number of basic mathematical function applications, a number of basic arithmetic and logic operations, an amount of computer hardware being used, a number of either CPUs or CPUs or TPUs or DSP chips being used, an amount of circuitry being used in either a CPU or a CPU or a TPU or a DSP chip, a number of transistors or logic gates being used in either a CPU or a CPU or a TPU or a DSP chip, and the amount of data storage being used.

The present invention provides methods, processes, and systems for simulating a many-variable (MV) signed density or solving a computational problem, which are advantageous over the prior art in either computational accuracy or computational efficiency, or in both computational accuracy and computational efficiency. Exemplary MV signed densities are associated with many-particle or many-body quantum systems. Said quantum systems have a configuration space [symbol] _{MV} as a of configuration points forming a manifold that is also denoted by [symbol] _{MV}, where each configuration point q∈ [symbol] _{MV} is an K-tuple or K-dimensional vector of variable values assigned to an ensemble of coordinate variables, K∈ [symbol] said variable values are numerical values (often eigenvalues) assigned to an ensemble of dynamical variables associated with an ensemble of particles constituting the quantum system. Such exemplary densities or signed densities as function whose domain is an K-dimensional configuration space, K∈ [symbol] , are referred to as a many-variable densities or a many-variable signed densities. Said dynamical variables include but are not limited to particle positions in space, their linear or angular momenta, intrinsic properties of elementary and composite particles such as electric charges, spins, spinors, and bispinors, as well as substantially all physical observables and quantities, such as those related to electric currents, voltages, magnetic fields, magnetic moments, electromagnetic fields, electromagnetic waves, masses of matter, number of particles, strengths of forces, physical locations, velocities of motion, linear momenta, angular momenta, mechanical energies, mechanical waves, chemical and material properties.

Advantageously, the present invention uses a sum-of-CFFs (SCFF) Hamiltonian H which generates an SCFF Gibbs operator that induces said MV signed density, where said SCFF Hamiltonian H is decomposed into a plurality of CFF interactions {Hₖ:k∈[1, K]}, K∈ [symbol] , each of said CFF interactions generates a corresponding CFF Gibbs operator that induces a corresponding one of few-variable (FV) signed densities, wherein said MV signed density is decomposed into a combination of said FV signed densities. Specifically, a Gibbs wavefunction or Gibbs kernel or Gibbs transition amplitude as an MV signed density is decomposed into and/or represented by a multi-dimensional integral of Wiener measures or Wiener measure densities or Gibbs transition amplitudes assigned to Feynman paths or cylinder points or series of connected Feynman spindles, where the Wiener measure or Wiener measure density or Gibbs transition amplitude assigned to each Feynman path or cylinder point or a series of connected Feynman spindles is decomposed into and/or represented by a product of said FV signed densities. Also specifically, said SCFF Hamiltonian H governing a many-species fermionic system (MSFS) is invariant under the exchange symmetry group G_{*} permuting identical fermions of the same species, each of said CFF interactions Hₖ, k∈[1, K] is invariant under a a corresponding subgroup Gₖ≤G_{*} permuting a small number of particles, and importantly, sign changes of said MV signed density under permutations in the group G_{*} form a group homomorphism between G_{*} and the cyclic group C₂ [symbol] {{+1, −1}, *}, whereas for each k∈[1, K], sign changes of the corresponding FV signed density under permutations in the corresponding subgroup Gₖ form a group homomorphism between Gₖ and the cyclic group C₂ [symbol] {{+1, −1}, *}, with said group homomorphisms being compatible with the decomposition of said MV signed density into said combination of said FV signed densities, such that a method of restricted path integral (RPI) applies, which samples only restricted Feynman paths or restricted cylinder points as combinations and/or products of restricted Feynman spindles associated with non-negative-definite density values of said FV signed densities, and integrates the samples of said restricted Feynman paths or restricted cylinder points to substantially estimate the expectation value of a prescribed observable due to said MV signed density.

Also advantageously, the present invention employs a total Hamiltonian H selected from a group of substantially frustration-free Hamiltonians comprising strongly frustration-free (StrFF) Hamiltonians, ground sate frustration-free (GFF) Hamiltonians, directly frustration-free (DFF) Hamiltonians, and separately frustration-free (SepFF) Hamiltonians, such that the total Hamiltonian H is decomposed into a combination of substantially frustration-free interactions as H=Σₖ₌₁^{K}Hₖ, wherein the ground state ψ₀(H) as an MV signed density is non-degenerate, the ground states ψ₀(Hₖ) of each of the substantially frustration-free interactions Hₖ as corresponding FV signed densities are substantially node-determinate and substantially coincide with ψ₀(H) on corresponding subsets of the support of ψ₀(H), consequently, the MV signed density ψ₀(H) is simulated by an inhomogeneous quasi-Markov chain generated by a sequence of quasi-stochastic operators each of which inducing a corresponding one of said FV signed densities, where said inhomogeneous quasi-Markov chain converges to a stationary distribution that is substantially the same as a predetermined function of ψ₀(H) such as ψ₀(H) itself or |ψ₀(H)| or |ψ₀(H)|², after applying said sequence of quasi-stochastic operators repeatedly for a predetermined number of times.

Still advantageously, the present invention uses a Feynman-Kitaev construct associated with or governed by a Feynman-Kitaev Hamiltonian that is substantially frustration-free by preferably making each of the involved Feynman-Kitaev propagators of the form I−X_{C}⊗R_{L} or I−|1 [symbol] [symbol] 0|_{C}⊗U_{L}−|0 [symbol] [symbol] 1|_{C}⊗U_{L}⁺ substantially node-determinate, where the subscript “_{C}” indicates either an operation on or a state of a single clock rebit in a clock register, while the subscript “_{L}” indicates either an operation on or a state of a plurality of logic rebits in a logic register. A Feynman-Kitaev propagator of the form I−X_{C}⊗R_{L} is referred to as a Hermitian Feynman-Kitaev propagator, which is suitable for a quantum gate R_{L} called Hermitian unitary when it satisfies both the condition of unitarity R_{L}⁺R_{L}=R^{L}R_{L}⁺=L and the condition of Hermiticity R_{L}⁺=R_{L}. A Feynman-Kitaev propagator of the form I−|1 [symbol] 0|_{C}⊗U_{L}−|0 [symbol] [symbol] 1|_{C}⊗U_{L}⁺ is referred to as a non-Hermitian Feynman-Kitaev propagator, which is suitable for a quantum gate U_{L} called non-Hermitian unitary when it satisfies only the condition of unitarity U_{L}⁺U_{L}=U_{L}U_{L}⁺=I.

Let G_{P} [symbol] {±I, ±iI, ±X, ±iX, ±Y, ±iY, ±Z, ±iZ} denote the 1-qubit Pauli group of quantum gates generated by the scalar coefficients {±1, ±i} and the Pauli matrices or Pauli operators on a single qubit, and G_{P}* denote the Pauli group consisting of all tensor products of a plurality of 1-qubit Pauli groups each of which acts on a corresponding one of a plurality of qubits [54]. It is noted that any Hermitian Feynman-Kitaev propagator of the form I−X_{C}⊗R_{L} with a Hermitian unitary gate R_{L} selected from the Pauli group is straightforwardly node-determinate, with the knowledge that a scalar multiplication by the imaginary unit i [symbol] \sqrt{−1} is isophysically implemented as an X gate one a flag rebit signifying a real-imaginary conversion [12]. It is also well known that the combination of the controlled-NOT gate and single-qubit unitary gates is universal for quantum computation. Since the controlled-NOT gate is straightforwardly node-determinate, it suffices to ensure node-determinacy for either an arbitrary Hermitian Feynman-Kitaev propagator I−X_{C}⊗R_{L}(θ) with an R-gate R_{L}(θ) [symbol] Z cos θ+X sin θ, θ∈[−π, π) on a single rebit, or an arbitrary non-Hermitian Feynman-Kitaev propagator I−|1 [symbol] [symbol] 0|_{C}(U_{L}(θ)−|0 [symbol] [symbol] 1|_{C}⊗U_{L}⁺(θ) with a rotation gate U_{L}(θ) [symbol] R_{L}(θ) [symbol] R_{L}(θ) Z=I cos θ+XZ sin θ, θ∈[−π, π) on a single rebit.

To facilitate node-determinacy, it is advantageous to work with the {|+ [symbol] , |− [symbol] } basis for a clock rebit and use |+ [symbol] [symbol] (+0 [symbol] +1 [symbol] )/\sqrt{2} and |− [symbol] [symbol] (|0 [symbol] −|1 [symbol] )/\sqrt{2} as the clock states, so that the Hermitian and non-Hermitian Feynman-Kitaev propagators take the new forms of I−Z_{C}⊗R_{L}(θ) and I−|− [symbol] [symbol] +|_{C}⊗U_{L}(θ)−|+ [symbol] [symbol] −|_{C}⊗U_{L}⁺(θ) respectively, θ∈[−π, π), whereby a Hermitian Feynman-Kitaev propagator I−Z_{C}⊗R_{L}(θ), θ∈[−π, π) is straightforwardly node-determinate, while a non-Hermitian Feynman-Kitaev propagator

$${{I - \vert - 〉 〈 + \vert}_{C} ⊗ {U}_{L} ( θ ) - \vert - 〉 〈 + \vert}_{C} ⊗ \text{} {U}_{L}^{+} ( \text{} θ ) = [ \text{} \begin{matrix}1 - cos θ & 0 & 0 & sin θ \\ 0 & 1 - cos θ & - sin θ & 0 \\ 0 & - sin θ & 1 + cos θ & 0 \\ sin θ & 0 & 0 & 1 + cos θ\end{matrix} ] \qquad ( 39 )$$

is also node-determinate for all θ∈[−π, π), since the two ground states ψ₀⁺ [symbol] [0, cos(θ/2), sin(θ/2), 0]⁺ and ψ₀⁻ [symbol] [cos(θ/2), 0,0, −sin(0/2)]⁺ do not overlap in the two-rebit configuration space, {00, 01, 10, 11}.

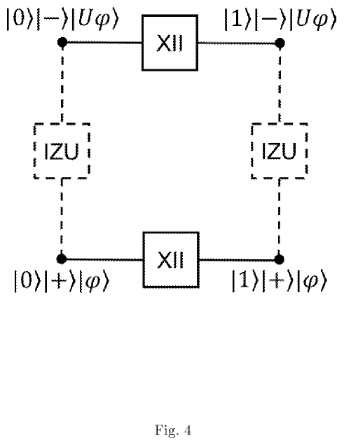

It is also advantageous to still work with the conventional {|0 [symbol] , |1 [symbol] } computational basis for each of a plurality of clock rebits, but have every clock rebit associated with an auxillary rebit operating in the {|+ [symbol] ,|− [symbol] } basis, so to construct a Hermitian Feynman-Kitaev propagator of the form (I−Z_{A}R_{L}(θ))+(I−X_{C}) or a non-Hermitian Feynman-Kitaev propagator of the form (I−|− [symbol] [symbol] +|_{A}⊗U_{L}(θ)−|+ [symbol] [symbol] −|_{A}⊗U_{L}⁺(θ)+(I−X_{C}), θ∈[−π, π), whose Feynman-Kitaev lattice or state graph is square-shaped as illustrated in FIG. 4, where “IZU” signifies (I−Z_{A}⊗R_{L}(θ)) or (I−|− [symbol] [symbol] +|_{A}⊗U_{L}(θ)−|+) [symbol] [symbol] −|_{A}⊗U_{L}⁺(θ)) for an auxiliary rebit controlled R-gate or rotation gate, while “XII” represents a copy gate (I−X_{C}) with only the clock rebit undergoing a state transition. Both the Hermitian and the non-Hermitian Feynman-Kitaev propagators are substantially frustration-free as desired, comprising two substantially frustration-free interactions that are strictly node-determinate. However, neither a Z_{C}⁺ time selection operator singles out an earlier or input |ϕ [symbol] _{L} logic state tensor-multiplied by the |0 [symbol] _{C} clock state, nor a Z_{C}⁻ time selection operator singles out a latter or output U|ϕ [symbol] _{L} logic state tensor-multiplied by the |1 [symbol] _{C} clock state, with U=R_{L}(θ)) or U_{L}(θ)). Rather, both the earlier/input and the latter/output logic states are substantially half/half mixed at each of the clock states or Feynman-Kitaev time instants.

One exemplary embodiment provides an arrow of time and a means for propagating the probability amplitude forward from an initial state to a final state of quantum computation by repeating the same square-shaped Feynman-Kitaev propagator as illustrated in FIG. 4 for a number 2M of times, each time applying a non-Hermitian Feynman-Kitaev propagator (I−|− [symbol] [symbol] +|_{A}⊗U_{L}(θ/M)−|+ [symbol] [symbol] −|_{A}⊗U_{L}⁺(θ/M))+(I−X_{C}) with a different pair consisting of a clock rebit and an auxiliary rebit, where θ∈[−π, π) is a predetermined constant angle or rotation, M∈ [symbol] is substantially large. This creates a 4M-dimensional hypercube of Feynman-Kitaev lattice or state graph. Each non-Hermitian Feynman-Kitaev propagator keeps intact substantially half of the logic state amplitude it receives, and applies a small-angle rotation to substantially the other half of the logic state amplitude, which is accompanied by a |+ [symbol] to |− [symbol] state transition of the corresponding auxiliary rebit. By the end of the sequence of 2M non-Hermitian Feynman-Kitaev propagators, the logic state is rotated by different angles accompanied by different combinations of the |+ [symbol] and |− [symbol] states of the auxiliary rebits. By the central limit theorem and well known properties of the binomial coefficients [55], the rotation angle is substantially Gaussian distributed with a mean substantially equal to M×(θ/M)=θ and a standard deviation substantially equal to M^{1/2}, therefore, most of the probability amplitude is concentrated in the logic state being substantially rotated by the angle θ. This is a phenomenon of measure concentration [56]. With the number M E N being chosen sufficiently large but still polynomial-bounded, the sequence of 2M non-Hermitian Feynman-Kitaev propagators constitute an implementation of a single U_{L}(θ) rotation gate up to a polynomial-bounded error at a polynomial-bounded cost.

Another exemplary embodiment provides an arrow of time and a means for propagating the probability amplitude forward from an initial state to a final state of quantum computation by filtering the |+ [symbol] and |− [symbol] states of the auxiliary rebit after a Hermitian or non-Hermitian Feynman-Kitaev propagator (I−Z_{A}⊗R_{L}(θ))+(I−X_{C}) or (I−|− [symbol] [symbol] +|_{A}⊗U_{L}(θ)−|+ [symbol] [symbol] −|_{A}⊗U_{L}⁺(θ))+(I−X_{C}), which produces a mixture of quantum computational states of the form |t [symbol] _{C}|+ [symbol] _{A}|ϕ [symbol] _{L}+|t [symbol] _{C}|− [symbol] _{A}|U_{L}ϕ [symbol] _{L}, t∈ [symbol] , |ϕ [symbol] _{L} being a logic state. To enhance and extract out the desired |− [symbol] _{A}|U_{L}ϕ [symbol] _{L} component while attenuating and removing the unwanted |+ [symbol] _{A}|ϕ [symbol] _{L} component down a Feynman-Kitaev construct to time instants later than t∈ [symbol] , one exemplary embodiment uses a generalized Feynman-Kitaev propagator Z_{C}⁺⊗(I−bX_{A})−X_{C}+Z_{C}⁻⊗(I+bX_{A}) or Z_{C}⁺⊗ (I−bX_{A})−X_{C}⊗X_{A}+Z_{C}⁻⊗((I+bX_{A}), with b>0 being a small energy bias, which mostly copies the tensor-product state of the auxiliary and logic rebits, but slightly amplifies the |− [symbol] _{A} state while slightly attenuating the |+ [symbol] _{A} state as the corresponding clock rebit makes a |0 [symbol] _{C} to |− [symbol] , state transition. The generalized Feynman-Kitaev propagator is not strictly node-determinate, but the probability of making a wrong node determination or being unable to make a node determination is a higher-order infinitesimal, while the effect of amplifying |− [symbol] _{A} and attenuating |+ [symbol] _{A} is small but systematic, which accumulates to a significant state filtering effect after being applied repeatedly for a substantial number of times. This small energy bias-indued state filtering is similar to Feynman's proposal [57] of driving a reversible computation forward: A small energy bias does not prevent the computation going backward from time to time, but it exerts a constant and persistent force to push the computation forward on the long run.

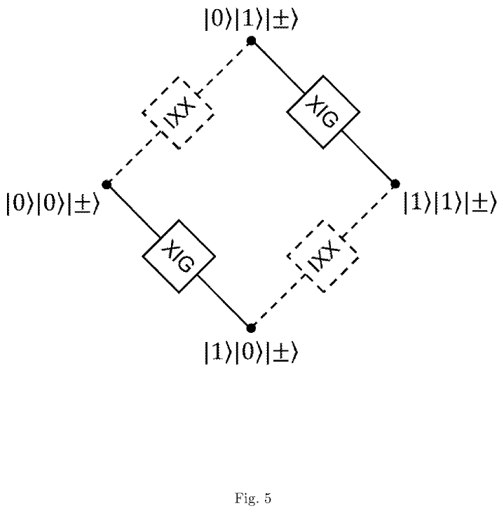

Still another embodiment of |± [symbol] _{A} state filtering uses a generalized Feynman-Kitaev propagator that comprises another auxiliary rebit with the subscript “_{B}” operating with the computational basis {|0 [symbol] _{B}, |1 [symbol] _{B}}, in addition to the auxiliary rebit with the subscript “_{A}” operating with the basis {|+ [symbol] _{A}, |− [symbol] _{A}}. The related Feynman-Kitaev lattice or state graph is illustrated in FIG. 5, where “XIG” represents a state filtering Feynman-Kitaev propagator Z_{C}⁺⊗(I−bX_{A})−X_{C}+Z_{C}⁻⊗(I+bX_{A}) or Z_{C}⁺⊗(I−bX_{A})−X_{C}⊗X_{A}+Z_{C}⁻⊗(I+bX_{A}), with b>0 being a small energy bias, while “IXX” signifies a strictly node-determinate Feynman-Kitaev propagator I−X_{B}⊗X_{A}, which copies the |± [symbol] _{A} states faithfully for the “_{A}” auxiliary rebit as the “_{B}” auxiliary rebit makes a transition between the |0 [symbol] _{B}, and |1 [symbol] _{B} states. The “XIG” Feynman-Kitaev propagator is not node-determinate, but its two ground states are chosen such that they only overlap in the subspace span{|0 [symbol] _{C}|1 [symbol] _{A}, |1 [symbol] _{C}|0 [symbol] _{A}} and do not overlap in the subspace span {|0 [symbol] _{C}|0 [symbol] _{A}, |1 [symbol] _{C}|1 [symbol] _{A}}. Consequently, an alternative method of MCQC employs an alternative solution to the sign problem using partial node-determinacy, where an MCQC simulation step involving the “XIG” Feynman-Kitaev propagator invokes it only when the current configuration point falls in the subspace span {|0 [symbol] _{C}|0 [symbol] _{A},|1 [symbol] _{C}|1 [symbol] _{A}} where the ground state being supported there can be determined, otherwise, the “XIG” Feynman-Kitaev propagator is skipped for the round. The simulation does not get stuck because the “IXX” interaction I−X_{B}⊗X_{A} will eventually move the configuration point out of the subspaces span {|0 [symbol] _{C}|1 [symbol] _{A}, |1 [symbol] _{C}|0 [symbol] _{A}}.

More generally, GSQC can employ generalized Feynman-Kitaev constructs that involve a sequence of non-unitary gates, such as a sequence of Gibbs operators representing imaginary time propagation (ITP) of quantum states [58], or a sequence of quantum measurements to project out a desired quantum state [59]. Given a sequence of imaginary time propagators

{Wₜ [symbol] exp[−τ(Hₜ′+Eₜ′)], Eₜ′∈ [symbol] }ₜ₌₁^{T}, T∈ [symbol] (40)

which represent a non-unitary state evolution of a logic register consisting of N∈ [symbol] logic rebits to project out a desired quantum state progressively, a non-unitary Feynman-Kitaev construct is built in substantially the same manner as for a Feynman-Kitaev construct involving unitary quantum gates, which employs a clock register with clock states {|t [symbol] _{C}}_{t∈[0,T]} mapping the indices of imaginary time, implements a Feynman-Kitaev Hamiltonian H as an (T+1)×(T+1) block matrix

$$H = {\sum }_{t = 0}^{T} {H}_{t} = [ \begin{matrix}{H}_{0}^{′} + 1 & - {W}_{1}^{- 1} & & & & & \\ - {W}_{1}^{- 1} & {W}_{1}^{- 2} + I & - {W}_{2}^{- 1} & & & & \\ & ⋱ & ⋱ & ⋱ & & & \\ & & - {W}_{t - 1}^{- 1} & {W}_{t - 1}^{- 2} + I & - {W}_{t}^{- 1} & & \\ & & & ⋱ & ⋱ & ⋱ & \\ & & & & - {W}_{T - 1}^{- 1} & {W}_{T - 1}^{- 2} + I & - {W}_{T}^{- 1} \\ & & & & & - {W}_{T}^{- 1} & {W}_{T}^{- 2}\end{matrix} ] , \qquad ( 41 )$$

with each Hₜ [symbol] (Hₜ(i,j))_{i,j=1}^{T+1}, t∈[1, T], called a non-unitary Feynman-Kitaev propagator, comprising mostly zero entries except for a 2×2 block as

$${H}_{t} ( i , j ) = \{ \begin{matrix}I , & when i = j = t , \\ - {W}_{t}^{- 1} , & when i = t , j = t + 1 , \\ - {W}_{t}^{- 1} , & when j = t , i = t + 1 , \\ {W}_{t}^{- 2} , & when i = j = t + 1 , \\ 0 , & elsewhere ,\end{matrix} \qquad ( 42 )$$

and H₀(i,j)=H₀′δᵢⱼ, H₀′ being a Hamiltonian on the logic register that has a known state ϕ₀ (the initial state of a quantum algorithm) as a non-degenerate ground state with energy 0, namely, H₀′ϕ₀=0, which is separated from all excited states by a polynomial-bounded energy gap.

If all of the partial Hamiltonians {Hₜ:t∈[0, T]} are non-negative definite, then the Feynman-Kitaev Hamiltonian H is non-negative definite and has 0 as the lowest eigenvalue with the ground state ψ₀(H) [symbol] const×Σₜ₌₀^{T}|t [symbol] _{C}|ϕₜ [symbol] _{L}, ϕₜ [symbol] W_{tϕt-1}, ∀t∈[1, T], such that

$$H {ψ}_{0} ( H ) = H [ \begin{matrix}{ϕ}_{0} \\ {W}_{1} {ϕ}_{0} \\ {W}_{2} {W}_{1} {ϕ}_{0} \\ {W}_{3} {W}_{2} {W}_{1} {ϕ}_{0} \\ … \\ {W}_{T - 1} … {W}_{2} {W}_{1} {ϕ}_{0} \\ {W}_{T} {W}_{T - 1} … {W}_{2} {W}_{1} {ϕ}_{0}\end{matrix} ] = 0. \qquad ( 43 )$$

Such a ground state ψ₀(H), as well as any Gibbs kernel (also known as a Gibbs wavefunction) associated with a Gibbs operator [symbol] , [symbol] >0 generated by a Feynman-Kitaev Hamiltonian representing a non-unitary Feynman-Kitaev construct, can be simulated using MCQC in substantially the same manner as for a Feynman-Kitaev construct involving unitary quantum gates, overcoming the numerical sign problem by one of the methods specified supra as well as in the incorporated references, with the Feynman-Kitaev Hamiltonian being either strongly frustration-free, or ground state frustration-free, or directly frustration-free, or separately frustration-free, or sum-of-controlled-few-fermions (sum-of-CFFs). The following equations

$$[ \begin{matrix}{H}_{0}^{′} + I & - {W}_{1}^{- 1} \\ - {W}_{1}^{- 1} & {W}_{1}^{- 2}\end{matrix} ] [ \begin{matrix}{ϕ}_{0} \\ {W}_{1} {ϕ}_{0}\end{matrix} ] = 0 , \qquad ( 44 )$$

$$[ \begin{matrix}{H}_{0}^{′} + I & - {W}_{1}^{- 1} & 0 \\ - {W}_{1}^{- 1} & {W}_{1}^{- 2} + I & - {W}_{2}^{- 1} \\ 0 & - {W}_{2}^{- 1} & {W}_{2}^{- 2}\end{matrix} ] [ \begin{matrix}{ϕ}_{0} \\ {W}_{1} {ϕ}_{0} \\ {W}_{2} {W}_{1} {ϕ}_{0}\end{matrix} ] = 0 , \qquad ( 45 )$$

$$[ \begin{matrix}{H}_{0}^{′} + I & - {W}_{1}^{- 1} & 0 & 0 \\ - {W}_{1}^{- 1} & {W}_{1}^{- 2} + I & {W}_{2}^{- 1} & 0 \\ 0 & {W}_{2}^{- 1} & {W}_{2}^{- 2} + I & {W}_{3}^{- 1} \\ 0 & 0 & - {W}_{3}^{- 1} & {W}_{3}^{- 2}\end{matrix} ] [ \begin{matrix}{ϕ}_{0} \\ {W}_{1} {ϕ}_{0} \\ {W}_{2} {W}_{1} {ϕ}_{0} \\ {W}_{3} {W}_{2} {W}_{1} {ϕ}_{0}\end{matrix} ] = 0 , \qquad ( 46 )$$

illustrate the Feynman-Kitaev Hamiltonians and their corresponding ground states for the simple cases of T=1, 2, 3, which compute a desired quantum state W_{1ϕ0}, W₂W_{1ϕ0}, or W₃W₂W_{1ϕ0} respectively.

Alternatively, if it is desired to have positive powers of the {Wₜ}ₜ₌₁^{T} operators instead of their inverses in the entries of a Feynman-Kitaev Hamiltonian, then it is advantageous to use non-unitary Feynman-Kitaev propagators Hₜ [symbol] (Hₜ(i,j))_{i,j}^{T+1} with

$${H}_{t} ( i , j ) = \{ \begin{matrix}{W}_{t}^{2} , & when i = j = t , \\ - {W}_{t} , & when i = t , j = t + 1 , \\ - {W}_{t} , & when j = t , i = t + 1 , \\ I , & when i = j = t + 1 , \\ 0 , & elsewhere ,\end{matrix} \qquad ( 47 )$$

for all t∈[1, T], and H₀(i,j)=H₀′δᵢⱼ, so to construct a Feynman-Kitaev Hamiltonian

$$H = {\sum }_{t = 0}^{T} {H}_{t} = [ \begin{matrix}{H}_{0}^{′} + {W}_{1}^{2} & - {W}_{1} & & & & & \\ - {W}_{1} & I + {W}_{2}^{2} & - {W}_{2} & & & & \\ & ⋱ & ⋱ & ⋱ & & & \\ & & - {W}_{t - 1} & I + {W}_{t}^{2} & - {W}_{t} & & \\ & & & ⋱ & ⋱ & ⋱ & \\ & & & & - {W}_{T - 1} & I + {W}_{T}^{2} & - {W}_{T} \\ & & & & & - {W}_{T} & I\end{matrix} ] , \qquad ( 48 )$$

which has the same zero-energy ground state ψ₀(H) [symbol] const×Σₜ₌₀^{T}|t [symbol] _{C}|ϕₜ [symbol] _{L}, ϕ^{t} [symbol] W_{tϕt-1}, ∀t∈[1, T], just like that in equation (43), provided that all of the partial Hamiltonians {Hₜ:t∈[0,T]} are non-negative definite. The following equations

$$[ \begin{matrix}{H}_{0}^{′} + {W}_{1}^{2} & - {W}_{1} \\ - {W}_{1} & I\end{matrix} ] [ \begin{matrix}{ϕ}_{0} \\ {W}_{1} {ϕ}_{0}\end{matrix} ] = 0 , \qquad ( 49 )$$

$$[ \begin{matrix}{H}_{0}^{′} + {W}_{1}^{2} & - {W}_{1} & 0 \\ - {W}_{1} & I + {W}_{2}^{2} & - {W}_{2} \\ 0 & - {W}_{2} & I\end{matrix} ] [ \begin{matrix}{ϕ}_{0} \\ {W}_{1} {ϕ}_{0} \\ {W}_{2} {W}_{1} {ϕ}_{0}\end{matrix} ] = 0 , \qquad ( 50 )$$

$$[ \begin{matrix}{H}_{0}^{′} + {W}_{1}^{2} & {W}_{1} & 0 & 0 \\ - {W}_{1} & I + {W}_{2}^{2} & - {W}_{2} & 0 \\ 0 & - {W}_{2} & I + {W}_{3}^{2} & - {W}_{3} \\ 0 & 0 & - {W}_{3} & I\end{matrix} ] [ \begin{matrix}{ϕ}_{0} \\ {W}_{1} {ϕ}_{0} \\ {W}_{2} {W}_{1} {ϕ}_{0} \\ {W}_{3} {W}_{2} {W}_{1} {ϕ}_{0}\end{matrix} ] = 0 , \qquad ( 51 )$$

illustrate the Feynman-Kitaev Hamiltonians and their corresponding ground states for the simple cases of T=1, 2, 3, which compute a desired quantum state W_{1ϕ0}, W₂W_{1ϕ0}, or W₃W₂W_{1ϕ0} respectively.

Another alternative is to use a Fe man-Kitaev Hamiltonian of the form

$$H = {\sum }_{t = 0}^{T} {H}_{t} = [ \begin{matrix}{H}_{0}^{′} + {W}_{1} & - I & & & & & \\ - I & {W}_{1}^{- 1} + {W}_{2}^{2} & - I & & & & \\ & ⋱ & ⋱ & ⋱ & & & \\ & & - I & {W}_{n}^{- 1} + {W}_{n + 1} & - I & & \\ & & & ⋱ & ⋱ & ⋱ & \\ & & & & - I & {W}_{T - 1}^{- 1} + {W}_{T} & - I \\ & & & & & - I & {W}_{T}^{- 1}\end{matrix} ] , \qquad ( 52 )$$

with each non-unitary Feynman-Kitaev propagator Hₜ [symbol] (Hₜ(i,j))_{i,j=1}^{T+1}, t∈[1, T] comprising mostly zero entries except for a 2×2 block as

$${H}_{t} ( i , j ) = \{ \begin{matrix}{W}_{t} , & when i = j = t , \\ - I , & when i = t , j = t + 1 , \\ - I , & when j = t , i = t + 1 , \\ {W}_{t}^{- 1} , & when i = j = t + 1 , \\ 0 , & else w h e r e ,\end{matrix} \qquad ( 53 )$$

and H₀(i,j)=H₀′δᵢⱼ, which has the same zero-energy ground state ψ₀(H) [symbol] const×Σₜ₌₀^{T}|t [symbol] _{C}|ϕₜ [symbol] _{L}, ϕₜ [symbol] W_{tϕt-1}, ∀t∈[1, T], just like that in equation (43), provided that all of the partial Hamiltonians {Hₜ:t∈[0, T]} are non-negative definite. The following equations

$$[ \begin{matrix}{H}_{0}^{′} + {W}_{1} & - I \\ - I & {W}_{1}^{- 1}\end{matrix} ] [ \begin{matrix}{ϕ}_{0} \\ {W}_{1} {ϕ}_{0}\end{matrix} ] = 0 , \qquad ( 54 )$$

$$[ \begin{matrix}{H}_{0}^{′} + {W}_{1} & - I & 0 \\ - I & {W}_{1}^{- 1} + {W}_{2} & - I \\ 0 & - I & {W}_{2}^{- 1}\end{matrix} ] [ \begin{matrix}{ϕ}_{0} \\ {W}_{1} {ϕ}_{0} \\ {W}_{2} {W}_{1} {ϕ}_{0}\end{matrix} ] = 0 , \qquad ( 55 )$$

$$[ \begin{matrix}{H}_{0}^{′} + {W}_{1} & - I & 0 & 0 \\ - I & {W}_{1}^{- 1} + {W}_{2} & - I & 0 \\ 0 & - I & {W}_{2}^{- 1} + {W}_{3} & - I \\ 0 & 0 & - I & {W}_{3}^{- 1}\end{matrix} ] [ \begin{matrix}{ϕ}_{0} \\ {W}_{1} {ϕ}_{0} \\ {W}_{2} {W}_{1} {ϕ}_{0} \\ {W}_{3} {W}_{2} {W}_{1} {ϕ}_{0}\end{matrix} ] = 0 , \qquad ( 56 )$$

illustrate the Feynman-Kitaev Hamiltonians and their corresponding ground states for the simple cases of T=1,2,3, which compute a desired quantum state W_{1ϕ0}, W₂W_{1ϕ0}, or W₃W₂W_{1ϕ0} respectively. In one exemplary embodiment where all {Wₙ}ₙ₌₁^{N} are associated with substantially the same partial Hamiltonian h up to a constant shift of potential energy, all of the matrix blocks Wₙ⁻¹+Wₙ₊₁, ∀n∈[1, N] are commutative and simultaneously diagonalized by the eigenstates of h, the ground state of H can be made to coincide with the ground state of h along the transverse dimensions that are perpendicular to the Feynman-Kitaev time axis, while the potential energy profile along the Feynman-Kitaev time axis can be made convex by adjusting the values of λ₀(Wₙ), n∈ [symbol] , such that the Hamiltonian H has a spectral gap that is provably lower-bounded as Ω(1/poly(T)).

Still another alternative is to use a Feynman-Kitaev operator of the form

$$H = {\sum }_{t = 0}^{T} {H}_{t} = [ \begin{matrix}{H}_{0}^{′} + I & - {W}_{1}^{- 1} & & & & & \\ - {W}_{1} & 2 I & - {W}_{2}^{- 1} & & & & \\ & ⋱ & ⋱ & ⋱ & & & \\ & & - {W}_{n} & 2 I & - {W}_{n + 1}^{- 1} & & \\ & & & ⋱ & ⋱ & ⋱ & \\ & & & & - {W}_{T - 1} & 2 I & - {W}_{T}^{- 1} \\ & & & & & - {W}_{T} & I\end{matrix} ] , \qquad ( 57 )$$

with each non-unitary Feynman-Kitaev propagator Hₜ [symbol] (Hₜ(i,j))_{i,j=1}^{T+1}, t∈[1, T] comprising mostly zero entries except for a 2×2 block as

$${H}_{t} ( i , j ) = \{ \begin{matrix}I , & when i = j = t , \\ - {W}_{t}^{- 1} , & when i = t , j = t + 1 , \\ - {W}_{t} , & when j = t , i = t + 1 , \\ I , & when i = j = t + 1 , \\ 0 , & else w h e r e ,\end{matrix} \qquad ( 58 )$$

and H₀(i,j)=H₀′δᵢⱼ, which has the same zero-energy ground state ψ₀(H) [symbol] const×Σₜ₌₀^{T}|t [symbol] _{C}|ϕₜ [symbol] _{L}, ϕₜ [symbol] W_{tϕt-1}, ∀t∈[1, T] as the eigenvector corresponding to the lowest eigenvalue, just like that in equation (43), and this zero eigenvector is separated from all other eigenstates by an Ω(T⁻²)-bounded spectral gap, as manifested by the following matrix similarity transformation

$${A}^{- 1} H A = [ \begin{matrix}{H}_{0}^{′} + I & - I & & & & & \\ - I & 2 I & - I & & & & \\ & ⋱ & ⋱ & ⋱ & & & \\ & & - I & 2 I & - I & & \\ & & & ⋱ & ⋱ & ⋱ & \\ & & & & - I & 2 I & - I \\ & & & & & - I & I\end{matrix} ] {=}^{def} {H}_{*} , \qquad ( 59 )$$

$$with$$

$$A {=}^{def} [ \begin{matrix}I & & & & \\ & {W}_{1} & & & \\ & & {W}_{2} {W}_{1} & & \\ & & & ⋱ & \\ & & & & {W}_{N} {W}_{N - 1} … {W}_{1}\end{matrix} ] , \qquad ( 60 )$$

$$and$$

$${A}^{- 1} = [ \begin{matrix}I & & & & \\ & {W}_{1}^{- 1} & & & \\ & & {W}_{2}^{- 1} {W}_{2}^{- 1} & & \\ & & & ⋱ & \\ & & & & {W}_{1}^{- 1} {W}_{2}^{- 1} … {W}_{N}^{- 1}\end{matrix} ] , \qquad ( 61 )$$

which shows that the eigen values of H are the same as those of H_{*}, while the spectrum of H_{*} is exactly solvable and well known to be polynomial-gapped. Take N=2 for a concrete example, a Feynman-Kitaev

$$H = [ \begin{matrix}{H}_{0}^{′} + {W}_{1} & - I & 0 \\ - I & {W}_{1}^{- 1} + {W}_{2} & - I \\ 0 & - I & {W}_{2}^{- 1}\end{matrix} ] , \qquad ( 62 )$$

$$with$$

$$A {=}^{def} [ \begin{matrix}I & & \\ & {W}_{1} & \\ & & {W}_{2} {W}_{1}\end{matrix} ] , {A}^{- 1} = [ \begin{matrix}I & & \\ & {W}_{1}^{- 1} & \\ & & {W}_{1}^{- 1} {W}_{2}^{- 1}\end{matrix} ] , \qquad ( 63 )$$

H is similarly-transformed into

$$\begin{matrix}{A}^{- 1} HA = [ \begin{matrix}I & & \\ & {W}_{1}^{- 1} & \\ & & {W}_{1}^{- 1} {W}_{2}^{- 1}\end{matrix} ] [ \begin{matrix}{H}_{0}^{′} + I & - {W}_{1}^{- 1} & 0 \\ - {W}_{1} & 2 I & - {W}_{2}^{- 1} \\ 0 & - {W}_{2} & I\end{matrix} ] [ \begin{matrix}I & & \\ & {W}_{1} & \\ & & {W}_{2} {W}_{1}\end{matrix} ] \\ = [ \begin{matrix}I & & \\ & {W}_{1}^{- 1} & \\ & & {W}_{1}^{- 1} {W}_{2}^{- 1}\end{matrix} ] [ \begin{matrix}{H}_{0}^{′} + I & - I & 0 \\ - {W}_{1} & 2 {W}_{1} & - {W}_{1} \\ 0 & - {W}_{2} {W}_{1} & {W}_{2} {W}_{1}\end{matrix} ] \\ = [ \begin{matrix}{H}_{0}^{′} + I & - I & 0 \\ - I & 2 I & - I \\ 0 & - I & I\end{matrix} ] {=}^{def} {H}_{*} .\end{matrix} \qquad ( 64 )$$

Therefore, a general Feynman-Kitaev operator H of equation (57) has nice spectral properties for GSQC, with the only drawback being that the operator is non-Hermitian and does not directly correspond to a total Hamiltonian governing a quantum system. One remedy is to Hermitian-square such a non-Hermitian operator into either H⁺ H or H H⁺, which becomes Hermitian and corresponds to a quantum system. Better yet, since the Feynman-Kitaev operator H of equation (57) is a sum of an O(T)-bounded number of computationally local operators each of which can be made FBM, the Hamiltonian H⁺ H or H H⁺ is a sum of an O(T²)-bounded number of partial Hamiltonians each of which can be made FBM and a CFF interaction, as such, the Hamiltonian H⁺ H or H H⁺ is amenable to efficient simulations using Monte Carlo on a classical computer without a sign problem, by virtue of a similar method as that employs a total Hamiltonian selected from the group consisting of strongly frustration-free Hamiltonians, ground sate frustration-free Hamiltonians, directly frustration-free Hamiltonians, separately frustration-free Hamiltonians, and sum-of-CFFs Hamiltonians.

In one exemplary embodiment using a non-unitary Feynman-Kitaev construct, an adiabatic procedure is adopted which starts with substantially H=H₀′ and the initial ground state ψ₀(H)=|0 [symbol] _{C}|ϕ₀ [symbol] _{L}, all reference energies {Eₜ′:t∈[1, T]} being set at a very high positive value, then turns on the subsequent non-unitary Feynman-Kitaev propagators {Hₜ:t∈[1, T]} for the later clock sites one by one by lowering and adjusting the reference energies. More specifically and inductively, at a t-th stage, t∈[1, [symbol] ] with clock sites 0, 1, . . . , t−1 already turned on, the reference energy Eₜ′ is initially set so high to make Wₜ≈0, such that the t-th clock site and the later clock sites with an index larger than t are effectively disconnected from the earlier clock sites with an index smaller than t, then lowers the reference energy E^{t}′ gradually to allow the wavefunction ϕₜ [symbol] (Πᵢ₌₁^{t}Wᵢ)ϕ₀ increase its amplitude at the t-th clock site, until the quantum amplitude is approximately equidistributed among the clock sites from 0 to t or distributed according to a desired profile along the axis of clock sites called the axis of imaginary time.

In all of the embodiments using a non-unitary Feynman-Kitaev Hamiltonian, as a means to avoid complexity due to boundary effects in an associated generalized Feynman-Kitaev construct, it is useful to set the initial state at the center of a Feynman-Kitaev lattice and have non-unitary Feynman-Kitaev propagators placed mirror-symmetrically about said center until reaching halting clock sites that are located mirror-symmetrically about said center, then continue to have identity state-copying Feynman-Kitaev propagators placed mirror-symmetrically about said center, such that, the ground state of the generalized Feynman-Kitaev construct has quantum amplitude decaying exponentially as the Feynman-Kitaev clock sites get farther away from said halting clock sites toward the boundaries of the generalized Feynman-Kitaev construct, until becoming negligibly small at said boundaries. Alternatively, it is useful to make the generalized Feynman-Kitaev construct cyclic and form a ring or torus or hyper-torus for a one- or two- or many-dimensional lattice of a generalized Feynman-Kitaev construct, where no boundary exists.

For a Feynman-Kitaev construct comprising either unitary Feynman-Kitaev propagators or non-unitary Feynman-Kitaev propagators or both types of Feynman-Kitaev propagators combined, it is advantageous to design and optimize the graph or topology of the Feynman-Kitaev construct or lattice in such a manner as to achieve a favorable scaling of the spectral gap Δλ(H_{FK}) [symbol] λ₁(H_{FK})−λ₀(H_{FK}) versus the number T∈ [symbol] of quantum gates needed to implement a predetermined quantum circuit, as exemplified in equations (35-38), where the spectral gap Δλ(H_{FK}) is the energy gap separating the ground state of the associated Feynman-Kitaev Hamiltonian Δλ(H_{FK}) from all of its excited states. The standard Feynman-Kitaev construct with a linear Feynman-Kitaev lattice/chain/graph or a one-dimensional ring-shaped Feynman-Kitaev lattice/chain/graph achieves a quadratic scaling as Δλ(H_{FK})=Ω(T⁻²). As being specified in the incorporated references, a lifted Feynman-Kitaev construct that adapts the technique of lifting Markov chains or lifted Markov chains [60-62] provides a linear scaling as Δλ(H_{FK})=Ω(T¹) for the spectral gap and O(T) for the mixing time of a Monte Carlo procedure simulating the associated lifted Feynman-Kitaev Hamiltonian said lifted Feynman-Kitaev construct. Besides, the standard technique of lifting Markov chains or lifted Markov chains as taught in references [60-62] applies at the level or layer of the Monte Carlo procedure or random walk simulation, with or without a Feynman-Kitaev construct. The two-rings-at-two-elevations lifted Markov chain provides an exemplary embodiment.

There have been techniques reported to obtain polynomially improved spectral gaps for adiabatic quantum computations and efficient quantum simulations of classical Monte Carlo methods [63-66], culminating in a systematic formulation and solution of spectral gap amplification [67], which transforms one substantially frustration-free Hamiltonian in the form of a sum of substantially frustration-free interactions into another Hamiltonian with a spectral gap that enjoys a polynomially improved scaling. Reference [35] has also alluded to a GSQC Hamiltonian with a spectral gap that scales as Ω(T⁻¹).

Also as being disclosed, a multi-dimensional or many-dimensional Feynman-Kitaev construct provides advantages associated with the phenomena of measure concentration [56], which promotes substantial concentration of probability amplitudes in a specific shell-shaped region with respect to an prescribed origin of an associated multi-dimensional or many-dimensional Feynman-Kitaev lattice, due to either a central limit theorem-type of probability concentration or a geometric volume concentration or another type of measure concentration, such that a prescribed observable making a measurement at lattice points in said shell-shaped region reads out a predetermined quantum result, and the phenomena of measure concentration advantageously accelerate such read-out of said predetermined quantum result.

One skilled in the art would readily see ways and means for using the disclosed and specified methods and embodiments to devise a multi-dimensional or many-dimensional Feynman-Kitaev construct, which has program counter sites or called clock sites arranged into an N-dimensional lattice (called the Feynman-Kitaev lattice), N≥1, with each of most of the clock sites being connected to substantially N neighbor clock sites via a Feynman-Kitaev propagator that executes a quantum gate of quantum computation as a certain particle or quantum amplitude makes a transition from one clock site to a neighbor clock site, where a certain clock site from the inner part of the N-dimensional Feynman-Kitaev lattice is chosen as the start clock site at which a quantum register consisting of a plurality of qubits is set to an initial quantum state, while the Feynman-Kitaev propagators connecting the clock sites are arranged such that a prescribed sequence of quantum gates constituting a quantum circuit realizing a quantum algorithms are applied in order as said certain particle or quantum amplitude moves away from the start clock site toward the outer part of the N-dimensional Feynman-Kitaev lattice, whereby the concentration of measure at the outermost part of the N-dimensional lattice helps to propagate said certain particle or quantum amplitude outward and to boost the probability of finding a desired computational result produced by said quantum circuit.

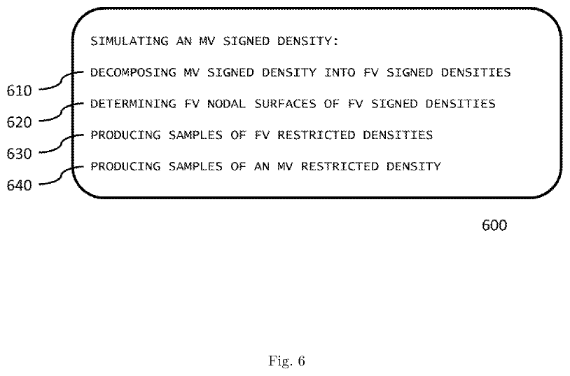

According to an exemplary embodiment, FIG. 6 illustrates one method 600 of simulating a many-variable (MV) signed density as a function whose domain is an MV product space of an MV configuration space [symbol] _{MV} as a compact manifold, where [symbol] _{MV} is a set of MV configuration points each of which is represented by a tuple or vector of variable values assigned to a first ensemble of coordinate variables, with the first ensemble of coordinate variables consisting of a variable number N∈ [symbol] of members or elements, namely, each of said MV configuration points is an N-tuple or N-dimensional vector of variable values. The configuration space [symbol] _{MV} is a compact manifold in the standard mathematical sense, that is, a topology is defined on [symbol] _{MV} with respect to which [symbol] _{MV} is a compact set and a compact topological space [68, 69]. Method 600 comprises providing a first means 610 for decomposing said MV signed density into a combination of a first plurality K∈ [symbol] of few-variable (FV) signed densities each of which corresponds to a second ensemble of a second plurality of coordinate variables, providing a second means 620 for determining FV nodal surfaces corresponding to each of said FV signed densities, providing a third means 630 for producing a third plurality of samples of FV restricted densities, and providing a fourth means 640 for producing a fourth plurality of samples of an MV restricted density. The means 610, 620, 630, and 640 are combined to endow method 600 an advantage that said MV restricted density is non-negative-valued and substantially equivalent to said MV signed density, in the sense that a signed expectation value of a prescribed observable due to said MV restricted density is substantially equal to the signed expectation value of said prescribed observable due to said MV signed density, where the prescribed observable is selected from the group consisting of the number 1, a predetermined constant, and a prescribed function whose domain is contained in said MV product space of said MV configuration space [symbol] _{MV}.

In relation to the first means 610, said second ensemble of coordinate variables corresponding to said each of said first plurality K of FV signed densities consists of said second plurality L∈ [symbol] of coordinate variables selected from said first ensemble of coordinate variables, a set of variable values assigned to said corresponding second ensemble of coordinate variables constitutes a corresponding FV configuration space or submanifold [symbol] _{FV}, where said first plurality K is substantially upper-bounded by a first predetermined polynomial P₁(N), while said second plurality L is substantially upper-bounded by a predetermined logarithm of a second predetermined polynomial P₂(N), with N being said variable number N, such that, said each of said FV signed densities is associated with a corresponding family of FV reduced configuration spaces, with said corresponding family of FV reduced configuration spaces being substantially a corresponding family of FV cosets or submanifolds of the form [symbol] _{FV}⊕r [symbol] {(q,r):q∈ [symbol] _{FV}}⊆ [symbol] _{MV}, where C_{FV} is said corresponding FV configuration space or submanifold consisting of L-tuples or L-dimensional vectors of variable values assigned to said corresponding second ensemble of coordinate variables, while r is any configuration point in an orthogonal complementary submanifold [symbol] _{FV}′ which consists of (N−L)-tuples or (N−L)-dimensional vectors of variable values assigned to coordinate variables that are in said first ensemble but out of said corresponding second ensemble. That said second plurality L is substantially upper-bounded by said predetermined logarithm of P₂(N) means that said each of said FV signed density can always be efficiently computed and substantially exhaustive-sampled over a product space of each of said corresponding family of FV reduced configuration spaces, with said each of said corresponding family of FV reduced configuration spaces being of the form [symbol] _{FV}⊕r, r∈ [symbol] _{FV}, which is a submanifold whose dimension is upper-bounded by said second plurality L.

In relation to the second means 620, a corresponding family of FV nodal surfaces are determined for each of said FV signed densities, with each member of said corresponding family of FV nodal surfaces encloses a corresponding FV nodal cell in which the corresponding FV signed density is non-negative-valued, with said corresponding FV nodal cell being a corresponding FV reduced configuration space, inside which any pair of MV configuration points differ from each other at most in variable values assigned to coordinate variables selected from the corresponding second ensemble of coordinate variables.

In relation to the third means 630, an FV plurality of non-negative-valued samples of a sequence of FV restricted densities are produced by repeatedly evaluating said sequence of FV restricted densities at a sequence of sample points forming a sample path or Feynman path, where each of said sequence of sample points is taken from a corresponding nodal cell of one of said FV signed densities, whereas each of said sequence of FV restricted densities is substantially equal to a corresponding one of said FV signed densities restricted to one of the corresponding nodal cells. Said FV plurality of non-negative-valued samples is substantially upper-bounded by a predetermined polynomial of said variable number N.

In relation to the fourth means 640, an MV plurality of non-negative-valued samples of an MV restricted density are produced by combining the FV plurality of non-negative-valued samples of FV restricted densities obtained by the third means 630. Said MV plurality of non-negative-valued samples is substantially upper-bounded by a predetermined polynomial of said variable number N.

In a first exemplary embodiment of method 600, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space [symbol] _{MV}, while said each of said FV signed densities is an FV stationary distribution of a corresponding one of FV quasi-stochastic operators, said each of said FV signed densities is associated with each of said corresponding family of FV reduced configuration spaces of the form [symbol] _{FV}⊕r, r∈ [symbol] _{FV}′, said corresponding one of FV quasi-stochastic operators can only induce transitions among MV configuration points that are contained in the same coset [symbol] _{FV}⊕r for a certain fixed r∈ [symbol] _{FV}′, wherein said MV signed density is decomposed into a combination of said FV signed densities in the sense that said MV signed density is substantially the single unique signed density associated with CMV which substantially coincides with each of said FV signed densities associated with each of said corresponding family of FV reduced configuration spaces of the form C_{FV}⊕r, r∈ [symbol] _{FV}.

In a second exemplary embodiment of method 600, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space [symbol] _{MV}, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form [symbol] _{FV}⊕r, r∈ [symbol] _{FV}′ said corresponding one of FV quasi-stochastic operators can only induce transitions among MV configuration points that are contained in the same coset C_{FV}⊕r for a certain fixed r∈ [symbol] _{FV}′, wherein said MV signed density is decomposed into a combination of said FV signed densities in the sense that said MV signed density is substantially the single unique signed density associated with [symbol] _{MV} which is the stationary distribution or called stationary distribution of an inhomogeneous quasi-Markov chain generated by a sequence of said FV quasi-stochastic operators.

In a third exemplary embodiment of method 600, said MV configuration space [symbol] _{MV}, is a state space of a homogeneous quasi-Markov chain generated by an MV quasi-stochastic operator, said MV signed density is an MV quasi-Markov transition probability density due to a homogeneous quasi-Markov chain generated by an MV quasi-stochastic operator, said MV signed density is associated with said MV configuration space [symbol] _{MV}, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form [symbol] _{FV}⊕r, r∈C_{FV}′, said corresponding one of FV quasi-stochastic operators can only induce transitions among MV configuration points that are contained in the same coset [symbol] _{FV}⊕r for a certain fixed r∈ [symbol] _{FV}′, wherein said MV signed density is decomposed into a combination of said FV signed densities in the sense that said MV quasi-Markov transition probability density is substantially equal to an FV quasi-Markov transition probability density due to an inhomogeneous quasi-Markov chain generated by a sequence of said FV quasi-stochastic operators.

In a fourth exemplary embodiment of method 600, said MV configuration space [symbol] _{MV} is a cylinder set for Feynman path integral in relation to an MV Gibbs operator, said MV signed density is a Gibbs wavefunction or Gibbs transition amplitude due to said MV Gibbs operator, said MV signed density is associated with said MV configuration space [symbol] _{MV}, while said each of said FV signed densities is one of FV Gibbs transition amplitudes due to a corresponding one of FV Gibbs operators, said each of said FV signed densities is associated with each of said corresponding family of FV reduced configuration spaces of the form C_{FV}⊕r, r∈ [symbol] _{FV}′, said corresponding one of FV Gibbs operators can only induce transitions among MV configuration points that are contained in the same coset C_{FV}⊕r for a certain fixed r∈ [symbol] _{FV}′, wherein said MV signed density is decomposed into a combination of said FV signed densities in the sense that said MV signed density is substantially equal to a Feynman path integral involving said FV Gibbs transition amplitudes in relation to a Feynman stack associated with a sequence of said FV Gibbs operators.

In other alternative embodiments of method 600, other similar ways and means are employed to similarly decompose said MV signed density into a combination of said FV signed densities and achieve the same advantage in method 600 of simulating said MV signed density.

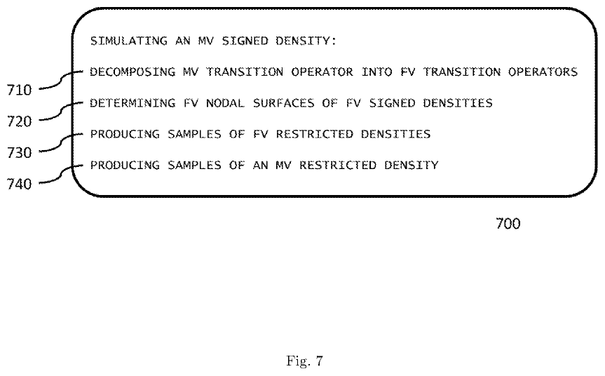

According to an exemplary embodiment, FIG. 7 illustrates another method 700 of simulating a many-variable signed density as a function whose domain is an MV product space of an MV configuration space [symbol] _{MV} as a compact manifold, where said MV signed density is induced by an MV transition operator, said MV transition operator involves a first ensemble of coordinate variables, with first ensemble of coordinate variables consisting of a variable number N∈ [symbol] of members. An N-tuple or N-dimensional vector of variable values assigned to said first ensemble of coordinate variables represents an MV configuration point, a set of such MV configuration points constitute an MV configuration space. The MV signed density is practically substantially entangled. The configuration space [symbol] _{MV} is a compact manifold in the standard mathematical sense, that is, a topology is defined on [symbol] _{MV} with respect to which CMV is a compact set and a compact topological space [68, 69]. Method 700 comprises providing a first means 710 for decomposing said MV transition operator into a combination of a first plurality K∈ [symbol] of few-variable (FV) transition operators with each of said FV transition operators inducing a corresponding one of FV signed densities, providing a second means 720 for determining FV nodal surfaces corresponding to each of said FV signed densities, providing a third means 730 for producing a third plurality of samples of FV restricted densities, and providing a fourth means 740 for producing a fourth plurality of samples of an MV restricted density by combining said third plurality of samples of FV restricted densities. The means 710, 720, 730, and 740 are combined to endow method 700 an advantage that said MV restricted density is non-negative-valued and substantially equivalent to said MV signed density, in the sense that a signed expectation value of a prescribed observable due to said MV restricted density is substantially equal to the signed expectation value of said prescribed observable due to said MV signed density, where the prescribed observable is selected from the group consisting of the number 1, a predetermined constant, and a prescribed function whose domain is contained in said MV product space of said MV configuration space [symbol] _{MV}.

In relation to the first means 710, said MV transition operator is decomposed into a combination of a first plurality K of FV transition operators, each of said FV transition operators involves a corresponding second ensemble of coordinate variables selected from said first ensemble of coordinate variables and induces a corresponding one of FV signed densities, the corresponding second ensemble of coordinate variables consists of a second plurality L∈ [symbol] of members, a set of variable values assigned to said corresponding second ensemble of coordinate variables constitutes a corresponding FV configuration space or submanifold [symbol] _{FV}, where said first plurality K is substantially upper-bounded by a first predetermined polynomial P₁(N), while said second plurality L is substantially upper-bounded by a predetermined logarithm of a second predetermined polynomial P₂(N), with N being said variable number N, such that, said each of said FV signed densities is associated with a corresponding family of FV reduced configuration spaces, with said corresponding family of FV reduced configuration spaces being substantially a corresponding family of FV cosets or submanifolds of the form [symbol] _{FV}⊕r [symbol] {(q,r):q∈ [symbol] _{FV}}⊆ [symbol] _{MV}, where [symbol] _{FV} is said corresponding FV configuration space or submanifold consisting of L-tuples or L-dimensional vectors of variable values assigned to said corresponding second ensemble of coordinate variables, while r is any configuration point in an orthogonal complementary submanifold [symbol] _{FV}′ which consists of (N−L)-tuples or (N−L)-dimensional vectors of variable values assigned to coordinate variables that are in said first ensemble but out of said corresponding second ensemble. That said second plurality L is substantially upper-bounded by said predetermined logarithm of P₂(N) means that said each of said FV signed density can always be efficiently computed and substantially exhaustive-sampled over a product space of each of said corresponding family of FV reduced configuration spaces, with said each of said corresponding family of FV reduced configuration spaces being of the form [symbol] _{FV}⊕r, r∈ [symbol] _{F}′, which is a submanifold whose dimension is upper-bounded by said second plurality L.

In relation to the second means 720, a corresponding family of FV nodal surfaces are determined for each of said FV signed densities, with each member of said corresponding family of FV nodal surfaces encloses a corresponding FV nodal cell in which the corresponding FV signed density is non-negative-valued, with said corresponding FV nodal cell being a corresponding FV reduced configuration space, inside which any pair of MV configuration points differ from each other at most in variable values assigned to coordinate variables selected from the corresponding second ensemble of coordinate variables.

In relation to the third means 730, an FV plurality of non-negative-valued samples of a sequence of FV restricted densities are produced by repeatedly evaluating said sequence of FV restricted densities at a sequence of sample points forming a sample path or Feynman path, where each of said sequence of sample points is taken from a corresponding nodal cell of one of said FV signed densities, whereas each of said sequence of FV restricted densities is substantially equal to a corresponding one of said FV signed densities restricted to one of the corresponding nodal cells. Said FV plurality of non-negative-valued samples is substantially upper-bounded by a predetermined polynomial of said variable number N.

In relation to the fourth means 740, an MV plurality of non-negative-valued samples of an MV restricted density are produced by combining the FV plurality of non-negative-valued samples of FV restricted densities obtained by the third means 730. Said MV plurality of non-negative-valued samples is substantially upper-bounded by a predetermined polynomial of said variable number N.

In a first exemplary embodiment of method 700, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space [symbol] _{MV}, while said each of said FV signed densities is an FV stationary distribution of a corresponding one of FV quasi-stochastic operators, said each of said FV signed densities is associated with each of said corresponding family of FV reduced configuration spaces of the form [symbol] _{FV}⊕r, r∈ [symbol] _{FV}′, said corresponding one of FV quasi-stochastic operators can only induce transitions among MV configuration points that are contained in the same coset [symbol] _{FV}⊕r for a certain fixed r∈ [symbol] _{FV}′, wherein said MV signed density is decomposed into a combination of said FV signed densities in the sense that said MV signed density is substantially the single unique signed density associated with [symbol] _{MV} which substantially coincides with each of said FV signed densities associated with each of said corresponding family of FV reduced configuration spaces of the form C_{FV}⊕r, r∈C_{FV}′.

In a second exemplary embodiment of method 700, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space CMV, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form C_{FV}⊕r, r∈ [symbol] ′_{FV} said corresponding one of FV quasi-stochastic operators can only induce transitions among MV configuration points that are contained in the same coset C_{FV}⊕r for a certain fixed r∈ [symbol] _{FV}′, wherein said MV signed density is decomposed into a combination of said FV signed densities in the sense that said MV signed density is substantially the single unique signed density associated with [symbol] _{MV} which is the stationary distribution or called stationary distribution of an inhomogeneous quasi-Markov chain generated by a sequence of said FV quasi-stochastic operators.

In a third exemplary embodiment of method 700, said MV configuration space [symbol] _{MV} is a state space of a homogeneous quasi-Markov chain generated by an MV quasi-stochastic operator, said MV signed density is an MV quasi-Markov transition probability density due to a homogeneous quasi-Markov chain generated by an MV quasi-stochastic operator, said MV signed density is associated with said MV configuration space CMV, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form [symbol] _{FV}⊕r, r∈ [symbol] ′_{FV}, said corresponding one of FV quasi-stochastic operators can only induce transitions among MV configuration points that are contained in the same coset [symbol] _{FV}⊕r for a certain fixed r∈ [symbol] _{FV}′, wherein said MV signed density is decomposed into a combination of said FV signed densities in the sense that said MV quasi-Markov transition probability density is substantially equal to an FV quasi-Markov transition probability density due to an inhomogeneous quasi-Markov chain generated by a sequence of said FV quasi-stochastic operators.

In a fourth exemplary embodiment of method 700, said MV configuration space [symbol] _{MV} is a cylinder set for Feynman path integral in relation to an MV Gibbs operator, said MV signed density is a Gibbs wavefunction or Gibbs transition amplitude due to said MV Gibbs operator, said MV signed density is associated with said MV configuration space [symbol] _{MV}, while said each of said FV signed densities is one of FV Gibbs transition amplitudes due to a corresponding one of FV Gibbs operators, said each of said FV signed densities is associated with each of said corresponding family of FV reduced configuration spaces of the form [symbol] _{FV}⊕r, r∈ [symbol] _{FV}′, said corresponding one of FV Gibbs operators can only induce transitions among MV configuration points that are contained in the same coset [symbol] _{FV}⊕r for a certain fixed r∈ [symbol] _{FV}′, wherein said MV signed density is decomposed into a combination of said FV signed densities in the sense that said MV signed density is substantially equal to a Feynman path integral involving said FV Gibbs transition amplitudes in relation to a Feynman stack associated with a sequence of said FV Gibbs operators.

In other alternative embodiments of method 700, other similar ways and means are employed to similarly decompose said MV signed density into a combination of said FV signed densities and achieve the same advantage in method 700 of simulating said MV signed density.

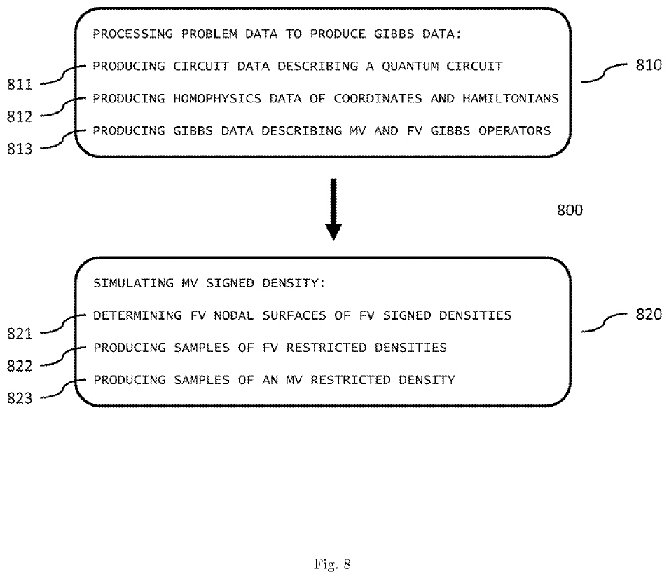

According to an exemplary embodiment, FIG. 8 illustrates one method 800 of solving a computational problem which is described by problem data. Method 800 comprises providing a first means 810 for processing said problem data to produce Gibbs data which describe a many-variable (MV) Gibbs operator that induces an MV signed density in conjunction with a plurality of few-variable (FV) Gibbs operators, and providing a second means 820 for simulating said MV signed density, whereby a solution to said computational problem is obtained substantially by said simulating said MV signed density to estimate substantially a signed expectation value of a prescribed observable due to said MV signed density.

In relation to the first means 810, said problem data are processed to produce Gibbs data. Said first means 810 further comprises providing a first processing means 811 for producing circuit data describing a quantum circuit that produces a quantum result encoding said solution to said computational problem, providing a second processing means 812 for producing homophysics data comprising coordinate data and Hamiltonian data, and providing a third processing means 813 that produces Gibbs data comprising a description of an MV Gibbs operator that induces said MV signed density in conjunction with said plurality of FV Gibbs operators, whereby said MV signed density encodes said quantum result in the sense that the signed expectation value of said prescribed observable due to said MV signed density is substantially equal to said quantum result, said prescribed observable is selected from the group consisting of the number 1, a predetermined constant, and a prescribed function associated with subset of an MV configuration space [symbol] _{MV}, which is a compact manifold, namely, a topology is defined on [symbol] _{MV} with respect to which the manifold [symbol] _{MV} is a compact set and a compact topological space [68, 69].

In relation to the first processing means 811, said circuit data are produced to describe a quantum circuit, said circuit data comprise qubit data and gate data, said qubit data comprise a description of a plurality N_{b}∈ [symbol] of qubits, said gate data comprise a description of a plurality N_{g}∈ [symbol] of quantum gates, wherein each of said quantum gates involves at most a predetermined number of said qubits, said quantum circuit produces a quantum result encoding said solution to said computational problem.

In relation to the second processing means 812, homophysics data comprising coordinate data and Hamiltonian data are produced. Said coordinate data comprise a description of a first ensemble of coordinate variables, said first ensemble of coordinate variables consists of a variable number N of members, with said coordinate variables homophysically implementing said qubits, such that an N-tuple or N-dimensional vector of variable values assigned to said first ensemble of coordinate variables represent an MV configuration point, a set of such MV configuration points constitute said MV configuration space [symbol] _{MV}. Said Hamiltonian data comprise a description of a plurality K ∈ [symbol] of FV Hamiltonians, with each of said FV Hamiltonians involving a corresponding second ensemble of coordinate variables selected from said first ensemble of coordinate variables, where said corresponding second ensemble of coordinate variables consists of a plurality L∈ [symbol] of members, each of said FV Hamiltonians corresponds to one of said quantum gates, and said FV Hamiltonians combine into an MV Hamiltonian, wherein said variable number N is substantially upper-bounded by a predetermined polynomial of (N_{b}+N_{g}), said plurality K is substantially upper-bounded by another predetermined polynomial of (N_{b}+N_{g}), said plurality L is substantially upper-bounded by a predetermined logarithm of yet another predetermined polynomial of (N_{b}+N_{g}).

In relation to the third processing means 813, Gibbs data are produced which comprise a description of said MV Gibbs operator and said plurality of FV Gibbs operators, where said MV Gibbs operator is generated by said MV Hamiltonian, each of said FV Gibbs operators is generated by a corresponding one of said FV Hamiltonians, such that, said MV Gibbs operator induces said MV signed density, each of said FV Gibbs operators induces a corresponding one of FV signed densities, wherein the number of members in said plurality of FV Gibbs operators is upper-bounded by a predetermined polynomial of (N_{b}+N_{g}), both said MV signed density and each of said FV signed densities are associated with a subset of said MV configuration space [symbol] _{MV}.

The processing means 811, 812, and 813 are combined to endow the first means 810 an advantage with which said MV signed density is decomposed into said FV signed densities such that said MV signed density is amenable to efficient simulations. Specifically, the first means 810 has said MV transition operator decomposed into a combination of said plurality K of FV transition operators, where each of said FV transition operators involves said corresponding second ensemble of coordinate variables selected from said first ensemble of coordinate variables and induces said corresponding one of FV signed densities, the corresponding second ensemble of coordinate variables consists of said plurality L∈ [symbol] of members, a set of variable values assigned to said corresponding second ensemble of coordinate variables constitutes a corresponding FV configuration space or submanifold [symbol] _{FV}, wherein said plurality K is substantially upper-bounded by a predetermined polynomial P₁(N_{b}+N_{g}), such that, said each of said FV signed densities is associated with a corresponding family of FV reduced configuration spaces, with said corresponding family of FV reduced configuration spaces being substantially a corresponding family of FV cosets or submanifolds of the form C_{FV}⊕r [symbol] {(q,r):q∈ [symbol] _{FV}}⊆ [symbol] _{MV}, where [symbol] _{FV} is said corresponding FV configuration space or submanifold consisting of L-tuples or L-dimensional vectors of variable values assigned to said corresponding second ensemble of coordinate variables, while r is any configuration point in an orthogonal complementary submanifold [symbol] _{FV}′ which consists of (N−L)-tuples or (N−L)-dimensional vectors of variable values assigned to coordinate variables that are in said first ensemble but out of said corresponding second ensemble. That said plurality L is substantially upper-bounded by said predetermined logarithm of said predetermined polynomial of (N_{b}+N_{g}) means that said each of said FV signed density can always be efficiently computed and substantially exhaustive-sampled over a product space of each of said corresponding family of FV reduced configuration spaces, with said each of said corresponding family of FV reduced configuration spaces being of the form C_{FV}⊕r, r∈C_{FV}′, which is a submanifold whose dimension is upper-bounded by said second plurality L.

In a first exemplary embodiment of the first means 810, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space [symbol] _{MV}, while said each of said FV signed densities is an FV stationary distribution of a corresponding one of FV quasi-stochastic operators, said each of said FV signed densities is associated with each of said corresponding family of FV reduced configuration spaces of the form C_{FV}⊕r, r∈C_{FV}′, said corresponding one of FV quasi-stochastic operators can only induce transitions among MV configuration points that are contained in the same coset [symbol] _{FV} ⊕r for a certain fixed r∈ [symbol] _{F}′, wherein said MV signed density is decomposed into a combination of said FV signed densities in the sense that said MV signed density is substantially the single unique signed density associated with CMV which substantially coincides with each of said FV signed densities associated with each of said corresponding family of FV reduced configuration spaces of the form [symbol] _{FV} ⊕r, r∈ [symbol] _{FV}′.

In a second exemplary embodiment of the first means 810, said MV configuration space [symbol] _{MV} is a state space of a homogeneous quasi-Markov chain generated by an MV quasi-stochastic operator, said MV signed density is an MV stationary distribution of said MV quasi-stochastic operator, said MV signed density is associated with said MV configuration space CMV, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form [symbol] _{FV} ⊕r, r∈ [symbol] _{FV}′, said corresponding one of FV quasi-stochastic operators can only induce transitions among MV configuration points that are contained in the same coset C_{FV}⊕r for a certain fixed r∈ [symbol] _{FV}′, wherein said MV signed density is decomposed into a combination of said FV signed densities in the sense that said MV signed density is substantially the single unique signed density associated with CMV which is the stationary distribution or called stationary distribution of an inhomogeneous quasi-Markov chain generated by a sequence of said FV quasi-stochastic operators.

In a third exemplary embodiment of the first means 810, said MV configuration space [symbol] _{MV} is a state space of a homogeneous quasi-Markov chain generated by an MV quasi-stochastic operator, said MV signed density is an MV quasi-Markov transition probability density due to a homogeneous quasi-Markov chain generated by an MV quasi-stochastic operator, said MV signed density is associated with said MV configuration space [symbol] _{MV}, while said each of said FV signed densities is an FV quasi-Markov transition probability density due to a quasi-Markov chain generated by a corresponding one of FV quasi-stochastic operators, said each of said FV signed densities is associated with each of said corresponding family of FV reduced configuration spaces of the form [symbol] _{FV}⊕r, r∈C′_{FV}, said corresponding one of FV quasi-stochastic operators can only induce transitions among MV configuration points that are contained in the same coset [symbol] _{FV} ⊕r for a certain fixed r∈ [symbol] _{FV}′, wherein said MV signed density is decomposed into a combination of said FV signed densities in the sense that said MV quasi-Markov transition probability density is substantially equal to an FV quasi-Markov transition probability density due to an inhomogeneous quasi-Markov chain generated by a sequence of said FV quasi-stochastic operators.

In a fourth exemplary embodiment of the first means 810, said MV configuration space [symbol] _{MV} is a cylinder set for Feynman path integral in relation to an MV Gibbs operator, said MV signed density is a Gibbs wavefunction or Gibbs transition amplitude due to said MV Gibbs operator, said MV signed density is associated with said MV configuration space [symbol] _{MV}, while said each of said FV signed densities is one of FV Gibbs transition amplitudes due to a corresponding one of FV Gibbs operators, said each of said FV signed densities is associated with each of said corresponding family of FV reduced configuration spaces of the form C_{FV}⊕r, r∈ [symbol] _{FV}′, said corresponding one of FV Gibbs operators can only induce transitions among MV configuration points that are contained in the same coset C_{FV}⊕r for a certain fixed r∈ [symbol] _{FV}′, wherein said MV signed density is decomposed into a combination of said FV signed densities in the sense that said MV signed density is substantially equal to a Feynman path integral involving said FV Gibbs transition amplitudes in relation to a Feynman stack associated with a sequence of said FV Gibbs operators.

In other alternative embodiments of the first means 810, other similar ways and means are employed to similarly decompose said MV signed density into a combination of said FV signed densities and achieve the same advantage in the first means 810 for processing said problem data to produce said Gibbs data.

In relation to the second means 820, said MV signed density is simulated. Said second means 820 further comprises providing a first simulating means 821 for determining FV nodal surfaces corresponding to each of said FV signed densities, providing a second simulating means for producing a plurality of samples of FV restricted densities, and providing a third simulating means for producing another plurality of samples of an MV restricted density, whereby said MV restricted density is substantially equivalent to said MV signed density in the sense that the signed expectation value of said prescribed observable due to said MV restricted density is substantially equal to the signed expectation value of said prescribed observable due to said MV signed density.

In relation to the first simulating means 821, a corresponding family of FV nodal surfaces are determined for each of said FV signed densities, with each member of said corresponding family of FV nodal surfaces encloses a corresponding FV nodal cell in which the corresponding FV signed density is non-negative-valued, with said corresponding FV nodal cell being a corresponding FV reduced configuration space, inside which any pair of MV configuration points differ from each other at most in variable values assigned to coordinate variables selected from the corresponding second ensemble of coordinate variables.

In relation to the second simulating means 822, an FV plurality of non-negative-valued samples of a sequence of FV restricted densities are produced by repeatedly evaluating said sequence of FV restricted densities at a sequence of sample points forming a sample path or Feynman path, where each of said sequence of sample points is taken from a corresponding nodal cell of one of said FV signed densities, whereas each of said sequence of FV restricted densities is substantially equal to a corresponding one of said FV signed densities restricted to one of the corresponding nodal cells. Said FV plurality of non-negative-valued samples is substantially upper-bounded by a predetermined polynomial of (N_{b}+N_{g}).

In relation to the third simulating means 823, an MV plurality of non-negative-valued samples of an MV restricted density are produced by combining the FV plurality of non-negative-valued samples of FV restricted densities obtained by the second simulating means 822. Said MV plurality of non-negative-valued samples is substantially upper-bounded by a predetermined polynomial of (N_{b}+N_{g}).

### REFERENCES

1. R. P. Feynman, “Simulating physics with computers,” Int. J. Theo. Phys., vol. 21, nos. 6/7, pp. 467-488 (1982).
2. J. Grotendorst, D. Marx, and A. Muramatsu (Eds.), Quantum Simulations of Complex Many-Body Systems: From Theory to Algorithms (John von Neumann Institute for Computing, 2002).
3. R. P. Feynman, “Quantum mechanical computers,” Optics News, vol. 11, pp. 11-20 (1985).
4. S. Lloyd, “Universal quantum simulators,” Science, vol. 273, no. 5278, pp. 1073-1078 (1996).
5. E. Y. Loh Jr., J. E. Gubernatis, R. T. Scalettar, S. R. White, D. J. Scalapino, and R. L. Sugar, “Sign problem in the numerical simulation of many-electron systems,” Phys. Rev. B, vol. 41, no. 13, pp. 9301-9307 (1990).
6. D. M. Ceperley, “Fermion nodes,” J. Stat. Phys., vol. 63, no. 5/6, pp. 1237-1267 (1991).
7. E. Bernstein and U. Vazirani, “Quantum complexity theory,” SIAM J. Comput., vol. 26, no. 5, pp. 1411-1473 (1997).
8. D. A. Levin, Y. Peres, and E. L. Wilmer, Markov Chains and Mixing Times (American Math. Society, 2008).
9. D. H. Wei, “Monte Carlo Quantum Computing,” arXiv:2012.14523 [quant-ph].
10. E. Hopf, “A remark on linear elliptic differential equations of second order,” Proc. Amer. Math. Soc., vol. 3, pp. 791-793 (1952).
11. L. C. Evans, Partial Differential Equations, 2nd Ed. (American Mathematical Society, 2010).
12. T. Rudolph and L. Grover, “A 2 rebit gate universal for quantum computing,” arXiv:quant-ph/0210187.
13. J. D. Biamonte and P. J. Love, “Realizable Hamiltonians for universal adiabatic quantum computers,” Phys. Rev. A, vol. 78, 012352 (2008).
14. A. Yu. Kitaev, A. H. Shen, and M. N. Vyalyi, Classical and Quantum Computation (AMS, Providence, RI, 2002).
15. J. Kempe, A. Kitaev, and O. Regev, “The complexity of the local Hamiltonian problem,” SIAM J. Comput., vol. 35, no. 5, pp. 1070-1097 (2006).
16. D. Knuth, “Big Omicron and big Omega and big Theta,” ACM SIGACT News, April-June 1976, pp. 18-24 (1976).
17. R. P. Feynman and A. R. Hibbs, Quantum Mechanics and Path Integrals (McGraw-Hill, 1965).
18. B. Simon, Functional Integration and Quantum Physics (Academic Press, 1979).
19. D M. Ceperley, “Path integral Monte Carlo methods for fermions,” in K. Binder and G. Ciccotti (Eds.), Monte Carlo and Molecular Dynamics of Condensed Matter Systems (Editrice Compositori, Bologna, Italy, 1996).
20. S. Zhang, J. Carlson, and J. E. Gubernatis, “Constrained path Monte Carlo method for fermion ground states,” Phys. Rev. B, vol. 55, no. 12, pp. 7464-7477 (1997).
21. S. Zhang, “Quantum Monte Carlo methods for strongly correlated electron systems,” in D. Sénéchal, A.-M. Tremblay, and C. Bourbonnais (Eds.), Theoretical Methods for Strongly Correlated Electrons (Springer-Verlag, 2004), pp. 39-74.
22. F. Krüger and J. Zaanen, “Fermionic quantum criticality and the fractal nodal surface,” Phys. Rev. B, vol. 78, 035104 (2008).
23. T. Dornheim, S. Groth, A. Filinov, and M. Bonitz, “Permutation blocking path integral Monte Carlo: a highly efficient approach to the simulation of strongly degenerate non-ideal fermions,” New. J. Phys., vol. 17, 073017 (2015).
24. Y. Yan and D. Blume, “Path integral Monte Carlo ground state approach: formalism, implementation, and applications,” J. Phys. B, vol. 50, 223001 (2017).
25. B. Militzer, “Path integral Monte Carlo simulations of hot dense hydrogen,” Ph.D. thesis, University of Illinois at Urbana-Champaign (2000). See equations (2.49) and (2.81) therein.
26. N. Metropolis, A. W. Rosenbluth, M. N. Rosenbluth, A. H. Teller, E. Teller, “Equations of state calculations by fast computing machines,” J. Chem. Phys., vol. 21, no. 6, pp. 1087-1092 (1953).
27. W. K. Hastings, “Monte Carlo sampling methods using Markov chains and their applications,” Biometrika, vol. 57, no. 1, pp. 97-109 (1970).
28. S. Geman and D. Geman, “Stochastic relaxation, Gibbs distributions, and the Bayesian restoration of images,” IEEE Trans. Pattern Anal. Machine Intel., vol. 6, no. 6, pp. 721-741 (1984).
29. S. Baroni and S. Moroni, “Reptation quantum Monte Carlo,” arXiv:cond-mat/9808213 (1998).
30. S. Baroni and S. Moron, “Reptation quantum Monte Carlo: a method for unbiased ground-state averages and imaginary-time correlations,” Phys. Rev. Lett., vol. 82, no. 24, pp. 4745-4748 (1999).
31. G. Carleo, F. Becca, S. Moroni, and S. Baroni, “Reptation quantum Monte Carlo algorithm for lattice Hamiltonians with a directed-update scheme,” Phys. Rev. E, vol. 82, 046710 (2010).
32. R. Motwani and P. Raghavan, Randomized Algorithms (Cambridge University Press, 1995).
33. P. R. Halmos, Measure Theory (Springer, 1974).
34. https://en.wikipedia.org/wiki/Iverson_bracket
35. A. Mizel, “Mimicking time evolution within a quantum ground state: Ground-state quantum computation, cloning, and teleportation,” Phys. Rev. A, vol. 70, 012304 (2004).
36. S. P. Jordan and E. Farhi, “Perturbative gadgets at arbitrary orders,” Phys. Rev. A, vol. 77, 062329 (2008).
37. S. Bravyi, D. P. DiVincenzo, D. Loss, and B. M. Terhal, “Quantum simulation of many-body Hamiltonians using perturbation theory with bounded-strength interactions,” Phys. Rev. Lett., vol. 101, 070503 (2008).
38. Y. Cao and D. Nagaj, “Perturbative gadgets without strong interactions,” Quan. Inf. Comp., vol. 15, no. 13/14, pp. 1197-1222 (2015).
39. D. Nagaj, “Fast universal quantum computation with railroad-switch local Hamiltonians,” J. Math. Phys., vol. 51, 062201 (2010).
40. N. P. Breuckmann and B. M. Terhal, “Space-time circuit-to-Hamiltonian construction and its applications,” J. Phys. A: Math. Theor., vol. 47, 195304 (2014).
41. S. Bravyi and B. Terhal, “Complexity of stoquastic frustration-free Hamiltonians,” SIAM J. Comput., vol. 39, no. 4, pp. 1462-1485 (2010).
42. S. P. Jordan, D. Gosset, and P. J. Love, “Quantum-Merlin-Arthur-complete problems for stoquastic Hamiltonians and Markov matrices,” Phys. Rev. A, vol. 81, 032331 (2010).
43. P. W. Shor, “Polynomial-time algorithms for prime factorization and discrete logarithms on a quantum computer,” SIAM J. Comput., vol. 26, no. 5, pp. 1484-1509 (1997).
44. S. Even, A. L. Selman, and Y. Yacobi, “The complexity of promise problems with applications to public-key cryptography,” Inform. Contr., vol. 61, no. 2, pp. 159-173 (1984).
45. O. Goldreich, “On promise problems: a survey,” in O. Goldreich et al. (Eds.), Shimon Even Festschrift, LNCS 3895 (Springer, 2006), pp. 254-290.
46. S. Arora and B. Barak, Computational Complexity: A Modern Approach (Cambridge University Press, 2009).
47. A. W. Harrow, A. Hassidim, and S. Lloyd, “Quantum algorithm for linear systems of equations,” Phys. Rev. Lett., vol, 103, 150502 (2009).
48. P. Diaconis and M. Shahshahani, “Generating a random permutation with random transpositions,” Z. Wahrscheinlichkeitstheorie verw. Gebiete, vol. 57, pp. 159-179 (1981).
49. A. Messiah, Quantum Mechanics, Two Volumes Bound as One (Dover Publications, 1999).
50. H. J. M. van Bemmel, D. F. B. ten Haaf, W. van Saarloos, J. M. J. van Leeuwen, and G. An, “Fixed-node quantum Monte Carlo method for lattice fermions,” Phys. Rev. Lett., vol. 72, pp. 2442-2445 (1994).
51. S. Sorella and F. Becca, SISSA Lecture Notes on Numerical Methods for Strongly Correlated Electrons, 5th draft (Mar. 10, 2015).
52. R. M. Gray and L. D. Davisson, An Introduction to Statistical Signal Processing (Cambridge University Press, 2004).
53. Z. Schuss, Theory and Applications of Stochastic Processes: An Analytical Approach (Springer, 2010).
54. M. A. Nielsen and I. L. Chuang, Quantum Computation and Quantum Information, 10th Anniversary Edition (Cambridge University Press, 2010).
55. https://en.wikipedia.org/wiki/Binomial-coefficient
56. M. Ledoux, The Concentration of Measure Phenomenon (American Mathematical Society, 2005).
57. R. P. Feynman, “Computing machines in the future,” in R. P. Feynman, The Pleasure of Finding Things Out (Basic Books, 1999).
58. L. Lehtovaara, J. Toivanen, and J. Eloranta, “Solution of time-independent Schrödinger equation by the imaginary time propagation method,” J. Comput. Phys., vol. 221, pp. 148-157 (2007).
59. A. M. Childs et al., “Quantum search by measurement,” Phys. Rev. A, vol. 66, 032314 (2002).
60. F. Chen, L. Lovasz, and I. Pak, “Lifting Markov chains to speed up mixing,” Proc. 31st Ann. ACM Symp. Theor. Comput. (STOC'99), pp. 275-281 (1999).
61. P. Diaconis, S. Holmes, and R. M. Neal, “Analysis of a nonreversible Markov chain sampler,” Ann. Appl. Prob., vol. 10, no. 3, pp. 726-752 (2000).
62. M. Vucelja, “Lifting—A non reversible Markov chain Monte Carlo algorithm,” Am. J. Phys., vol. 84, no. 12, pp. 958-968 (2016).
63. A. Ambainis, “Quantum walk algorithms for element distinctness,” Proc. 45th Ann. IEEE Symp. Found. Comput. Sci. (FOCS'04), pp. 22-31 (2004).
64. M. Szegedy, “Quantum speed-up of Markov chain based algorithms,” Proc. 45th Ann. IEEE Symp. Found. Comput. Sci. (FOCS'04), pp. 32-41 (2004).
65. R. D. Somma, S. Boixo, H. Barnum, and E. Knill, “Quantum simulations of classical annealing processes,” Phys. Rev. Lett., vol. 101, 130504 (2008).
66. R. D. Somma and G. Ortiz, “Quantum approach to classical thermodynamics and optimization,” in A. K. Chandra, A. Das, and B. K. Chakrabarti (Eds.), Quantum Quenching, Annealing and Computation, Lecture Notes in Physics 802 (Springer-Verlag, Berlin, 2010), pp. 1-20.
67. R. D. Somma and S. Boixo, “Spectral gap amplification,” SIAM J. Comput., vol. 42, no. 2, pp. 593-610 (2013).
68. J. Munkres, Topology, 2nd Ed. (Pearson, 2000).
69. L. W. Tu, An Introduction to Manifolds, 2nd Ed. (Springer, 2011).

What is claimed is:

1. A method of simulating a many-variable (MV) signed density associated with an MV configuration space, said MV configuration space being a set of MV configuration points each of which is represented by a tuple or vector of variable values assigned to a first ensemble of coordinate variables, said first ensemble of coordinate variables consisting of a variable number N of members, said MV signed density being practically substantially entangled, said method comprising:
providing a first means for decomposing said MV signed density into a combination of a first plurality K of few-variable (FV) signed densities, each of said FV signed densities corresponding to a second ensemble of coordinate variables selected from said first ensemble of coordinate variables, said corresponding second ensemble of coordinate variables consisting of a second plurality of members, wherein said first plurality is substantially upper-bounded by a first predetermined polynomial of said variable number N, said second plurality is substantially upper-bounded by a predetermined logarithm of a second predetermined polynomial of said variable number N;
providing a second means for determining FV nodal surfaces corresponding to each of said FV signed densities, each of said FV nodal surfaces enclosing a corresponding FV nodal cell in which the corresponding FV signed density is non-negative-valued, said corresponding FV nodal cell being a corresponding subset of said MV configuration space, each pair of MV configuration points in said corresponding subset differing from each other at most in variable values assigned to coordinate variables selected from the corresponding second ensemble of coordinate variables;
providing a third means for producing a third plurality of samples of FV restricted densities, each of said FV restricted densities being substantially equal to a corresponding one of said FV signed densities restricted to one of the corresponding nodal cells, wherein said third plurality is substantially upper-bounded by a third predetermined polynomial of said variable number N, said samples of said FV restricted densities are non-negative-valued;
providing a fourth means for producing a fourth plurality of samples of an MV restricted density by combining said third plurality of samples of FV restricted densities, wherein said fourth plurality is substantially upper-bounded by a fourth predetermined polynomial of said variable number N, said samples of said MV restricted density are non-negative-valued;
whereby said MV restricted density is substantially equivalent to said MV signed density in the sense that a signed expectation value of a prescribed observable due to said MV restricted density is substantially equal to the signed expectation value of said prescribed observable due to said MV signed density, said prescribed observable is selected from the group consisting of the number 1, a predetermined constant, and a prescribed function associated with a subset of said MV configuration space.

2. The method of claim 1, wherein said MV signed density has a severe sign problem.

3. The method of claim 1, further comprising a fifth means for computing the signed expectation value of said prescribed observable due to said MV restricted density.

4. The method of claim 1, wherein said MV signed density is associated with an MV symmetry group, said MV symmetry group induces an MV group action on said MV configuration space thereby permutes a first set of MV nodal cells corresponding to said MV signed density, each of said MV nodal cells tiles up said MV configuration space under said MV group action, each of said FV signed densities is associated with a corresponding FV symmetry group, said corresponding FV symmetry group has an order (namely, cardinality) that is substantially upper-bounded by a fifth predetermined polynomial of said variable number N, said corresponding FV symmetry group induces a corresponding FV group action on said MV configuration space thereby permutes a second set of FV nodal cells corresponding to the corresponding FV signed density, a collection of the corresponding FV symmetry groups associated with the FV signed densities generates said MV symmetry group.

5. The method of claim 1, wherein said MV signed density is selected from the group consisting of ground state wavefunctions, Gibbs wavefunctions, Gibbs kernels, Gibbs transition amplitudes, and Wiener densities, said MV signed density is associated with a quantum system that is governed by a total Hamiltonian selected from the group consisting of strongly frustration-free Hamiltonians, ground sate frustration-free Hamiltonians, directly frustration-free Hamiltonians, separately frustration-free Hamiltonians, and sum-of-CFFs Hamiltonians.

6. The method of claim 5, wherein said quantum system is a many-species fermionic system comprising a fifth plurality of fermion species, each of said fifth plurality of fermion species consists of a sixth plurality of identical fermions, said fifth plurality is substantially greater than aN^{α} for a predetermined pair of positive real numbers a and a, said sixth plurality is substantially less than a predetermined logarithm of bN^{β} for another predetermined pair of positive real numbers b and β, where N is said variable number.

7. The method of claim 5, wherein said total Hamiltonian is substantially a Feynman-Kitaev Hamiltonian governing substantially a Feynman-Kitaev construct, said Feynman-Kitaev construct provides a means for spectral gap amplification such that the ground state and the excited states of said Feynman-Kitaev Hamiltonian is separated by an amplified spectral gap, said amplified spectral gap is substantially greater than cK^{-γ} for a predetermined pair of positive real numbers c and γ, where K is said first plurality, said positive real number γ is less than 2.

8. A method of simulating a many-variable (MV) signed density, said MV signed density being induced by an MV transition operator, said MV transition operator involving a first ensemble of coordinate variables, said first ensemble of coordinate variables consisting of a variable number N of members, a tuple or vector of variable values assigned to said first ensemble of coordinate variables representing an MV configuration point, a set of such MV configuration points constituting an MV configuration space, said MV signed density being practically substantially entangled, said method comprising:
providing a first means for decomposing said MV transition operator into a combination of a first plurality K of few-variable (FV) transition operators, each of said FV transition operators involving a corresponding second ensemble of coordinate variables selected from said first ensemble of coordinate variables, said corresponding second ensemble of coordinate variables consisting of a second plurality L of members, each of said FV transition operators inducing a corresponding one of FV signed densities, wherein said first plurality is substantially upper-bounded by a first predetermined polynomial of said variable number N, said second plurality L is substantially upper-bounded by a predetermined logarithm of a second predetermined polynomial of said variable number N;
providing a second means for determining FV nodal surfaces corresponding to each of said FV signed densities, each of said FV nodal surfaces enclosing a corresponding FV nodal cell in which the corresponding FV signed density is non-negative-valued, said corresponding FV nodal cell being a corresponding subset of said MV configuration space, each pair of MV configuration points in said corresponding subset differing from each other at most in variable values assigned to coordinate variables selected from the corresponding second ensemble of coordinate variables;
providing a third means for producing a third plurality of samples of FV restricted densities, each of said FV restricted densities being substantially equal to a corresponding one of said FV signed densities restricted to one of the corresponding nodal cells, wherein said third plurality is substantially upper-bounded by a third predetermined polynomial of said variable number N, said samples of said FV restricted densities are non-negative-valued;
providing a fourth means for producing a fourth plurality of samples of an MV restricted density by combining said third plurality of samples of FV restricted densities, wherein said fourth plurality is substantially upper-bounded by a fourth predetermined polynomial of said variable number N, said samples of said MV restricted density are non-negative-valued;
whereby said MV restricted density is substantially equivalent to said MV signed density in the sense that a signed expectation value of a prescribed observable due to said MV restricted density is substantially equal to the signed expectation value of said prescribed observable due to said MV signed density, said prescribed observable is selected from the group consisting of the number 1, a predetermined constant, and a prescribed function associated with a subset of said MV configuration space.

9. The method of claim 8, wherein said MV signed density has a severe sign problem.

10. The method of claim 8, further comprising a fifth means for computing the signed expectation value of said prescribed observable due to said MV restricted density.

11. The method of claim 8, wherein said MV signed density is associated with an MV symmetry group, said MV symmetry group induces an MV group action on said MV configuration space thereby permutes a first set of MV nodal cells corresponding to said MV signed density, each of said MV nodal cells tiles up said MV configuration space under said MV group action, each of said FV signed densities is associated with a corresponding FV symmetry group, said corresponding FV symmetry group has an order (namely, cardinality) that is substantially upper-bounded by a fifth predetermined polynomial of said variable number N, said corresponding FV symmetry group induces a corresponding FV group action on said MV configuration space thereby permutes a second set of FV nodal cells corresponding to the corresponding FV signed density, a collection of the corresponding FV symmetry groups associated with the FV signed densities generates said MV symmetry group.

12. The method of claim 8, wherein said MV signed density is selected from the group consisting of ground state wavefunctions, Gibbs wavefunctions, Gibbs kernels, Gibbs transition amplitudes, and Wiener densities, said MV signed density is associated with a quantum system, said MV transition operator is a Gibbs operator generated by a total Hamiltonian governing said quantum system, said total Hamiltonian is selected from the group consisting of strongly frustration-free Hamiltonians, ground sate frustration-free Hamiltonians, directly frustration-free Hamiltonians, separately frustration-free Hamiltonians, and sum-of-CFFs Hamiltonians.

13. The method of claim 12, wherein said quantum system is a many-species fermionic system comprising a fifth plurality of fermion species, each of said fifth plurality of fermion species consists of a sixth plurality of identical fermions, said fifth plurality is substantially greater than aN^{α} for a predetermined pair of positive real numbers a and a, said sixth plurality is substantially less than a predetermined logarithm of bN^{β} for another predetermined pair of positive real numbers b and β, where N is said variable number.

14. The method of claim 12, wherein said total Hamiltonian is substantially a Feynman-Kitaev Hamiltonian governing substantially a Feynman-Kitaev construct, said Feynman-Kitaev construct provides a means for spectral gap amplification such that the ground state and the excited states of said Feynman-Kitaev Hamiltonian is separated by an amplified spectral gap, said amplified spectral gap is substantially greater than cK^{-γ} for a predetermined pair of positive real numbers c and γ, where K is said first plurality, said positive real number γ is less than 2.

15. A method of solving a computational problem, said computational problem being described by problem data, said method comprising:
providing a first means for processing said problem data to produce Gibbs data, said first means comprising:
providing a first processing means for producing circuit data describing a quantum circuit, said circuit data comprising qubit data and gate data, said qubit data comprising a description of a first plurality N_{b} of qubits, said gate data comprising a description of a second plurality N_{g} of quantum gates, wherein each of said quantum gates involves at most a first predetermined number of said qubits, said quantum circuit produces a quantum result encoding a solution to said computational problem;
providing a second processing means for producing homophysics data comprising coordinate data and Hamiltonian data, said coordinate data comprising a description of a first ensemble of coordinate variables, said first ensemble of coordinate variables consisting of a variable number N of members, said coordinate variables homophysically implementing said qubits, a tuple or vector of variable values assigned to said first ensemble of coordinate variables representing a many-variable (MV) configuration point, a set of such MV configuration points constituting an MV configuration space, said Hamiltonian data comprising a description of a third plurality K of few-variable (FV) Hamiltonians, each of said FV Hamiltonians involving a corresponding second ensemble of coordinate variables selected from said first ensemble of coordinate variables, said corresponding second ensemble of coordinate variables consisting of a fourth plurality L of members, each of said FV Hamiltonians corresponding to one of said quantum gates, said FV Hamiltonians combining into an MV Hamiltonian, wherein said variable number N is substantially upper-bounded by a first predetermined polynomial of (N_{b}+N_{g}), said third plurality K is substantially upper-bounded by a second predetermined polynomial of (N_{b}+N_{g}), said fourth plurality L is substantially upper-bounded by a predetermined logarithm of a third predetermined polynomial of (N_{b}+N_{g});
providing a third processing means for producing Gibbs data comprising a description of an MV Gibbs operator and a fifth plurality of FV Gibbs operators, said MV Gibbs operator being generated by said MV Hamiltonian, each of said FV Gibbs operators being generated by a corresponding one of said FV Hamiltonians, said MV Gibbs operator inducing an MV signed density, each of said FV Gibbs operators inducing a corresponding one of FV signed densities, wherein said fifth plurality is upper-bounded by a fourth predetermined polynomial of (N_{b}+N_{g}), both said MV signed density and each of said FV signed densities are associated with a subset of said MV configuration space;
whereby said MV signed density encodes said quantum result in the sense that a signed expectation value of a prescribed observable due to said MV signed density is substantially equal to said quantum result, said prescribed observable is selected from the group consisting of the number 1, a predetermined constant, and a prescribed function associated with a subset of said MV configuration space;
providing a second means for simulating said MV signed density, said second means comprising:
providing a first simulating means for determining FV nodal surfaces corresponding to each of said FV signed densities, each of said FV nodal surfaces enclosing a corresponding FV nodal cell in which the corresponding FV signed density is non-negative-valued, said corresponding FV nodal cell being a corresponding subset of said MV configuration space, each pair of MV configuration points in said corresponding subset differing from each other at most in variable values assigned to coordinate variables selected from the corresponding second ensemble of coordinate variables;
providing a second simulating means for producing a sixth plurality of samples of FV restricted densities, each of said FV restricted densities being substantially equal to a corresponding one of said FV signed densities restricted to one of the corresponding nodal cells, wherein said sixth plurality is substantially upper-bounded by a fifth predetermined polynomial of (N_{b}+N_{g}), said samples of said FV restricted densities are non-negative-valued;
providing a third simulating means for producing a seventh plurality of samples of an MV restricted density by combining said sixth plurality of samples of FV restricted densities, wherein said seventh plurality is substantially upper-bounded by a sixth predetermined polynomial of (N_{b}+N_{g}), said samples of said MV restricted density are non-negative-valued;
whereby said MV restricted density is substantially equivalent to said MV signed density in the sense that the signed expectation value of said prescribed observable due to said MV restricted density is substantially equal to the signed expectation value of said prescribed observable due to said MV signed density;
whereby the solution to said computational problem is obtained by said simulating said MV signed density.

16. The method of claim 15, further comprising a fifth means for computing the signed expectation value of said prescribed observable due to said MV restricted density.

17. The method of claim 15, wherein said MV signed density is associated with an MV symmetry group, said MV symmetry group induces an MV group action on said MV configuration space thereby permutes a first set of MV nodal cells corresponding to said MV signed density, each of said MV nodal cells tiles up said MV configuration space under said MV group action, each of said FV signed densities is associated with a corresponding FV symmetry group, said corresponding FV symmetry group has an order (namely, cardinality) that is substantially upper-bounded by a seventh predetermined polynomial of said variable number N, said corresponding FV symmetry group induces a corresponding FV group action on said MV configuration space thereby permutes a second set of FV nodal cells corresponding to the corresponding FV signed density, a collection of the corresponding FV symmetry groups associated with the FV signed densities generates said MV symmetry group.

18. The method of claim 15, wherein said MV signed density is selected from the group consisting of ground state wavefunctions, Gibbs wavefunctions, Gibbs kernels, Gibbs transition amplitudes, and Wiener densities, said MV signed density is associated with a quantum system, said MV transition operator is a Gibbs operator generated by a total Hamiltonian governing said quantum system, said total Hamiltonian is selected from the group consisting of strongly frustration-free Hamiltonians, ground sate frustration-free Hamiltonians, directly frustration-free Hamiltonians, separately frustration-free Hamiltonians, and sum-of-CFFs Hamiltonians.

19. The method of claim 18, wherein said quantum system is a many-species fermionic system comprising an eighth plurality of fermion species, each of said eighth plurality of fermion species consists of a ninth plurality of identical fermions, said eighth plurality is substantially greater than aN^{α} for a predetermined pair of positive real numbers a and a, said ninth plurality is substantially less than a predetermined logarithm of bN^{β} for another predetermined pair of positive real numbers b and β, where N is said variable number.

20. The method of claim 18, wherein said total Hamiltonian is substantially a Feynman-Kitaev Hamiltonian governing substantially a Feynman-Kitaev construct, said Feynman-Kitaev construct provides a means for spectral gap amplification such that the ground state and the excited states of said Feynman-Kitaev Hamiltonian is separated by an amplified spectral gap, said amplified spectral gap is substantially greater than cK^{-γ} for a predetermined pair of positive real numbers c and γ, where K is said third plurality, said positive real number γ is less than 2.
